(19) United States
(12) Patent Application Publication
(10) Pub. No.: US 2013/0081022 A1
(43) Pub. Date: Mar. 28, 2013

(54) CONFIGURING INTERFACE DEVICES WITH RESPECT TO TASKS AND SUBTASKS

(71) Applicants: Royce A. Levien, Lexington, MA (US); Richard T. Lord, Tacoma, WA (US); Robert W. Lord, Seattle, WA (US); Mark A. Malamud, Seattle, WA (US); John D. Rinaldo, JR., Bellevue, WA (US)

(72) Inventors: Royce A. Levien, Lexington, MA (US); Richard T. Lord, Tacoma, WA (US); Robert W. Lord, Seattle, WA (US); Mark A. Malamud, Seattle, WA (US); John D. Rinaldo, JR., Bellevue, WA (US)

(73) Assignee: Elwha LLC, a limited liability company of the State of Delaware

(21) Appl. No.: 13/436,550

(22) Filed: Mar. 30, 2012

Related U.S. Application Data
(63) Continuation of application No. 13/436,544, filed on Mar. 30, 2012.
Application No. 13/436,544 is a continuation-in-part of application No. 13/200,553, filed on Sep. 23, 2011.
Application No. 13/200,553 is a continuation-in-part of application No. 13/200,797, filed on Sep. 30, 2011.
Application No. 13/200,797 is a continuation-in-part of application No. 13/317,591, filed on Oct. 21, 2011.
Application No. 13/317,591 is a continuation-in-part of application No. 13/317,833, filed on Oct. 28, 2011.
Application No. 13/317,833 is a continuation-in-part of application No. 13/373,795, filed on Nov. 29, 2011.
Application No. 13/373,795 is a continuation-in-part of application No. 13/373,794, filed on Nov. 29, 2011.
Application No. 13/373,794 is a continuation-in-part of application No. 13/373,826, filed on Nov. 30, 2011.
Application No. 13/373,826 is a continuation-in-part of application No. 13/373,829, filed on Nov. 30, 2011.
Application No. 13/373,829 is a continuation-in-part of application No. 13/374,512, filed on Dec. 30, 2011.
Application No. 13/374,512 is a continuation-in-part of application No. 13/374,514, filed on Dec. 30, 2011.
Application No. 13/374,514 is a continuation-in-part of application No. 13/374,529, filed on Dec. 30, 2011.
Application No. 13/374,529 is a continuation-in-part of application No. 13/374,527, filed on Dec. 30, 2011.
Application No. 13/374,527 is a continuation-in-part of application No. 13/374,511, filed on Dec. 30, 2011.
Application No. 13/374,511 is a continuation-in-part of application No. 13/374,518, filed on Dec. 30, 2011.
Application No. 13/374,518 is a continuation-in-part of application No. 13/374,522, filed on Dec. 30, 2011.
Application No. 13/374,522 is a continuation-in-part of application No. 13/341,901, filed on Dec. 30, 2011.
Application No. 13/341,901 is a continuation-in-part of application No. 13/436,463, filed on Mar. 30, 2012.
Application No. 13/436,463 is a continuation-in-part of application No. 13/436,464, filed on Mar. 30, 2012.

(51) Int. Cl. G06F 9/46

(52) U.S. Cl. 718/100

(57) ABSTRACT

Computationally implemented methods and systems include configuring a device to acquire one or more subtasks configured to be carried out by at least two discrete interface devices, said one or more subtasks corresponding to portions of one or more tasks of acquiring data requested by a task requestor, facilitating execution of the received one or more subtasks, and controlling access to at least one feature of the device unrelated to the execution of the one or more subtasks, based on successful execution of the one or more subtasks. In addition to the foregoing, other aspects are described in the claims, drawings, and text.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)). All subject matter of the Related Applications and of any and all parent, grandparent, great-grandparent, etc. applications of the Related Applications is incorporated herein by reference to the extent such subject matter is not inconsistent herewith.

For purposes of the USPTO extra-statutory requirements, the present application constitutes a continuation of U.S. patent application Ser. No. 13/436,544, entitled CONFIGURING INTERFACE DEVICES WITH RESPECT TO TASKS AND SUBTASKS, naming Royce A. Levien, Richard T. Lord, Robert W. Lord, Mark A. Malamud, and John D. Rinaldo, Jr. as inventors, filed Mar. 30 2012, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/200,553, entitled ACQUIRING AND TRANSMITTING TASKS AND SUBTASKS TO INTERFACE DEVICES, naming Royce A. Levien; Richard T. Lord; Robert W. Lord; Mark A. Malamud; and John D. Rinaldo, Jr., as inventors, filed Sep. 23, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/200,797, entitled ACQUIRING AND TRANSMITTING TASKS AND SUBTASKS TO INTERFACE DEVICES, naming Royce A. Levien; Richard T. Lord; Robert W. Lord; Mark A. Malamud; and John D. Rinaldo, Jr., as inventors, filed Sep. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/317,591, entitled ACQUIRING, PRESENTING AND TRANSMITTING TASKS AND SUBTASKS TO INTERFACE DEVICES, naming Royce A. Levien; Richard T. Lord; Robert W. Lord; Mark A. Malamud; and John D. Rinaldo, Jr., as inventors, filed Oct. 21, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/317,833, entitled ACQUIRING, PRESENTING AND TRANSMITTING TASKS AND SUBTASKS TO INTERFACE DEVICES, naming Royce A. Levien; Richard T. Lord; Robert W. Lord; Mark A. Malamud; and John D. Rinaldo, Jr., as inventors, filed Oct. 28, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/373,795, entitled METHODS AND DEVICES FOR RECEIVING AND EXECUTING SUBTASKS, naming Royce A. Levien; Richard T. Lord; Robert W. Lord; Mark A. Malamud; and John D. Rinaldo, Jr., as inventors, filed Nov. 29, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No., 13/373,794, entitled METHODS AND DEVICES FOR RECEIVING AND EXECUTING SUBTASKS, naming Royce A. Levien; Richard T. Lord; Robert W. Lord; Mark A. Malamud; and John D. Rinaldo, Jr., as inventors, filed Nov. 29, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No., 13/373,826, entitled ACQUIRING TASKS AND SUBTASKS TO BE CARRIED OUT BY INTERFACE DEVICES, naming Royce A. Levien; Richard T. Lord; Robert W. Lord; Mark A. Malamud; and John D. Rinaldo, Jr., as inventors, filed Nov. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No., 13/373,829, entitled ACQUIRING TASKS AND SUBTASKS TO BE CARRIED OUT BY INTERFACE DEVICES, naming Royce A. Levien; Richard T. Lord; Robert W. Lord; Mark A. Malamud; and John D. Rinaldo, Jr., as inventors, filed Nov. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/374,512, entitled ACQUIRING TASKS AND SUBTASKS TO BE CARRIED OUT BY INTERFACE DEVICES, naming Royce A. Levien; Richard T. Lord; Robert W. Lord; Mark A. Malamud; and John D. Rinaldo, Jr., as inventors, filed Dec. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/374,514, entitled ACQUIRING TASKS AND SUBTASKS TO BE CARRIED OUT BY INTERFACE DEVICES, naming Royce A. Levien; Richard T. Lord; Robert W. Lord; Mark A. Malamud; and John D. Rinaldo, Jr., as inventors, filed Dec. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/374,529, entitled ACQUIRING AND TRANSMITTING TASKS AND SUBTASKS TO INTERFACE DEVICES, AND OBTAINING RESULTS OF EXECUTED SUBTASKS, naming Royce A. Levien; Richard T. Lord; Robert W. Lord; Mark A. Malamud; and John D. Rinaldo, Jr., as inventors, filed Dec. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/374,527, entitled ACQUIRING AND TRANSMITTING TASKS AND SUBTASKS TO INTERFACE DEVICES, AND OBTAINING RESULTS OF EXECUTED SUBTASKS, naming Royce A. Levien; Richard T. Lord; Robert W. Lord; Mark A. Malamud; and John D. Rinaldo, Jr., as inventors, filed Dec. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/374,511, entitled RECEIVING SUBTASK REPRESENTATIONS, AND OBTAINING AND COMMUNICATING SUBTASK RESULT DATA, naming Royce A. Levien; Richard T. Lord; Robert W. Lord; Mark A. Malamud; and John D. Rinaldo, Jr., as inventors, filed Dec. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/374,518, entitled RECEIVING SUBTASK REPRESENTATIONS, AND OBTAINING AND COMMUNICATING SUBTASK RESULT DATA, naming Royce A. Levien; Richard T. Lord; Robert W. Lord; Mark A. Malamud; and John D. Rinaldo, Jr., as inventors, filed Dec. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/374,522, entitled RECEIVING SUBTASK REPRESENTATIONS, AND OBTAINING AND COMMUNICATING SUBTASK RESULT DATA, naming Royce A. Levien; Richard T. Lord; Robert W. Lord; Mark A. Malamud; and John D. Rinaldo, Jr., as inventors, filed Dec. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/341,901, entitled RECEIVING SUBTASK REPRESENTATIONS, AND OBTAINING AND COMMUNICATING SUBTASK RESULT DATA, naming Royce A. Levien; Richard T. Lord; Robert W. Lord; Mark A. Malamud; and John D. Rinaldo, Jr., as inventors, filed Dec. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/436,463, entitled ACQUIRING AND TRANSMITTING EVENT RELATED TASKS AND SUBTASKS TO INTERFACE DEVICES, naming Royce A. Levien; Richard T. Lord; Robert W. Lord; Mark A. Malamud; and John D. Rinaldo, Jr., as inventors, filed Mar. 30, 2012, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/436,464, entitled ACQUIRING AND TRANSMITTING EVENT RELATED TASKS AND SUBTASKS TO INTERFACE DEVICES, naming Royce A. Levien; Richard T. Lord; Robert W. Lord; Mark A. Malamud; and John D. Rinaldo, Jr., as inventors, filed Mar. 30, 2012, which is currently co-pending, or is an application of which a currently co-pending application is entitled to the benefit of the filing date.

### BACKGROUND

This application is related to using interface devices to collect data.

### SUMMARY

A computationally implemented method includes, but is not limited to, configuring a device to acquire one or more subtasks configured to be carried out by at least two discrete interface devices, said one or more subtasks corresponding to portions of one or more tasks of acquiring data requested by a task requestor, facilitating execution of the received one or more subtasks, and controlling access to at least one feature of the device unrelated to the execution of the one or more subtasks, based on successful execution of the one or more subtasks. In addition to the foregoing, other method aspects are described in the claims, drawings, and text forming a part of the present disclosure.

In one or more various aspects, related systems include but are not limited to circuitry and/or programming for effecting the herein referenced method aspects; the circuitry and/or programming can be virtually any combination of hardware, software, and/or firmware in one or more machines or article of manufacture configured to effect the herein referenced method aspects depending upon the design choices of the system designer.

A computationally-implemented system includes, but is not limited to, means for configuring a device to acquire one or more subtasks configured to be carried out by at least two discrete interface devices, said one or more subtasks corresponding to portions of one or more tasks of acquiring data requested by a task requestor, means for facilitating execution of the received one or more subtasks, and means for controlling access to at least one feature of the device unrelated to the execution of the one or more subtasks, based on successful execution of the one or more subtasks. In addition to the foregoing, other system aspects are described in the claims, drawings, and text forming a part of the present disclosure.

A computationally-implemented system includes, but is not limited to, circuitry for configuring a device to acquire one or more subtasks configured to be carried out by at least two discrete interface devices, said one or more subtasks corresponding to portions of one or more tasks of acquiring data requested by a task requestor, circuitry for facilitating execution of the received one or more subtasks, and circuitry for controlling access to at least one feature of the device unrelated to the execution of the one or more subtasks, based on successful execution of the one or more subtasks.

A computer program product comprising an article of manufacture bears instructions including but not limited to one or more instructions for configuring a device to acquire one or more subtasks configured to be carried out by at least two discrete interface devices, said one or more subtasks corresponding to portions of one or more tasks of acquiring data requested by a task requestor, one or more instructions for facilitating execution of the received one or more subtasks, and one or more instructions for controlling access to at least one feature of the device unrelated to the execution of the one or more subtasks, based on successful execution of the one or more subtasks.

A computer architecture comprising at least one level, comprising architecture configured to configure a device to acquire one or more subtasks configured to be carried out by at least two discrete interface devices, said one or more subtasks corresponding to portions of one or more tasks of acquiring data requested by a task requestor, architecture configured to facilitate execution of the received one or more subtasks, and architecture configured to control access to at least one feature of the device unrelated to the execution of the one or more subtasks, based on successful execution of the one or more subtasks.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1, including FIGS. 1A and 1B, shows a high-level block diagram of an interface device operating in an exemplary environment 100, according to an embodiment.

FIG. 2, including FIGS. 2A-2C, shows a particular perspective of the device configuring module 52 of the interface device 20 of environment 100 of FIG. 1.

FIG. 3, including FIGS. 3A-3D, shows a particular perspective of the received one or more subtasks requested by a task requestor execution facilitating module 54 of the interface device 20 of environment 100 of FIG. 1.

FIG. 4, including FIGS. 4A-4K, shows a particular perspective of the two-or-more discrete interface devices selection module for selecting two or more discrete interface devices based on at least one of a status and a characteristic 153 of the computing device 30 of environment 100 of FIG. 1.

FIG. 5 is a high-level logic flowchart of a process, e.g., operational flow 500, according to an embodiment.

FIG. 6A is a high-level logic flowchart of a process depicting alternate implementations of a subtask receiving device configuring data operation 502 of FIG. 5.

FIG. 6B is a high-level logic flowchart of a process depicting alternate implementations of a subtask receiving device configuring data operation 502 of FIG. 5.

FIG. 6C is a high-level logic flowchart of a process depicting alternate implementations of a subtask receiving device configuring data operation 502 of FIG. 5.

FIG. 6D is a high-level logic flowchart of a process depicting alternate implementations of a subtask receiving device configuring data operation 502 of FIG. 5.

FIG. 7A is a high-level logic flowchart of a process depicting alternate implementations of a subtask execution facilitating operation 504 of FIG. 5.

FIG. 7B is a high-level logic flowchart of a process depicting alternate implementations of a subtask execution facilitating operation 504 of FIG. 5.

FIG. 7C is a high-level logic flowchart of a process depicting alternate implementations of a subtask execution facilitating operation 504 of FIG. 5.

FIG. 7D is a high-level logic flowchart of a process depicting alternate implementations of a subtask execution facilitating operation 504 of FIG. 5.

FIG. 7E is a high-level logic flowchart of a process depicting alternate implementations of a subtask execution facilitating operation 504 of FIG. 5.

FIG. 8A is a high-level logic flowchart of a process depicting alternate implementations of an unrelated feature access controlling operation 506 of FIG. 5.

FIG. 8B is a high-level logic flowchart of a process depicting alternate implementations of an unrelated feature access controlling operation 506 of FIG. 5.

FIG. 8C is a high-level logic flowchart of a process depicting alternate implementations of an unrelated feature access controlling operation 506 of FIG. 5.

FIG. 8D is a high-level logic flowchart of a process depicting alternate implementations of an unrelated feature access controlling operation 506 of FIG. 5.

FIG. 8E is a high-level logic flowchart of a process depicting alternate implementations of an unrelated feature access controlling operation 506 of FIG. 5.

FIG. 8F is a high-level logic flowchart of a process depicting alternate implementations of an unrelated feature access controlling operation 506 of FIG. 5.

FIG. 8G is a high-level logic flowchart of a process depicting alternate implementations of an unrelated feature access controlling operation 506 of FIG. 5.

FIG. 8H is a high-level logic flowchart of a process depicting alternate implementations of an unrelated feature access controlling operation 506 of FIG. 5.

FIG. 8I is a high-level logic flowchart of a process depicting alternate implementations of an unrelated feature access controlling operation 506 of FIG. 5.

FIG. 8J is a high-level logic flowchart of a process depicting alternate implementations of an unrelated feature access controlling operation 506 of FIG. 5.

FIG. 8K is a high-level logic flowchart of a process depicting alternate implementations of an unrelated feature access controlling operation 506 of FIG. 5.

FIG. 8L is a high-level logic flowchart of a process depicting alternate implementations of an unrelated feature access controlling operation 506 of FIG. 5.

FIG. 8M is a high-level logic flowchart of a process depicting alternate implementations of an unrelated feature access controlling operation 506 of FIG. 5.

FIG. 8N is a high-level logic flowchart of a process depicting alternate implementations of an unrelated feature access controlling operation 506 of FIG. 5.

FIG. 8P is a high-level logic flowchart of a process depicting alternate implementations of an unrelated feature access controlling operation 506 of FIG. 5.

### DETAILED DESCRIPTION

In the following detailed description, reference is made to the accompanying drawings, which form a part hereof. In the drawings, similar symbols typically identify similar or identical components or items, unless context dictates otherwise. The illustrative embodiments described in the detailed description, drawings, and claims are not meant to be limiting. Other embodiments may be utilized, and other changes may be made, without departing from the spirit or scope of the subject matter presented here.

The emergence of portable computing devices (e.g., laptop computers, computer tablets, digital music players, personal navigation systems, net books, smart phones, personal digital assistants (“PDAs”), digital still cameras, digital video cameras, and handheld game devices, e.g., PlayStation Portable and Nintendo 3DS) into all segments of society over the last two decades has resulted in vast socioeconomic benefits generally enriching the lives of those who choose to take advantage of the benefits that such devices provide. The rise in the portability of such devices has provided a wealth of information available to a user.

In addition, the promulgation of portable electronic devices, each having their own set of unique sensors and detectors, has been widespread. Currently, there are very few populated areas of developed countries which do not contain a large number of portable computing devices at any given time. These portable computing devices are constantly collecting data, and capable of collecting data, which is not stored in any repository or transmitted to any device which may use such data. Thus, such data, and opportunity to collect data, may be lost.

Although the promulgation of portable electronic devices above has been widespread, it is not universal. There are many individuals and other entities that do not have access to portable electronic devices, or have reduced access to portable electronic devices. Many portable electronic devices, e.g., cellular telephones and smart phones, require monthly payments to continue using services, in addition to the initial cost of purchasing the device. For example, devices that access the Internet across a cellular network may have high costs. It is not unusual for so-called “smartphones” to range in price from under 100 dollars to over 600 dollars. In addition, some devices require contracts that cap the amount of data that the device may use. Thus, while access to portable electronic devices is widespread, they remain inaccessible or barely-accessible to many groups of people. This is not limited to cellular devices, either. Many other devices, from GPS navigators in vehicles to laptop computers, have a high initial cost that is difficult for many people to reach.

In accordance with various embodiments, computationally implemented methods, systems, circuitry, articles of manufacture, and computer program products are designed to, among other things, provide an interface for configuring a device to acquire one or more subtasks configured to be carried out by at least two discrete interface devices, said one or more subtasks corresponding to portions of one or more tasks of acquiring data requested by a task requestor, facilitating execution of the received one or more subtasks, and controlling access to at least one feature of the device unrelated to the execution of the one or more subtasks, based on successful execution of the one or more subtasks.

The foregoing summary is illustrative only and is not intended to be in any way limiting. In addition to the illustrative aspects, embodiments, and features described above, further aspects, embodiments, and features will become apparent by reference to the drawings and the following detailed description.

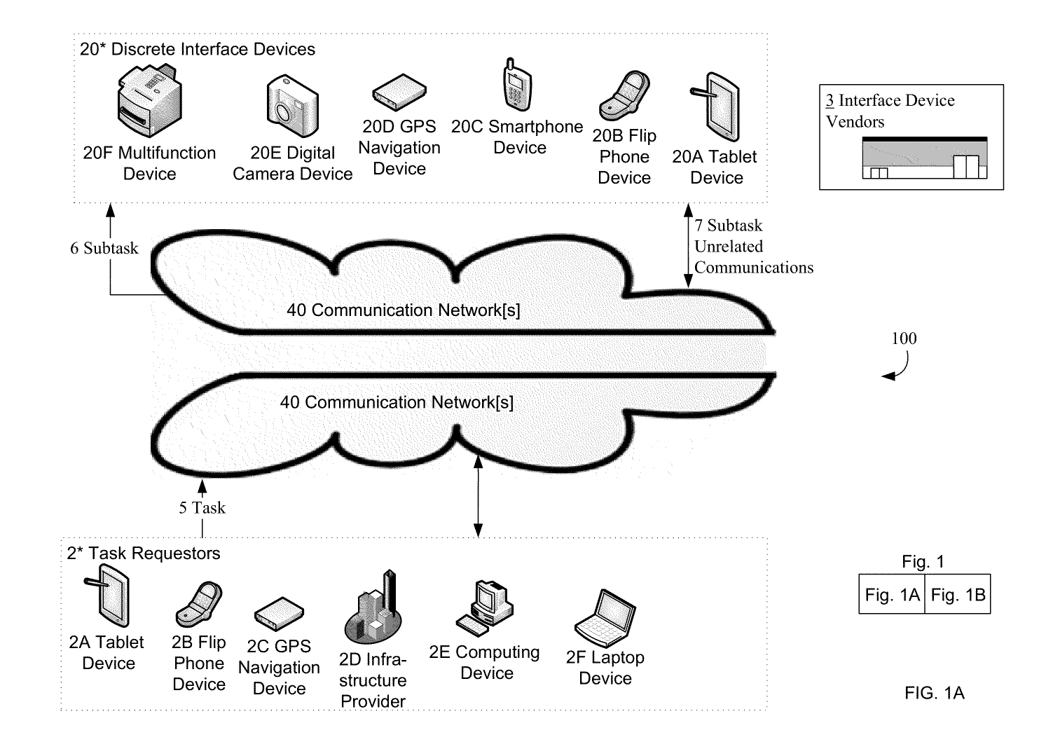

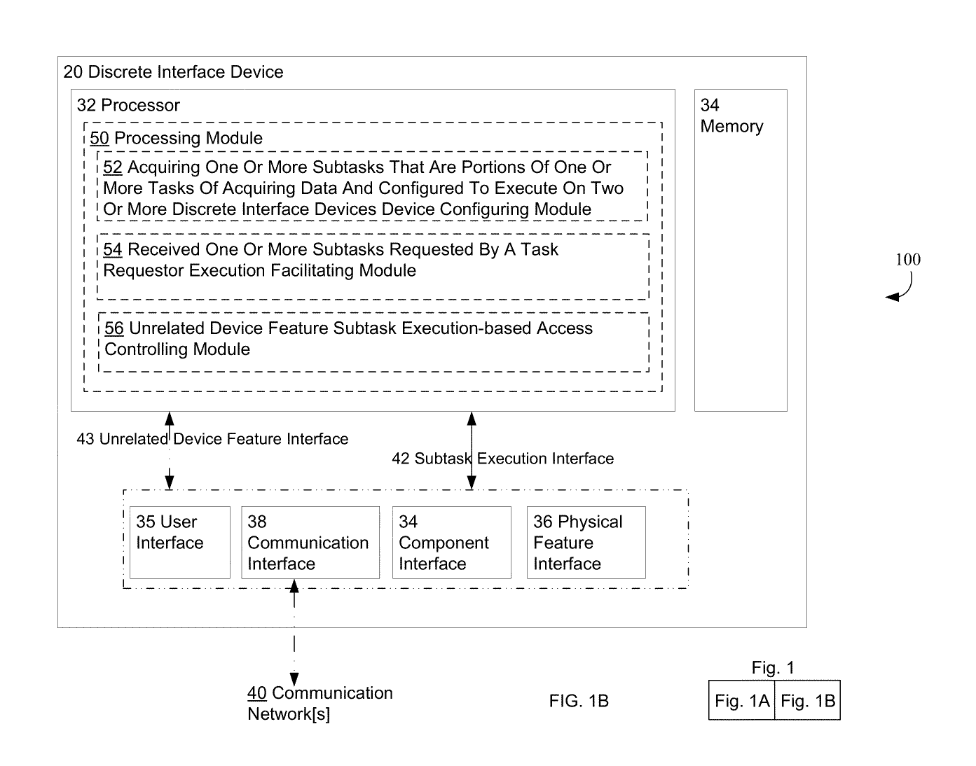

Referring now to FIG. 1, FIG. 1 illustrates an example environment 100 in which the methods, systems, circuitry, articles of manufacture, and computer program products and architecture, in accordance with various embodiments, may be implemented by interface device 20. Specifically, FIG. 1 illustrates an operational flow 100 representing example operations for, among other things, interfacing with a system of interface devices to carry out a task by acquiring one or more subtasks related to the task, and transmitting the subtasks to two or more discrete interface devices for execution.

Note that in the following description, the character “*” represents a wildcard. Thus, references to, for example, task requestors 2* of FIG. 1 may be in reference to tablet device 2A, flip phone device 2B, smartphone device 2C, GPS navigation device 2D, infrastructure provider 2E, communication network provider 2F, computing device 2G, laptop device 2H, which may be part of computing device 30, but for the purposes of the interface devices described herein, is not distinguishable from the other task requestors 2*. FIG. 1 illustrates a number of task requestors 2*. For example, FIG. 1 illustrates task requestor 2A as a tablet, task requestor 2B as a flip phone, and task requestor 2C as a smartphone device. These drawings are meant to be illustrative only, and should not be construed as limiting the definition of task requestors 2*, which can be any device with computing functionality.

Similarly, interface devices 20* of FIG. 1 may be in reference to tablet device 20A, flip phone device 20B, smartphone device 20C, GPS navigation device 20D, digital camera device 20E, multifunction device 20F, and weather station device 20G. These drawings are meant to be illustrative only, and should not be construed as limiting the definition of interface devices 20*, which can be any device with computing functionality.

Within the context of this application, “discrete interface device” is defined as an “interface device capable of operating or being operated independently of other discrete interface devices.” The discrete interface devices may be completely unaware of each other, and are not necessarily the same type. For example, discrete interface devices 20*, which will be described in more detail herein, include but are not limited to laptop computers, computer tablets, digital music players, personal navigation systems, net books, smart phones, PDAs, digital still cameras, digital video cameras, vehicle assistance systems, and handheld game devices. For the purposes of this application, the type of interface device is not important, except that it can communicate with a communications network, and that it has device characteristics and status, as will be described in more detail herein.

FIG. 1 also illustrates the interface device vendors 3. In some embodiments, it is the interface device vendors 3 who receive interface devices 20*, and configure the interface devices 20* such that a portion of the interface device has controlled access, as will be described in more detail herein. The interface device vendors 3 may be manufacturers, third party salesmen, or other members of the supply chain, e.g., communication network providers that distribute devices along with signing up for service. Interface device vendors 3 also may include vendors that give away interface devices as part of a promotion, or any other distributor, programmer, manufacturer, modifier, wholesaler, reseller, seller, and retailer of interface devices.

Within the context of this application, “discrete interface device” is defined as an “interface device capable of operating or being operated independently of other discrete interface devices.” The discrete interface devices may be completely unaware of each other, and are not necessarily the same type. For example, discrete interface devices 20*, which will be described in more detail herein, include but are not limited to laptop computers, computer tablets, digital music players, personal navigation systems, net books, smart phones, PDAs, digital still cameras, digital video cameras, vehicle assistance systems, and handheld game devices. For the purposes of this application, the type of interface device is not important, except that it can communicate with a communications network, and that it has device characteristics and status, as will be described in more detail herein.

Referring again to the exemplary environment 100 of FIG. 1, in various embodiments, the task requestors 2 may communicate with a communication network 40. For example, as shown in FIG. 1, task requestors may send a task, e.g., task 5 to a network. In some embodiments, a task 5 sent from a task requestor 2* may be received by computing device (not shown), and separated into its component subtasks. In some embodiments, the computing device may rely on partial human intervention to be separated into its component subtasks. In other embodiments, the computing device may be entirely automated, and may use such techniques as are known in the art to separate tasks into subtasks.

Tasks may be separated into component subtasks using any known type of processing, including neural net processing, natural language processing, machine learning, logic-based processing, and knowledge-based processing. For example, a received task may be “Take a 360 degree picture of the Eiffel Tower.” The computing device may separate it into components of “take a picture of the Eiffel Tower.” Either by consulting machine archives or by predicting how many pictures must be combined to make a 360 degree picture, the system may determine, for example, that 25 pictures of the Eiffel Tower are needed. These twenty-five “take a picture of the Eiffel Tower” subtasks thus are created. The preceding example is merely a simple example of how a computing device may process tasks into subtasks. Other methods, which may be substantially more complex, may be used in this process, but are not discussed in detail here.

The interface devices 20*, including the interface device 20, which is an exemplary discrete interface device that could be any of the types of interface devices 20* or other devices, pictured in FIG. 1B, may communicate via a communications network 40. In various embodiments, the communication network 40 may include one or more of a local area network (LAN), a wide area network (WAN), a metropolitan area network (MAN), a wireless local area network (WLAN), a personal area network (PAN), a Worldwide Interoperability for Microwave Access (WiMAX), public switched telephone network (PTSN), a general packet radio service (GPRS) network, a cellular network, and so forth. The communication networks 40 may be wired, wireless, or a combination of wired and wireless networks. It is noted that “communication network” here refers to communication networks, which may or may not interact with each other. It is further noted, that, in this drawing, communication network 40 is shown having a split between the task requestors 2* and the discrete interface devices 20*. This is because, in embodiments, the discrete interface devices 20* cannot communicate with the task requestors 2*. As will be discussed in more detail herein, the discrete interface devices 20* operate with a smaller subset of information than what is available to task requestors 2* regarding the nature of the task and/or the task requestor, e.g., discrete interface devices 20* operate in an “absence of information regarding the task and/or the task requestor.”

Interface device 20 may include a network interface module 38 to facilitate communications with communications network 40. Network interface module 38, which may be implemented as hardware or software, or both, used to interface the interface device 20 with the one or more communication networks 40. In some embodiments, the network interface module 38 may be a Network Interface Card, e.g., a NIC, or an antenna. The specific structure of network interface module 38 depends on the type or types of one or more communication networks 40 that are used. Particular details of this transmission will be discussed in more detail herein.

Interface device 20 also may include a component interface 34, which is used to interact with the various components of the interface device, and a physical feature interface 36, which may be used to interact with the physical features of the interface device, which may overlap with the various components. As will be discussed herein, these components may be controlled with the processor in different manners depending upon whether a subtask is being executed (e.g., subtask execution interface 42). For example, in some embodiments, before subtasks have been executed, unrelated device feature interface 43 may prevent or limit access to certain portions of the device, but subtask execution interface 42 may allow access to those portions of the device for the purposes of completing subtasks. This is merely an example, and these processes will be described in more detail herein.

Referring again to the example environment 100 of FIG. 1, in various embodiments, the interface device 20 may comprise, among other elements, a processor 32, a memory 34, and a user interface 35. For example, user interface 35 may include, but is not limited to, an audio display, a video display, a microphone, a camera, a keyboard, a mouse, a joystick, a game controller, a touchpad, a handset, or any other device that allows interaction between a computing device and a user. User interface 35 may be subject to the same limitations as described above, in which access to user interface 35 may be controlled by the processing module 50.

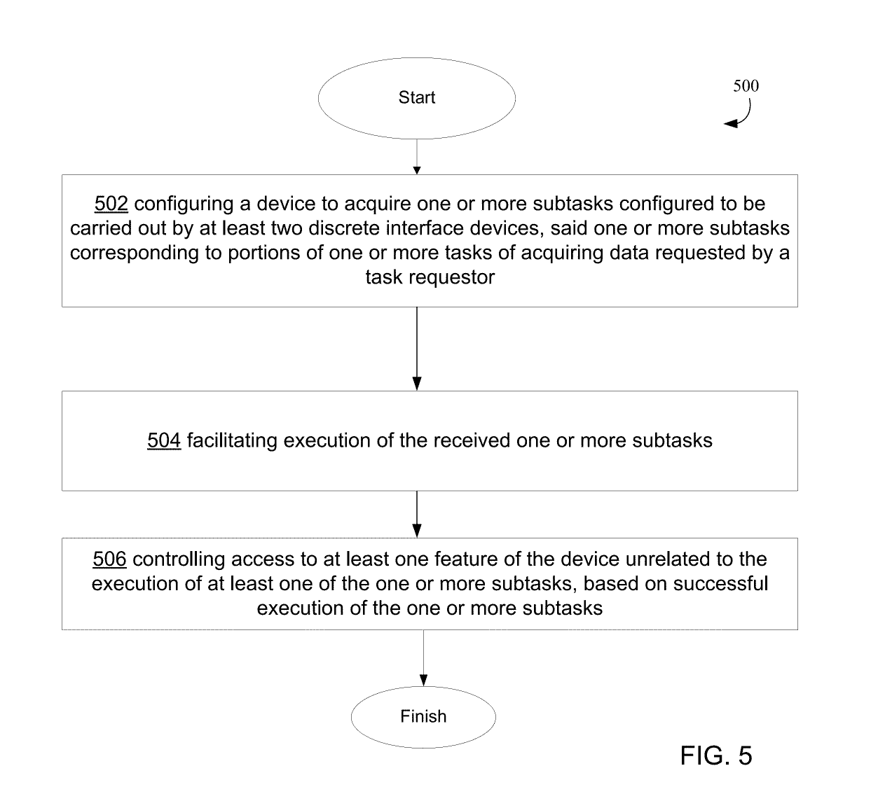

Processor 32 may include one or more microprocessors, Central Processing Units (“CPU”), a Graphics Processing Units (“GPU”), Physics Processing Units, Digital Signal Processors, Network Processors, Floating Point Processors, and the like. In some embodiments, processor 32 may be a server. In some embodiments, processor 32 may be a distributed-core processor. Although processor 32 is depicted as a single processor that is part of a single computing device 30, in some embodiments, processor 32 may be multiple processors distributed over one or many computing devices 30, which may or may not be configured to work together. Processor 32 is illustrated as being configured to execute computer readable instructions in order to execute one or more operations described above, and as illustrated in FIGS. 5, 6A-6D, 7A-7E, and 8A-8P. In some embodiments, processor 32 is designed to be configured to operate as the processing module 50, which may include acquiring one or more subtasks that are portions of one or more tasks of acquiring data and configured to execute on two or more discrete interface devices device configuring module 52, received one or more subtasks requested by a task requestor execution facilitating module 54, and received one or more subtasks requested by a task requestor execution facilitating module 56.

Referring again to FIG. 1, interface device 20 may comprise a memory 34. In some embodiments, memory 34 may comprise of one or more of one or more mass storage devices, read-only memory (ROM), programmable read-only memory (PROM), erasable programmable read-only memory (EPROM), cache memory such as random access memory (RAM), flash memory, synchronous random access memory (SRAM), dynamic random access memory (DRAM), and/or other types of memory devices. In some embodiments, memory 34 may be located at a single network site. In other embodiments, memory 34 may be located at multiple network sites, including sites that are distant from each other.

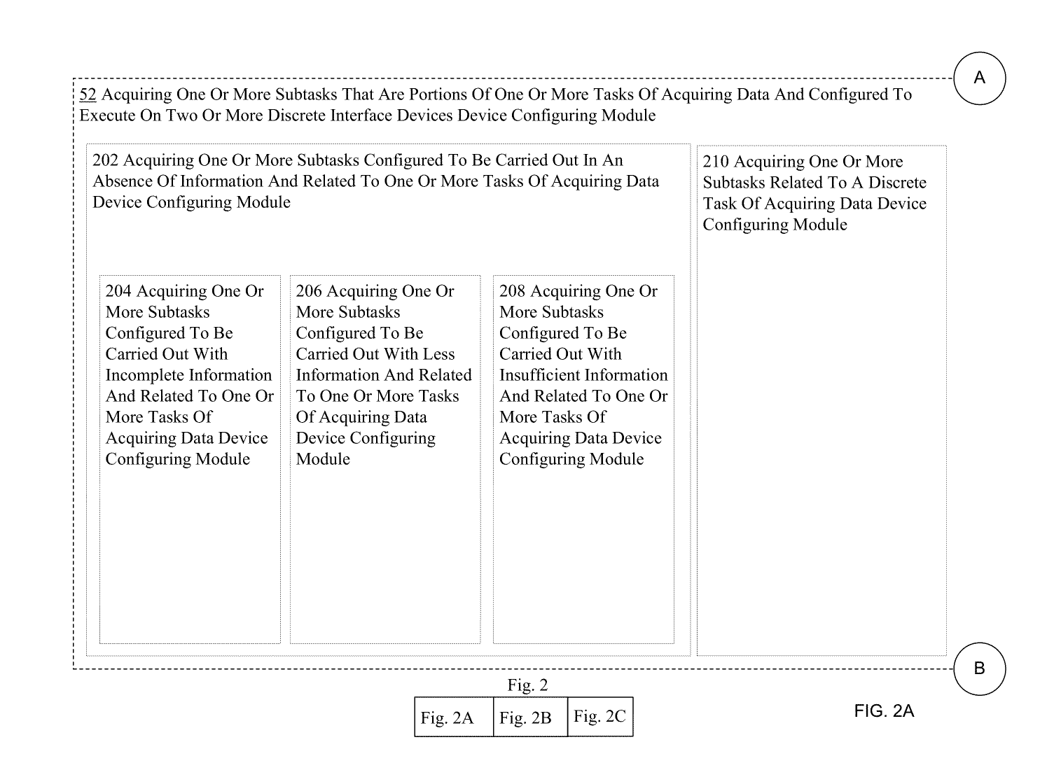

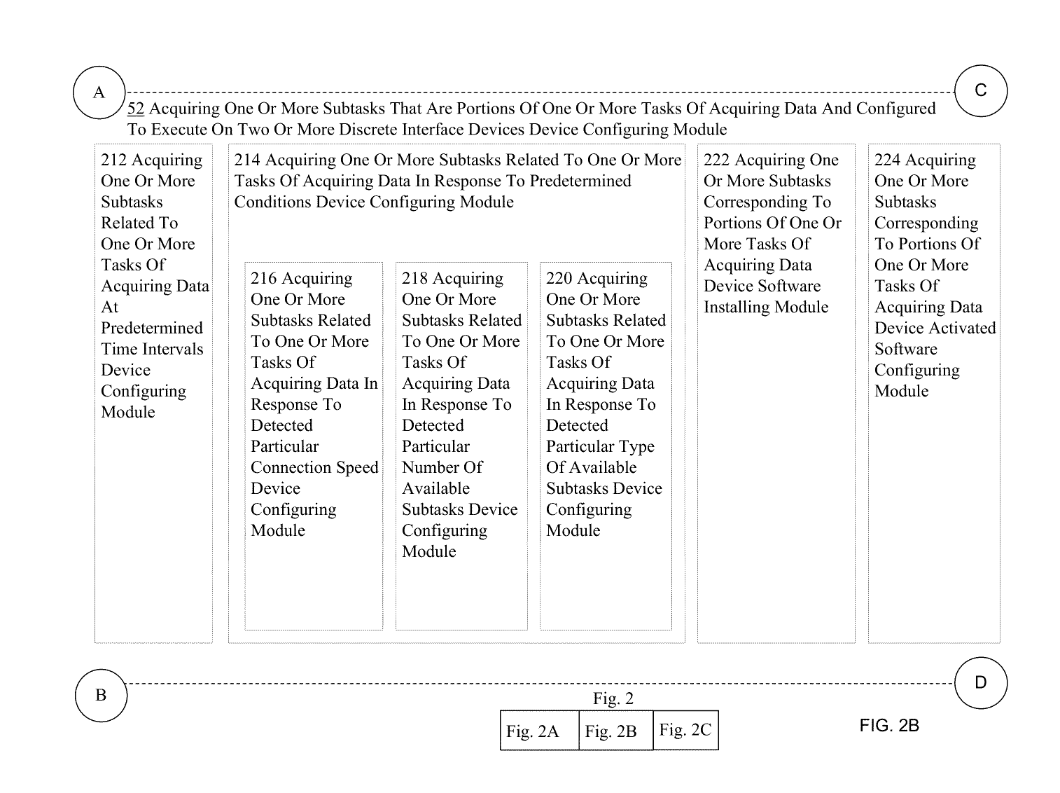

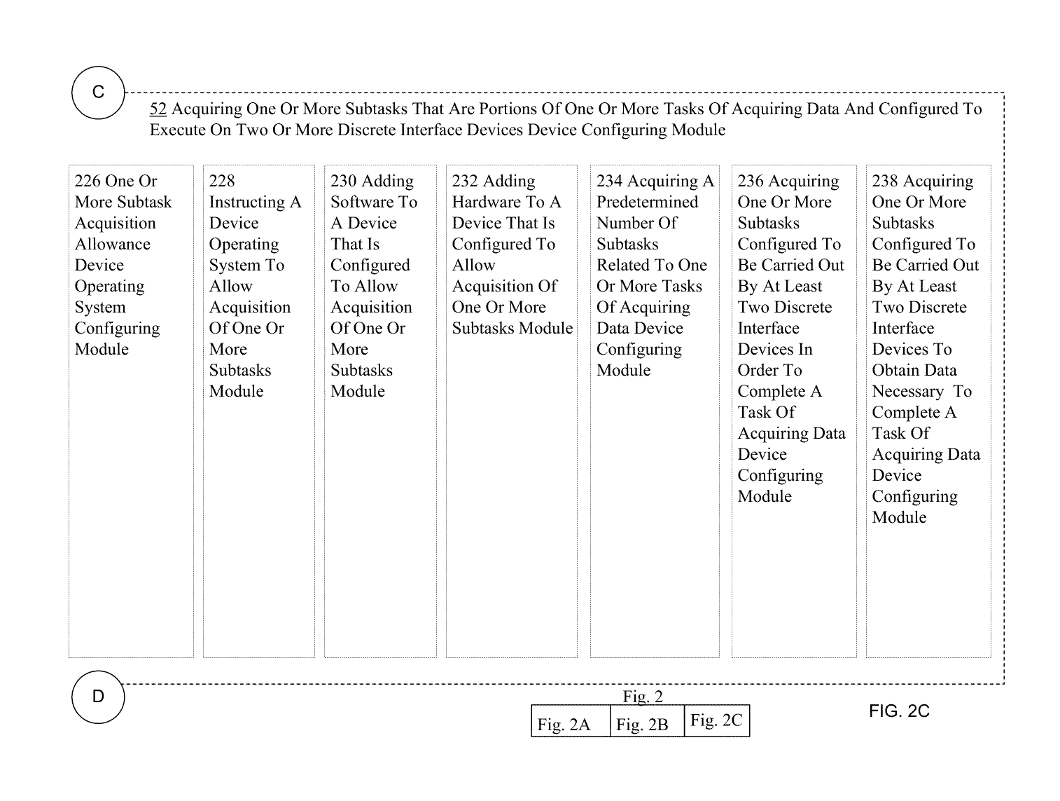

Referring now to FIG. 2, FIG. 2 illustrates an exemplary implementation of the acquiring one or more subtasks that are portions of one or more tasks of acquiring data and configured to execute on two or more discrete interface devices device configuring module 52 of the module 50. As illustrated in FIG. 2, the acquiring one or more subtasks that are portions of one or more tasks of acquiring data and configured to execute on two or more discrete interface devices device configuring module 52 may include one or more sub-logic modules in various alternative implementations and embodiments. For example, in some embodiments, module 52 may include acquiring one or more subtasks configured to be carried out in an absence of information and related to one or more tasks of acquiring data device configuring module 202 (e.g., which, in some embodiments, may include acquiring one or more subtasks configured to be carried out with incomplete information and related to one or more tasks of acquiring data device configuring module 204, acquiring one or more subtasks configured to be carried out with less information and related to one or more tasks of acquiring data device configuring module 206, and acquiring one or more subtasks configured to be carried out with insufficient information and related to one or more tasks of acquiring data device configuring module 208). In some embodiments, module 52 may include acquiring one or more subtasks related to a discrete task of acquiring data device configuring module 210.

Referring again to FIG. 2, in some embodiments, module 52 may include acquiring one or more subtasks related to one or more tasks of acquiring data at predetermined time intervals device configuring module 212, acquiring one or more subtasks related to one or more tasks of acquiring data in response to predetermined conditions device configuring module 214 (e.g., which, in some embodiments, may include acquiring one or more subtasks related to one or more tasks of acquiring data in response to detected particular connection speed device configuring module 216, acquiring one or more subtasks related to one or more tasks of acquiring data in response to detected particular number of available subtasks device configuring module 218, and acquiring one or more subtasks related to one or more tasks of acquiring data in response to detected particular type of available subtasks device configuring module 220), acquiring one or more subtasks corresponding to portions of one or more tasks of acquiring data device software installing module 222, and acquiring one or more subtasks corresponding to portions of one or more tasks of acquiring data device activated software configuring module 224.

Referring again to FIG. 2, in some embodiments, module 52 may include one or more subtask acquisition allowance device operating system configuring module 226, instructing a device operating system to allow acquisition of one or more subtasks module 228, adding software to a device that is configured to allow acquisition of one or more subtasks module 230, adding hardware to a device that is configured to allow acquisition of one or more subtasks module 232, acquiring a predetermined number of subtasks related to one or more tasks of acquiring data device configuring module 234, acquiring one or more subtasks configured to be carried out by at least two discrete interface devices in order to complete a task of acquiring data device configuring module 236, and acquiring one or more subtasks configured to be carried out by at least two discrete interface devices to obtain data necessary to complete a task of acquiring data device configuring module 238.

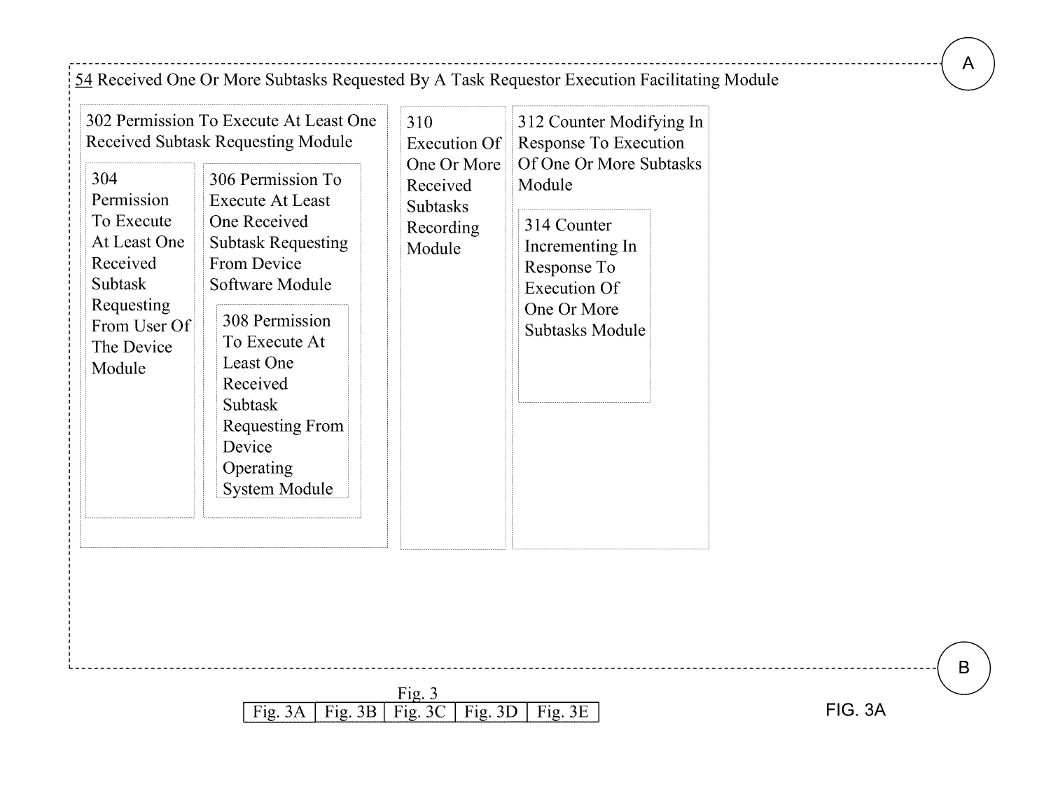

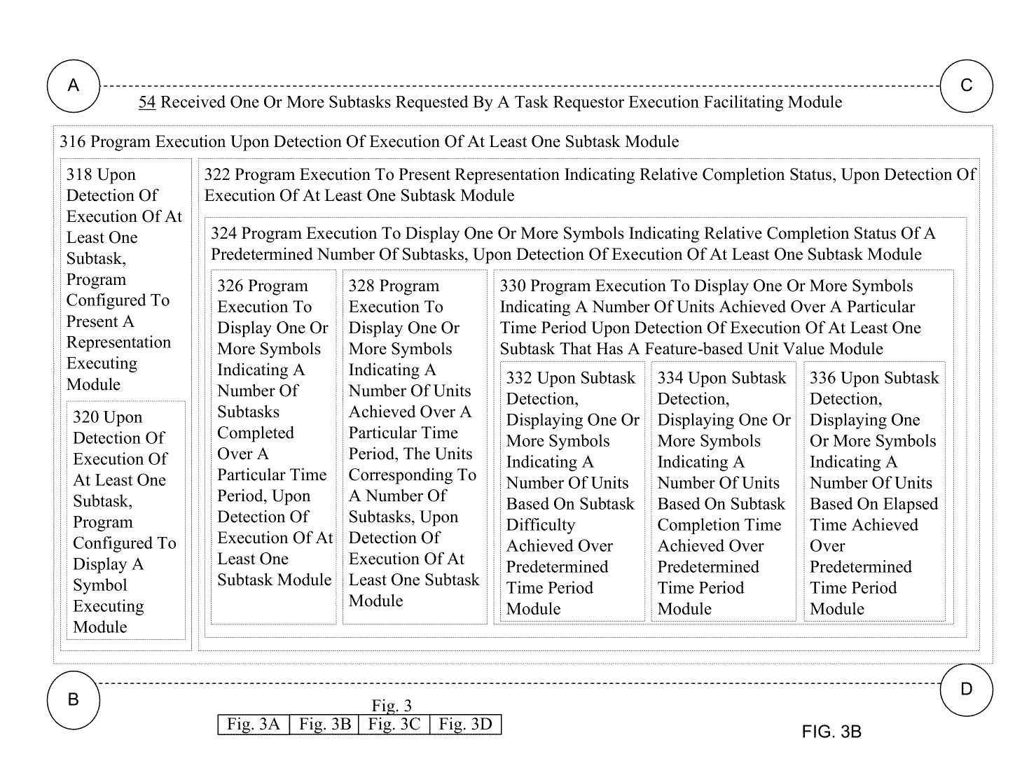

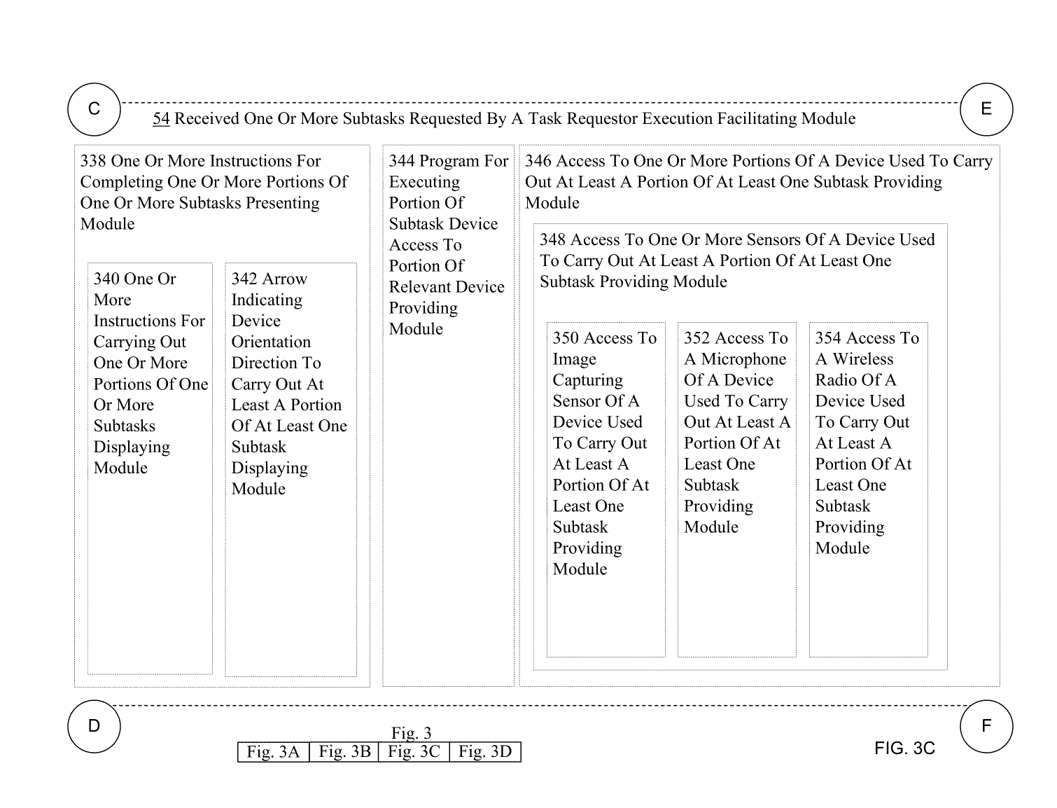

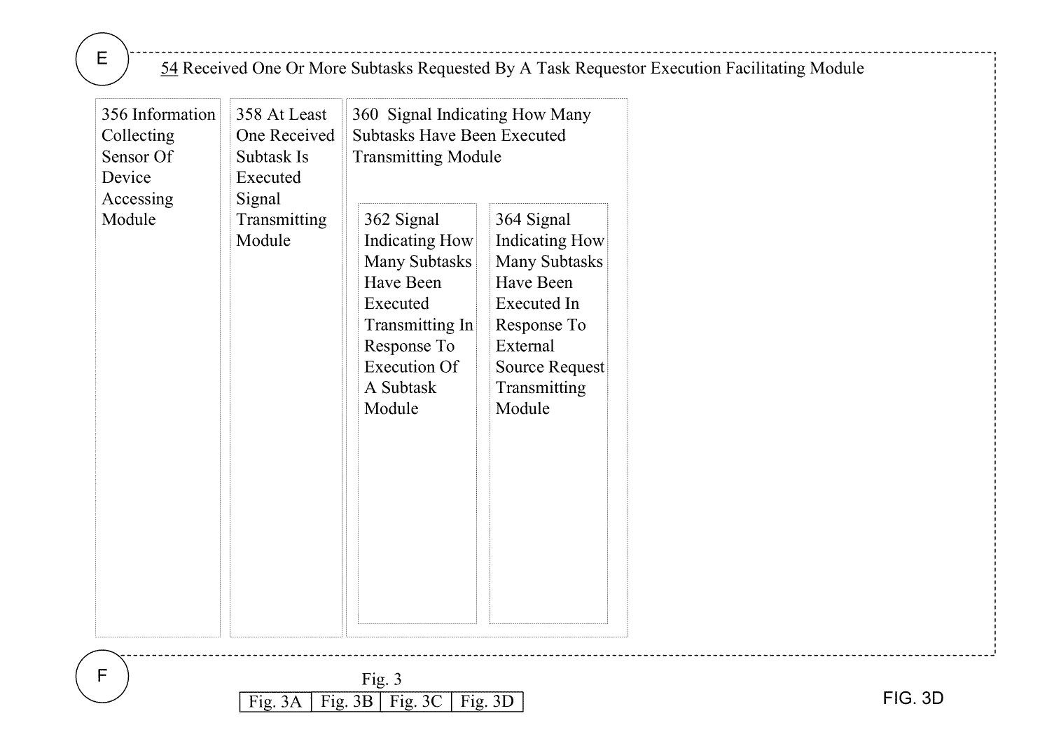

Referring now to FIG. 3, FIG. 3 illustrates an exemplary implementation of the received one or more subtasks requested by a task requestor execution facilitating module 54 of the module 50. As illustrated in FIG. 3, module 54 may include one or more sub-logic modules in various alternative implementations and embodiments. As illustrated in FIG. 3, in some embodiments, module 54 may include permission to execute at least one received subtask requesting module (e.g., which, in some embodiments, may include permission to execute at least one received subtask requesting from user of the device module 304 and permission to execute at least one received subtask requesting from device software module 306 (e.g., which, in some embodiments, may include permission to execute at least one received subtask requesting from device operating system module 308)), execution of one or more received subtasks recording module 310, and counter modifying in response to execution of one or more subtasks module 312.

Referring again to FIG. 3, in some embodiments, module 54 may include program execution upon detection of execution of at least one subtask module 316. In some embodiments, module 316 may include upon detection of execution of at least one subtask, program configured to present a representation executing module 318 (e.g., which, in some embodiments, may include upon detection of execution of at least one subtask, program configured to display a symbol executing module 320) and program execution to present representation indicating relative completion status, upon detection of execution of at least one subtask module 322. In some embodiments, module 322 may include 324 program execution to display one or more symbols indicating relative completion status of a predetermined number of subtasks, upon detection of execution of at least one subtask module 324. In some embodiments, module 324 may include Program execution to display one or more symbols indicating a number of subtasks completed over a particular time period, upon detection of execution of at least one subtask module 326, program execution to display one or more symbols indicating a number of units achieved over a particular time period, the units corresponding to a number of subtasks, upon detection of execution of at least one subtask module 328, and program execution to display one or more symbols indicating a number of units achieved over a particular time period upon detection of execution of at least one subtask that has a feature-based unit value module 330. In some embodiments, module 330 may include upon subtask detection, displaying one or more symbols indicating a number of units based on subtask difficulty achieved over predetermined time period module 332, upon subtask detection, displaying one or more symbols indicating a number of units based on subtask completion time achieved over predetermined time period module 334, and upon subtask detection, displaying one or more symbols indicating a number of units based on elapsed time achieved over predetermined time period module 336.

Referring again to FIG. 3, in some embodiments, module 54 may include one or more instructions for completing one or more portions of one or more subtasks presenting module 338 (e.g., which, in some embodiments, may include one or more instructions for carrying out one or more portions of one or more subtasks displaying module 340, and arrow indicating device orientation direction to carry out at least a portion of at least one subtask displaying module 342), program for executing portion of subtask device access to portion of relevant device providing module 344, and access to one or more portions of a device used to carry out at least a portion of at least one subtask providing module 346. In some embodiments, module 346 may include access to one or more sensors of a device used to carry out at least a portion of at least one subtask providing module 348. In some embodiments, module 348 may include access to image capturing sensor of a device used to carry out at least a portion of at least one subtask providing module 350, access to a microphone of a device used to carry out at least a portion of at least one subtask providing module 352, and access to a wireless radio of a device used to carry out at least a portion of at least one subtask providing module 354.

Referring again to FIG. 3, in some embodiments, module 54 may include information collecting sensor of device accessing module 356, at least one received subtask is executed signal transmitting module 358, and signal indicating how many subtasks have been executed transmitting module 360. In some embodiments, module 360 may include signal indicating how many subtasks have been executed transmitting in response to execution of a subtask module 362 and signal indicating how many subtasks have been executed in response to external source request transmitting module 364.

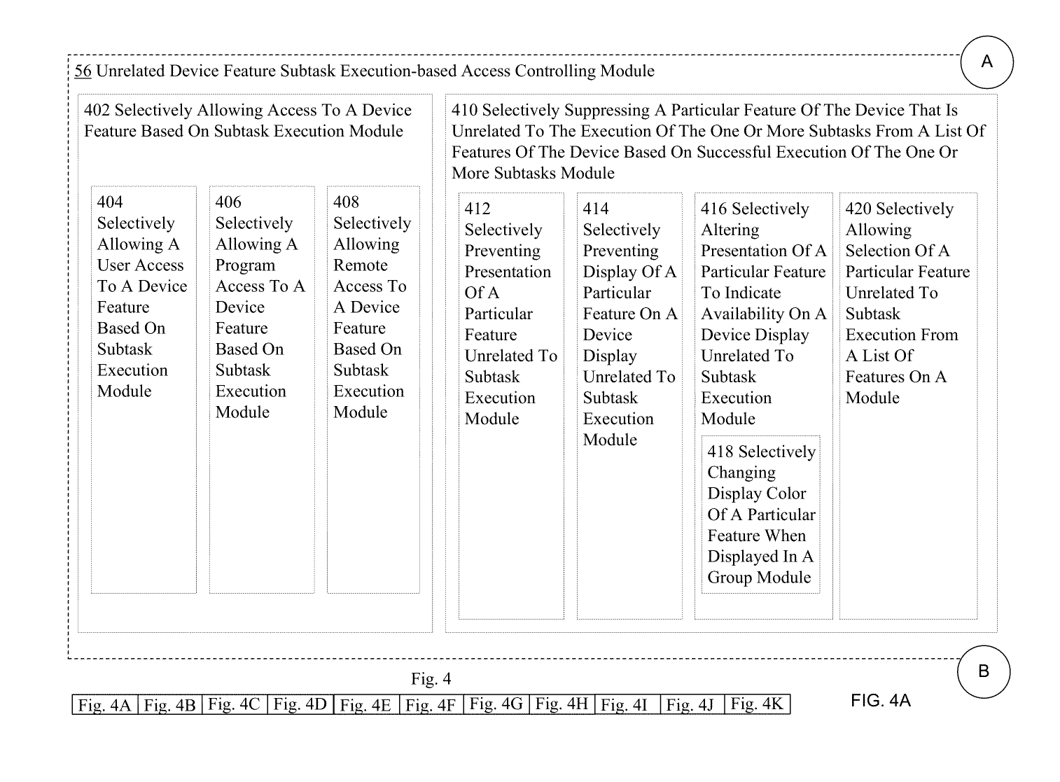

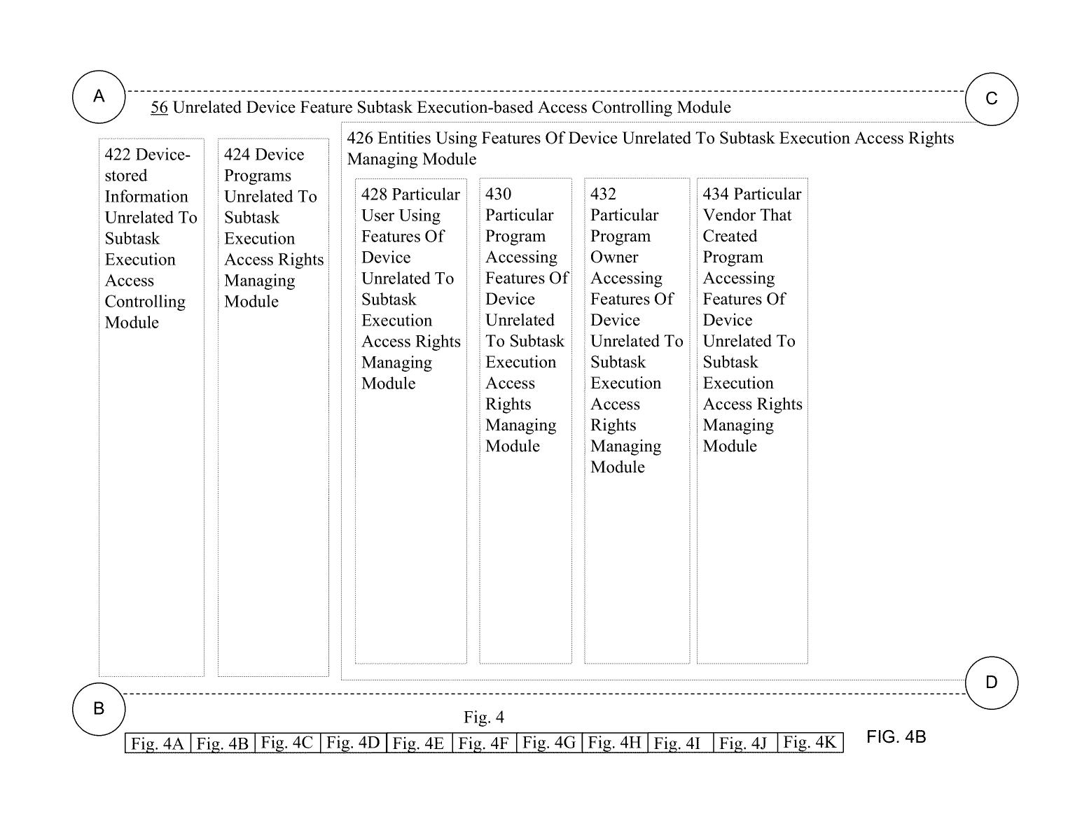

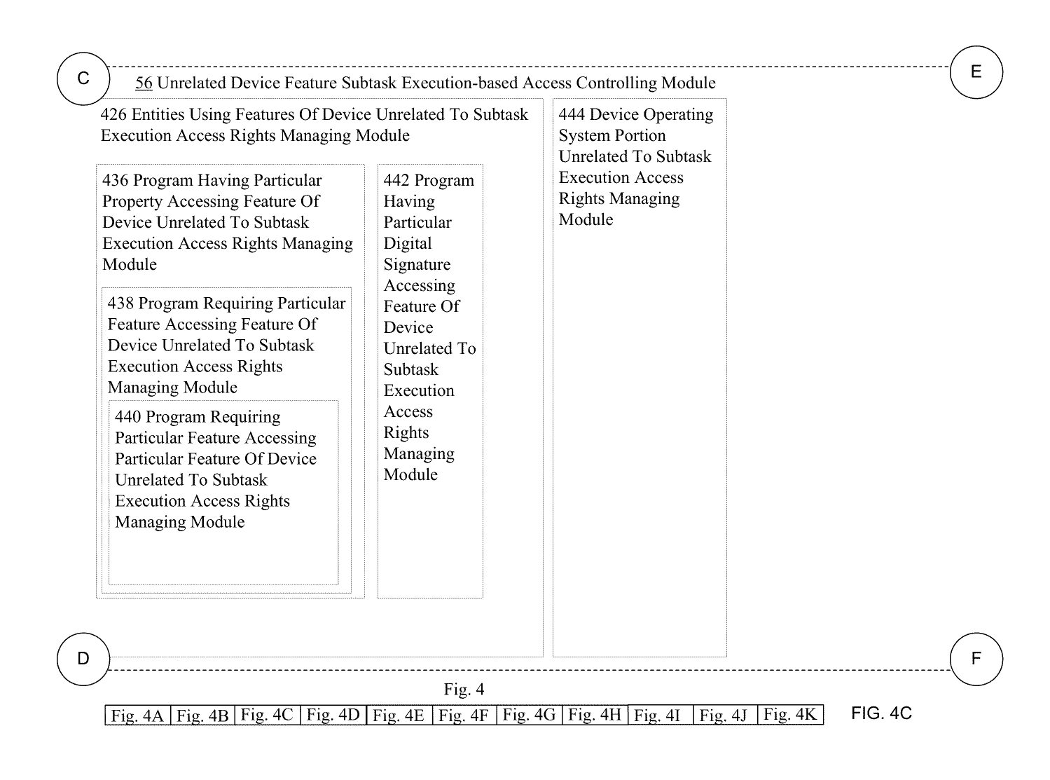

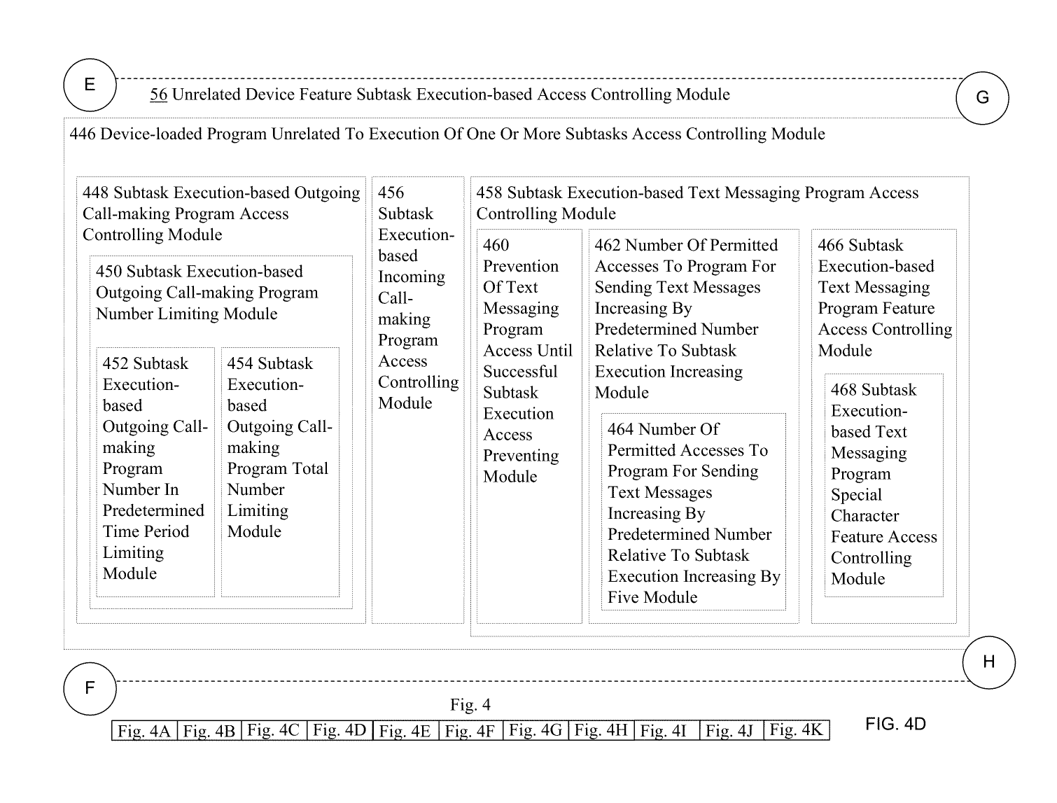

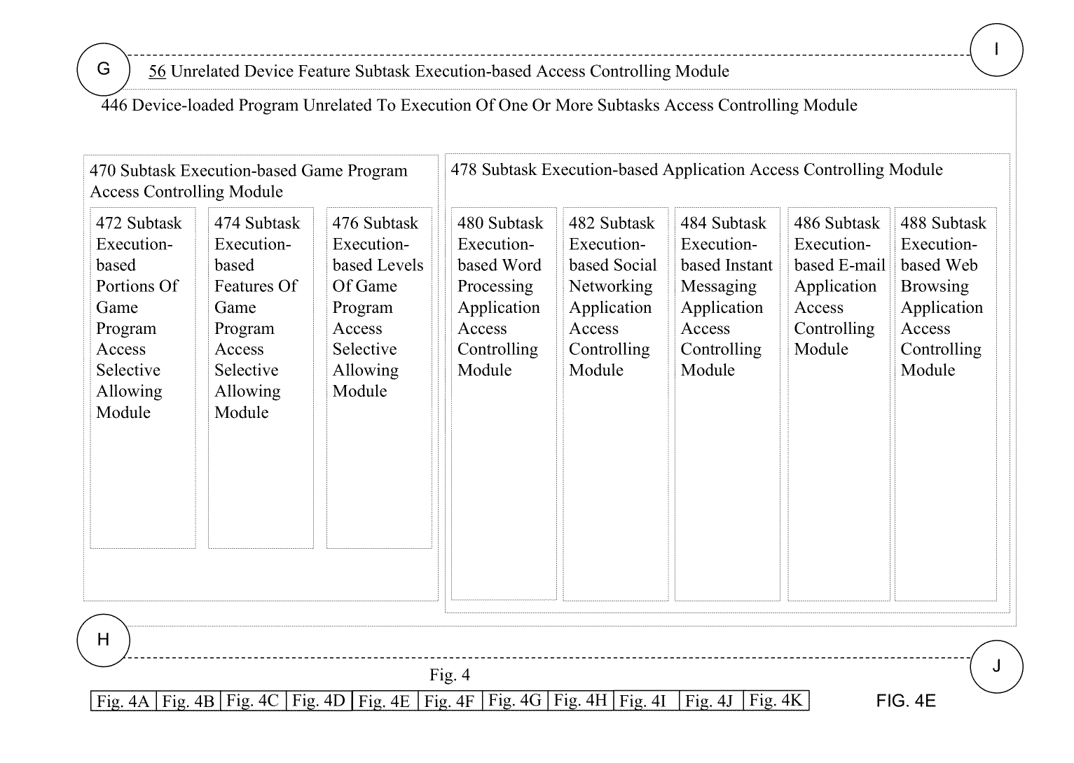

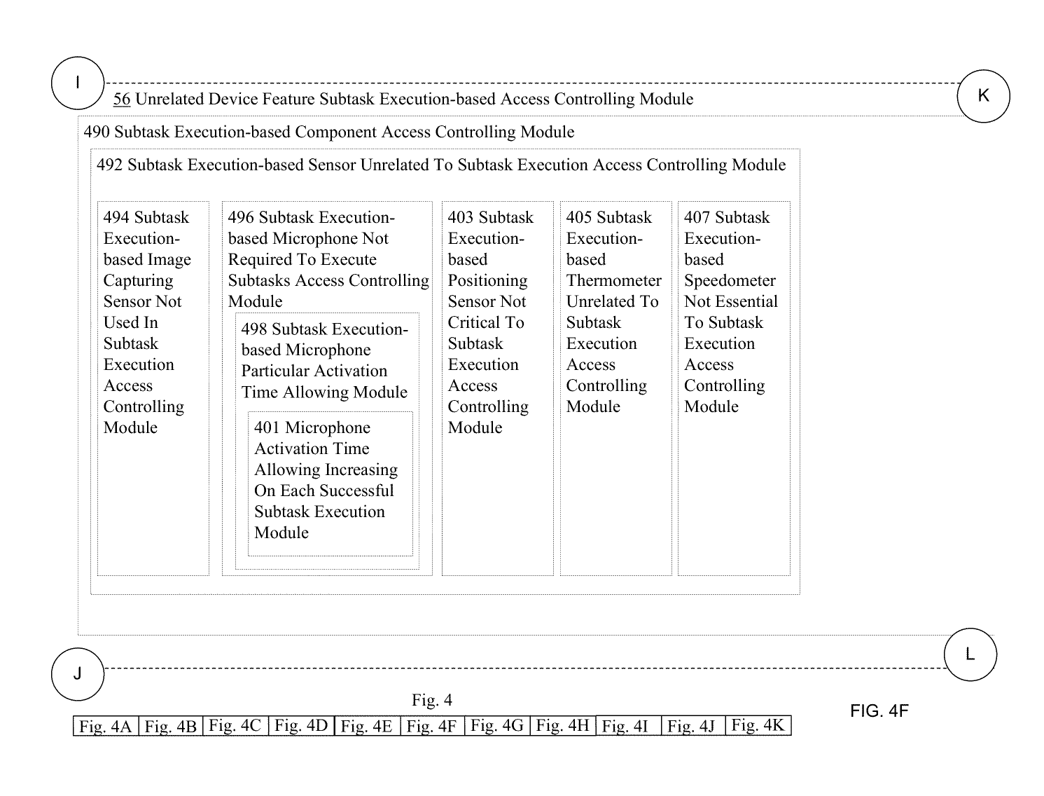

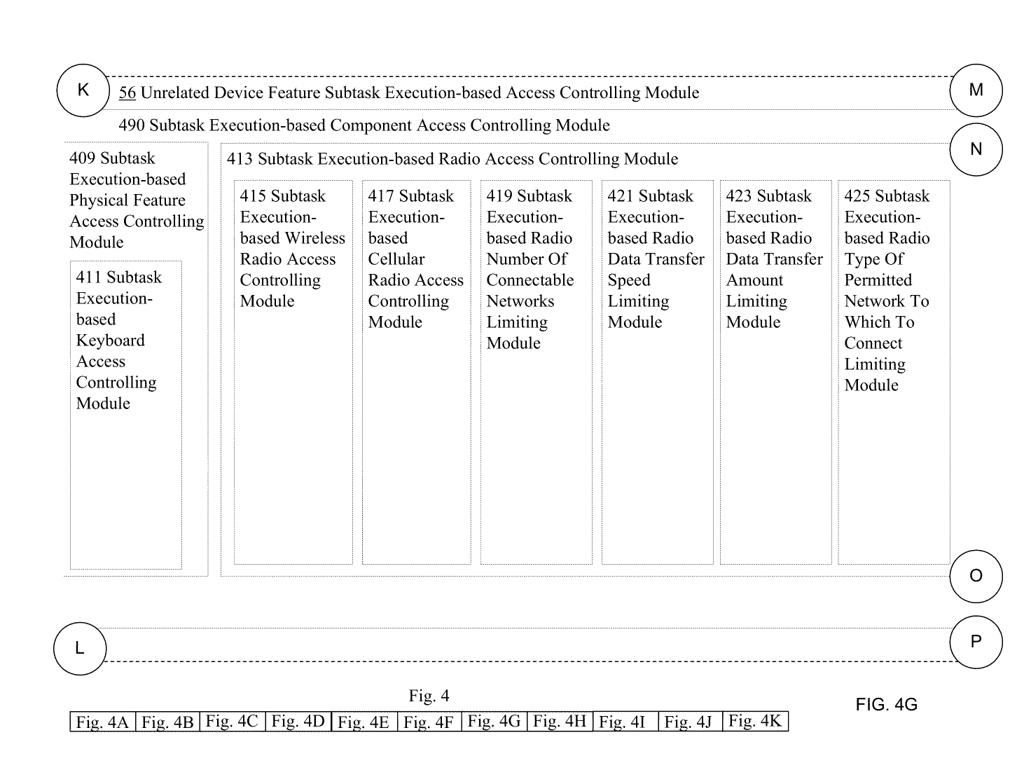

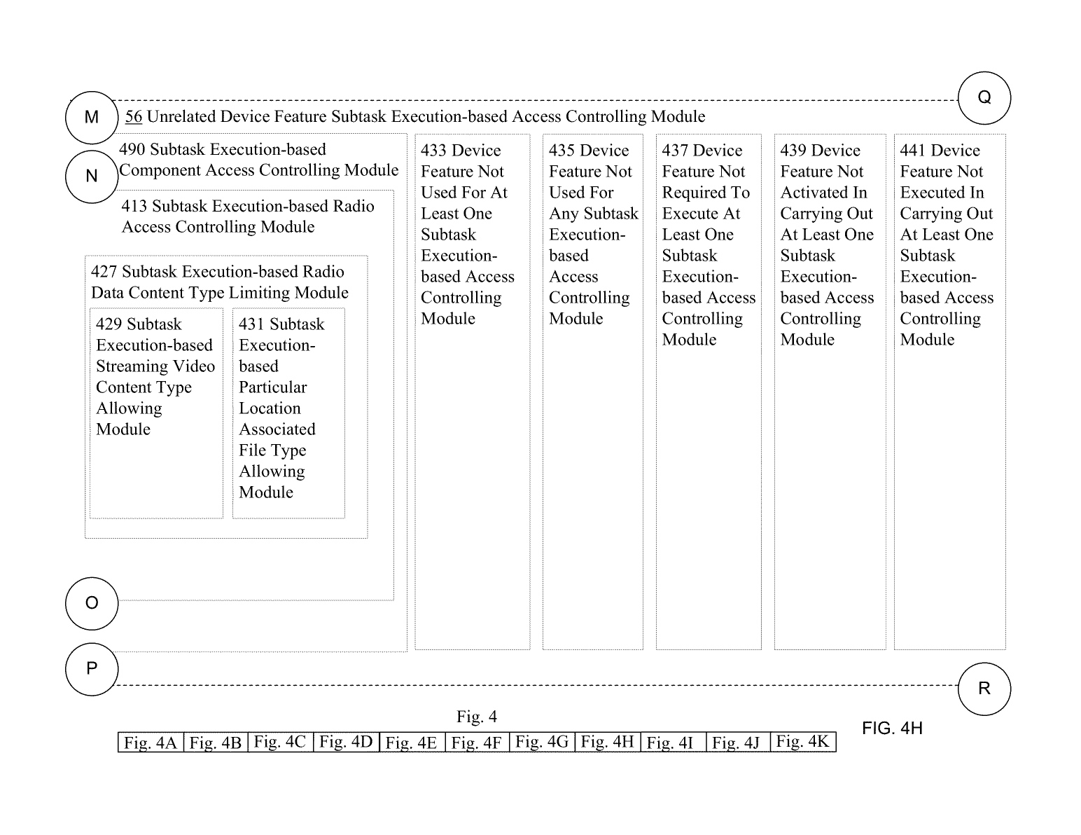

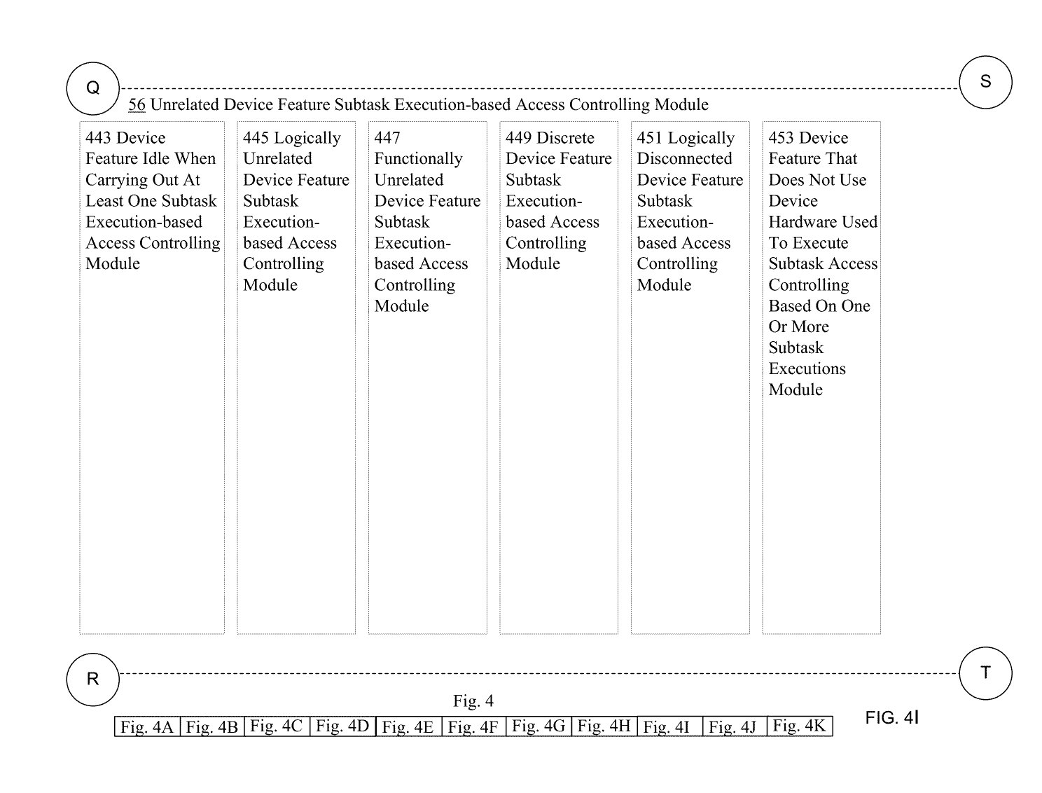

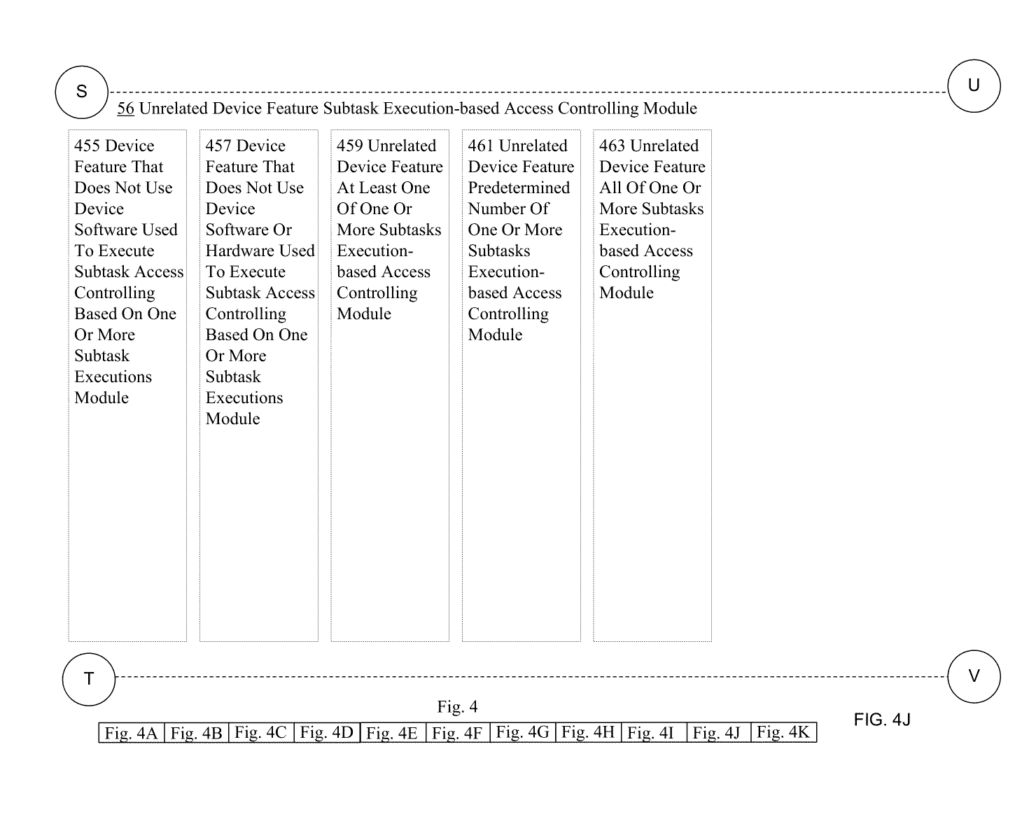

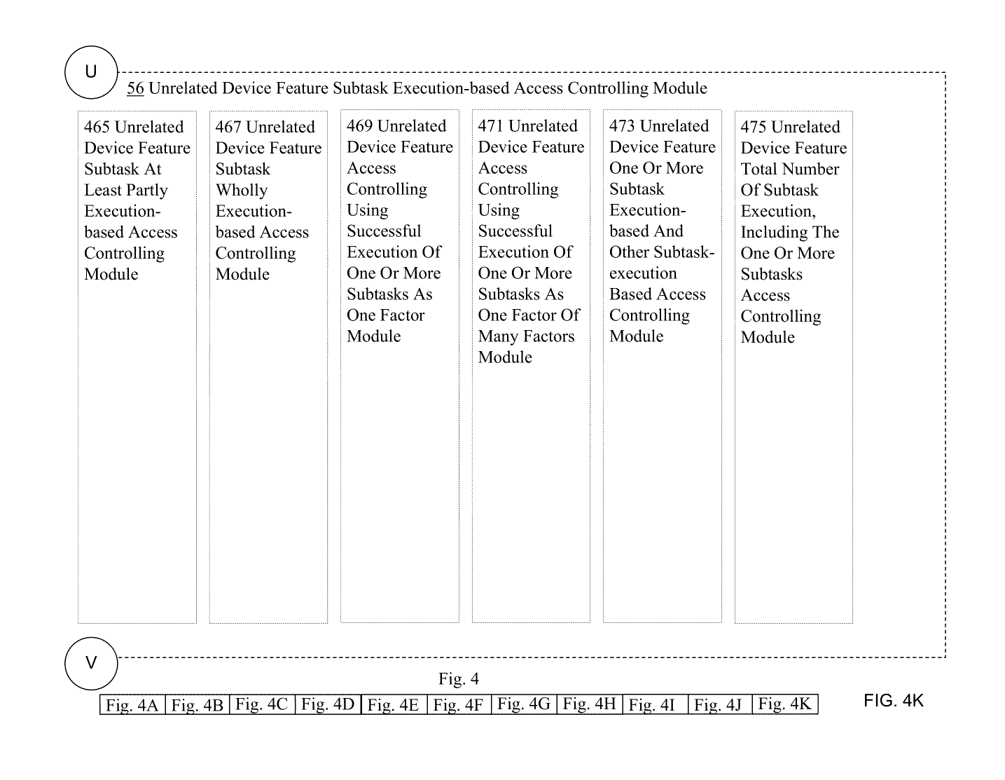

Referring now to FIG. 4, FIG. 4 illustrates an exemplary implementation of the unrelated device feature subtask execution-based access controlling module 56 of the module 50. As illustrated in FIG. 4, module 56 may include one or more sub-logic modules in various alternative implementations and embodiments. As illustrated in FIG. 4, in some embodiments, module 56 may include selectively allowing access to a device feature based on subtask execution module 402 (e.g., which, in some embodiments, may include selectively allowing a user access to a device feature based on subtask execution module 404, selectively allowing a program access to a device feature based on subtask execution module 406, and selectively allowing remote access to a device feature based on subtask execution module 408), and selectively suppressing a particular feature of the device that is unrelated to the execution of the one or more subtasks from a list of features of the device based on successful execution of the one or more subtasks module 410. In some embodiments, module 410 may include selectively preventing presentation of a particular feature unrelated to subtask execution module 412, selectively preventing display of a particular feature on a device display unrelated to subtask execution module 414, selectively altering presentation of a particular feature to indicate availability on a device display unrelated to subtask execution module 416 (e.g., which, in some embodiments, may include selectively changing display color of a particular feature when displayed in a group module 418), and selectively allowing selection of a particular feature unrelated to subtask execution from a list of features on a module 420.

Referring again to FIG. 4, in some embodiments, module 56 may include device-stored information unrelated to subtask execution access controlling module 422, device programs unrelated to subtask execution access rights managing module 424, and entities using features of device unrelated to subtask execution access rights managing module 426. In some embodiments, module 426 may include particular user using features of device unrelated to subtask execution access rights managing module 428, particular program accessing features of device unrelated to subtask execution access rights managing module 430, particular program owner accessing features of device unrelated to subtask execution access rights managing module 432, and particular vendor that created program accessing features of device unrelated to subtask execution access rights managing module 434.

Referring again to FIG. 4, in some embodiments, module 426 may further include program having particular property accessing feature of device unrelated to subtask execution access rights managing module 436 (e.g., which, in some embodiments, may include program requiring particular feature accessing feature of device unrelated to subtask execution access rights managing module 438 (e.g., which, in some embodiments, may include program requiring particular feature accessing particular feature of device unrelated to subtask execution access rights managing module 440)) and program having particular digital signature accessing feature of device unrelated to subtask execution access rights managing module 442, and device operating system portion unrelated to subtask execution access rights managing module 444.

Referring again to FIG. 4, in some embodiments, module 56 may include device-loaded program unrelated to execution of one or more subtasks access controlling module 446. In some embodiments, module 446 may include subtask execution-based outgoing call-making program access controlling module 448 (e.g., which, in some embodiments, may include subtask execution-based outgoing call-making program number limiting module 450 (e.g., which, in some embodiments, may include subtask execution-based outgoing call-making program number in predetermined time period limiting module 452 and subtask execution-based outgoing call-making program total number limiting module 454)), subtask execution-based incoming call-making program access controlling module 456, and subtask execution-based text messaging program access controlling module 458. Module 458 may include prevention of text messaging program access until successful subtask execution access preventing module 460, number of permitted accesses to program for sending text messages increasing by predetermined number relative to subtask execution increasing module 462 (e.g., which, in some embodiments, may include number of permitted accesses to program for sending text messages increasing by predetermined number relative to subtask execution increasing by five module 464), subtask execution-based text messaging program feature access controlling module 466 (e.g., which, in some embodiments, may include subtask execution-based text messaging program special character feature access controlling module 468.

Referring again to FIG. 4, in some embodiments, module 446 may further include subtask execution-based game program access controlling module 470 (e.g., which, in some embodiments, may include subtask execution-based portions of game program access selective allowing module 472, subtask execution-based features of game program access selective allowing module 474, and subtask execution-based levels of game program access selective allowing module 476) and subtask execution-based application access controlling module 478. Module 478 may, in some embodiments, include subtask execution-based word processing application access controlling module 480, subtask execution-based social networking application access controlling module 482, subtask execution-based instant messaging application access controlling module 484, subtask execution-based e-mail application access controlling module 486, and subtask execution-based web browsing application access controlling module 488.

Referring again to FIG. 4, in some embodiments, module 56 may include subtask execution-based component access controlling module 490. In some embodiments, module 490 may include subtask execution-based sensor unrelated to subtask execution access controlling module 492. In some embodiments, module 492 may include subtask execution-based image capturing sensor not used in subtask execution access controlling module 494, subtask execution-based microphone not required to execute subtasks access controlling module 496 (e.g., which, in some embodiments, may include subtask execution-based microphone particular activation time allowing module 498 (e.g., which, in some embodiments, may include microphone activation time allowing increasing on each successful subtask execution module 401)), subtask execution-based positioning sensor not critical to subtask execution access controlling module 403, subtask execution-based thermometer unrelated to subtask execution access controlling module 405, and subtask execution-based speedometer not essential to subtask execution access controlling module 407.

Referring again to FIG. 4, in some embodiments, module 490 may further include subtask execution-based physical feature access controlling module 409 (e.g., which, in some embodiments, may include subtask execution-based keyboard access controlling module 411), and subtask execution-based radio access controlling module 413. In some embodiments, module 413 may include subtask execution-based wireless radio access controlling module 415, subtask execution-based cellular radio access controlling module 417, subtask execution-based radio number of connectable networks limiting module 419, subtask execution-based radio data transfer speed limiting module 421, subtask execution-based radio data transfer amount limiting module 423, and subtask execution-based radio type of permitted network to which to connect limiting module 425.

Referring again to Fig, 4, in some embodiments, module 413 may further include subtask execution-based radio data content type limiting module 427. Module 427 may include subtask execution-based streaming video content type allowing module 429 and subtask execution-based particular location associated file type allowing module 431. In some embodiments, module 56 may include device feature not used for at least one subtask execution-based access controlling module 433, device feature not used for any subtask execution-based access controlling module 435, device feature not required to execute at least one subtask execution-based access controlling module 437, device feature not activated in carrying out at least one subtask execution-based access controlling module 439, and device feature not executed in carrying out at least one subtask execution-based access controlling module 441.

Referring again to Fig, 4, in some embodiments, module 56 may further include device feature idle when carrying out at least one subtask execution-based access controlling module 443, logically unrelated device feature subtask execution-based access controlling module 445, functionally unrelated device feature subtask execution-based access controlling module 447, discrete device feature subtask execution-based access controlling module 449, logically disconnected device feature subtask execution-based access controlling module 451, and device feature that does not use device hardware used to execute subtask access controlling based on one or more subtask executions module 453.

Referring again to Fig, 4, in some embodiments, module 56 may further include device feature that does not use device software used to execute subtask access controlling based on one or more subtask executions module 455, device feature that does not use device software or hardware used to execute subtask access controlling based on one or more subtask executions module 457, unrelated device feature at least one of one or more subtasks execution-based access controlling module 459, unrelated device feature predetermined number of one or more subtasks execution-based access controlling module 461, and unrelated device feature all of one or more subtasks execution-based access controlling module 463.

Referring again to Fig, 4, in some embodiments, module 56 may further include unrelated device feature subtask at least partly execution-based access controlling module 465, unrelated device feature subtask wholly execution-based access controlling module 467, unrelated device feature access controlling using successful execution of one or more subtasks as one factor module 469, unrelated device feature access controlling using successful execution of one or more subtasks as one factor of many factors module 471, unrelated device feature one or more subtask execution-based and other subtask-execution based access controlling module 473, and unrelated device feature total number of subtask execution, including the one or more subtasks access controlling module 475.

A more detailed discussion related to interface device 20 of FIG. 1 now will be provided with respect to the processes and operations to be described herein. Referring now to FIG. 5, FIG. 5 illustrates an operational flow 500 representing example operations for, among other methods, configuring a device to acquire one or more subtasks configured to be carried out by at least two discrete interface devices, said one or more subtasks corresponding to portions of one or more tasks of acquiring data requested by a task requestor, facilitating execution of the received one or more subtasks, and controlling access to at least one feature of the device unrelated to the execution of the one or more subtasks, based on successful execution of the one or more subtasks. In FIG. 5 and in the following figures that include various examples of operational flows, discussions and explanations will be provided with respect to the exemplary environment 100 as described above and as illustrated in FIG. 1, and with respect to other examples (e.g., as provided in FIGS. 2-4) and contexts. It should be understood that the operational flows may be executed in a number of other environments and contexts, and/or in modified versions of the systems shown in FIGS. 2-4. Although the various operational flows are presented in the sequence(s) illustrated, it should be understood that the various operations may be performed in other orders other than those which are illustrated, or may be performed concurrently.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Following are a series of flowcharts depicting implementations. For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

Further, in FIG. 5 and in the figures to follow thereafter, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently. Still further, these operations illustrated in FIG. 4 as well as the other operations to be described herein may be performed by at least one of a machine, an article of manufacture, or a composition of matter.

It is noted that, for the examples set forth in this application, the tasks and subtasks are commonly represented by short strings of text. This representation is merely for ease of explanation and illustration, and should not be considered as defining the format of tasks and subtasks. Rather, in various embodiments, the tasks and subtasks may be stored and represented in any data format or structure, including numbers, strings, Booleans, classes, methods, complex data structures, and the like.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

Throughout this application, examples and lists are given, with parentheses, the abbreviation “e.g.,” or both. Unless explicitly otherwise stated, these examples and lists are merely exemplary and are non-exhaustive. In most cases, it would be prohibitive to list every example and every combination. Thus, smaller, illustrative lists and examples are used, with focus on imparting understanding of the claim terms rather than limiting the scope of such terms.

Referring again to FIG. 5, FIG. 5 shows operation 500 that includes operation 502 depicting configuring a device to acquire one or more subtasks configured to be carried out by at least two discrete interface devices, said one or more subtasks corresponding to portions of one or more tasks of acquiring data requested by a task requestor. For example, FIG. 1 shows acquiring one or more subtasks related to one or more tasks of acquiring data device configuring module 52 configuring (e.g., performing some action, or changing a setting, activating a piece of hardware or software) a device (e.g., an interface device, e.g., a physical object that processes data, a non-exhaustive list of which is provided elsewhere in this application) to acquire (e.g., to retrieve (e.g., from a database, either internal or external, from memory, from a storage of any type, from a network location), receive (e.g., from user input, from a list or other data structure), create, generate, find, get, have delivered, or cause to be delivered) one or more subtasks (e.g., “capture the view from your iPad's cameras when you're positioned at Times Square in New York”) configured to be carried out by at least two discrete interface devices (e.g., designed such that multiple devices that operate independently carry out the subtasks, e.g., your iPad, and an iPad of someone across the street, and a digital camera held by someone on a park bench, and an ATM surveillance camera pointed at Times Square all can run a subtask in order to compile the information needed to carry out the task), said one or more subtasks corresponding to portions of one or more tasks of acquiring data (e.g., “acquire a real-time picture of Times Square in New York to determine which ads are most prominently displayed at 8:55 am”) requested (e.g., originated, or initially created) by a task requestor (e.g., IDF Advertising Agency).

As used in this application, a “task requestor” may refer to the entity that requests the task, e.g., the corporation or other similar business structure, or an individual working as an agent of the business structure. A “task requestor” also may refer to an individual requesting information on his or her own (e.g., a single person sitting at a terminal in Williamson, W.Va. may desire to see what Times Square looks like on his birthday). In addition, a “task requestor” may refer to the hardware or software used by the individual or entity to make the request, e.g., the computer used by the person, or the network utilized by the company. Further, the “task requestor” may refer to software, either local or centralized, that allows task requests. For example, a third party may create a querying website where users, whether personal, corporate, or automated machines, can input queries such as “show me a real time 360-degree picture of Yankee Stadium”. In some embodiments, the task requestor may refer to an aggregator that collects task requests. The aggregator in such embodiments may or may not perform some processing on the task requests, including, but not limited to, grouping, preprocessing, filtering, and the like. In such embodiments, the aggregator may also be considered to be the “task requestor.”

Referring again to FIG. 5, operation 500 includes operation 504 depicting facilitating execution of the received one or more subtasks. For example, FIG. 1 shows received one or more subtasks requested by a task requestor execution facilitating module 54 facilitating execution (e.g., carrying out some action which impacts or is part of, related to, or otherwise affected by, e.g., “notifying the user that the camera is about to be used to take a picture of the current location to carry out the subtask of ‘capture the view from your iPad's cameras when you're positioned at Times Square in New York’) of the received one or more subtasks (e.g., “capture the view from your iPad's cameras when you're positioned at Times Square in New York”).

It is specifically noted that, within the context of this application, the term facilitating execution includes logging or counting that the execution took place successfully, as will be discussed in more detail herein. This definition is meant to be open-ended and is not all-inclusive or limiting the term “facilitating” or “execution” from their definitions as used in this specification and as understood by those of ordinary skill in the art.

Referring again to FIG. 5, operation 500 includes operation 506 depicting controlling access to at least one feature of the device unrelated to the execution of the one or more subtasks, based on successful execution of the one or more subtasks. For example, FIG. 1 shows unrelated device feature subtask execution-based access controlling module 56 controlling access (e.g., determining whether or not to permit, limit, modify, or otherwise control particular users or actions to hardware and software) to at least one feature of the device (e.g., “playing movies from Netflix”) unrelated to the execution of the one or more subtasks (e.g., you don't need to play movies from Netflix in order to take a picture of Times Square in New York) based on successful execution of the one or more subtasks (e.g., once the subtask of “capture the view from your iPad's cameras when you're positioned at Times Square in New York” is completed, a certain amount of access to playing Netflix movies on the device is granted). There may be other factors in determining how much access to grant, e.g., other subtasks that are completed, or the type of plan purchased with the iPad, or the conditions agreed to when the iPad was purchased.

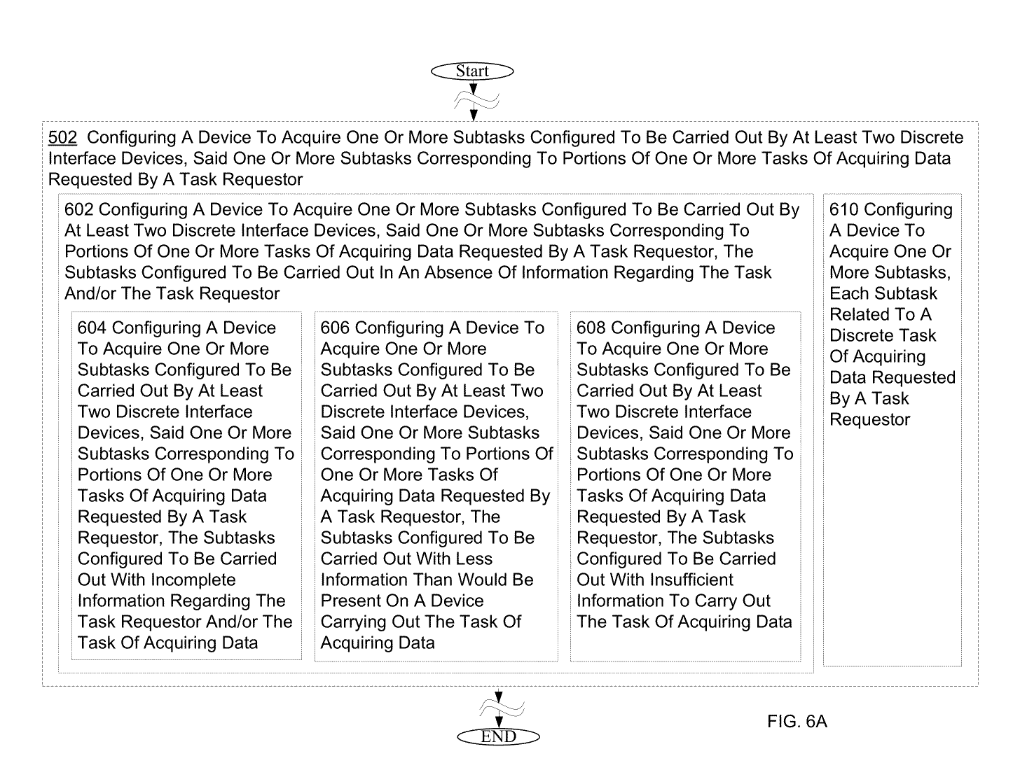

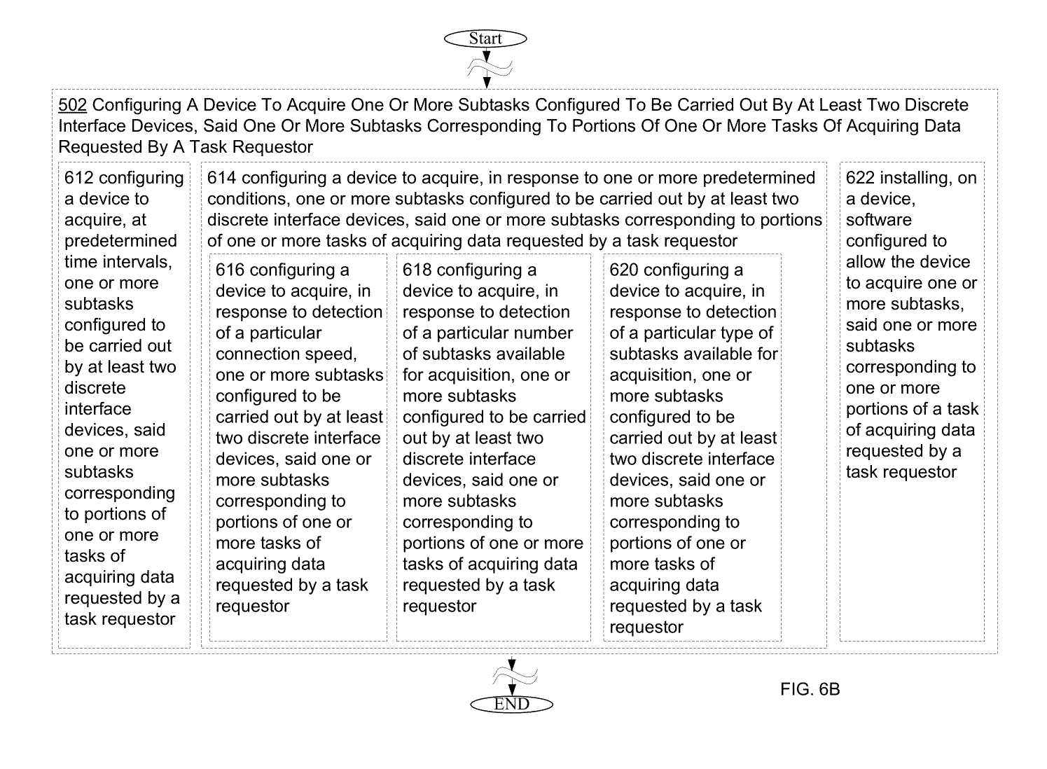

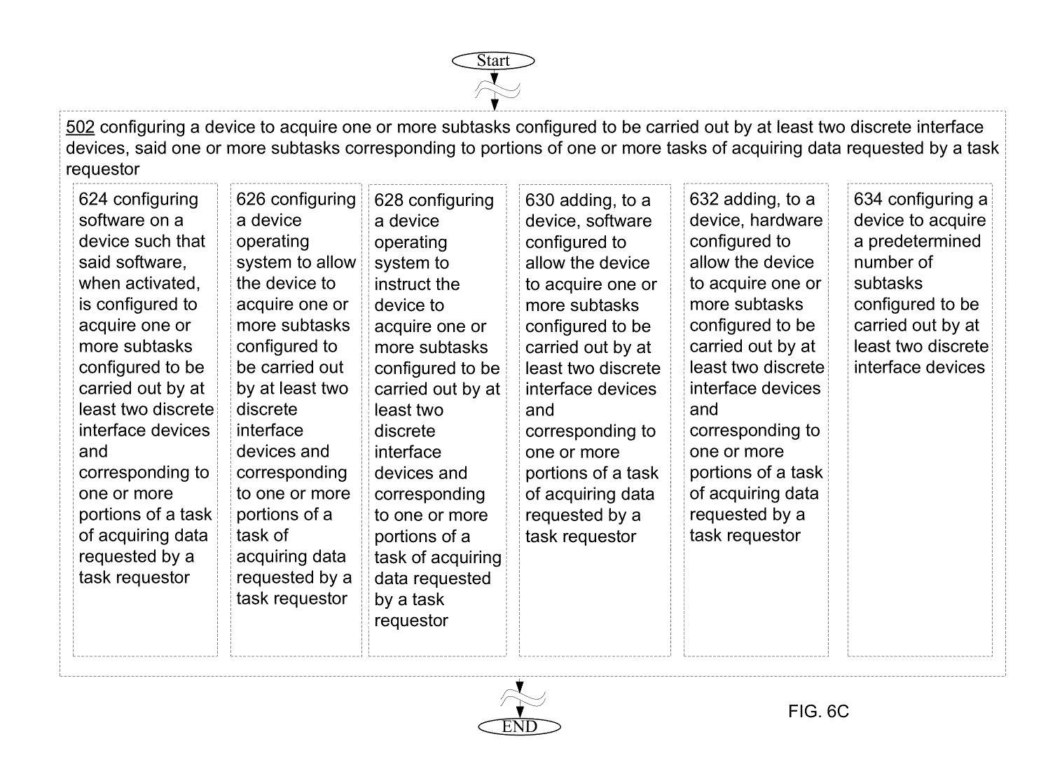

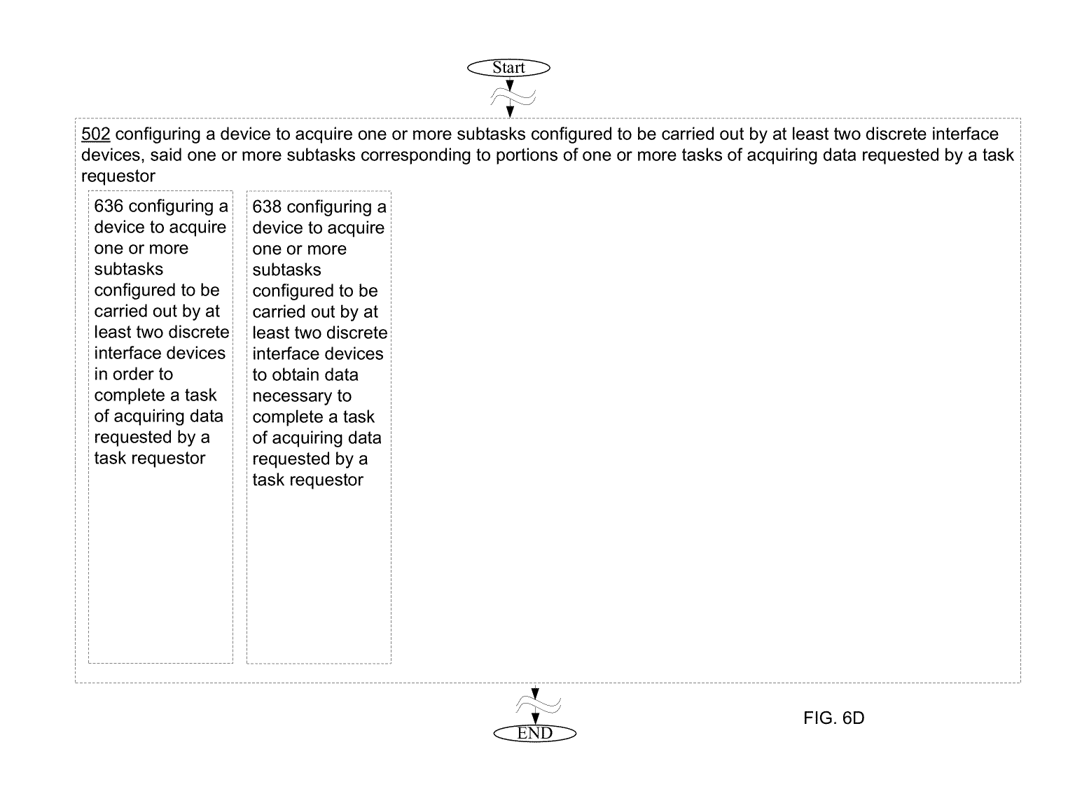

FIGS. 6A-6D depict various implementations of operation 502, according to embodiments. Referring now to FIG. 6A, operation 502 may include operation 602 depicting configuring a device to acquire one or more subtasks configured to be carried out by at least two discrete interface devices, said one or more subtasks corresponding to portions of one or more tasks of acquiring data requested by a task requestor, the subtasks configured to be carried out in an absence of information regarding the task and/or the task requestor. For example, FIG. 2 shows acquiring one or more subtasks configured to be carried out in an absence of information and related to one or more tasks of acquiring data device configuring module 202 configuring a device (e.g., Garmin Nuvi GPS) to acquire one or more subtasks (e.g., “determine how fast you are moving along Interstate 495”) configured to be carried out by at least two discrete interface devices (e.g., the Samsung Galaxy Nexus and the Garmin Nuvi GPS), said one or more subtasks corresponding to portions of one or more tasks (e.g., “determine the amount and speed of traffic on I-495”) of acquiring data (e.g., traffic data) requested by a task requestor (e.g., a commuter sitting at his office desk), the subtasks configured to be carried out in an absence of information regarding the task and/or the task requestor (e.g., the Samsung Galaxy Nexus and the Garmin Nuvi GPS do not know the commuter's identity or any information about him or her).

It is noted that “in an absence of information” does not imply a complete absence of information, but rather that the interface devices carrying out the subtasks have a smaller subset of information than a single device carrying out the task of acquiring data would have. In some instances, a sufficiently advanced interface device could infer the task of acquiring data, or guess the task of acquiring data, but the interface device would still be operating in an “absence of information” as defined in the claims. It is not necessary for the interface device to operate in a complete lack of information regarding the task and/or the task requestor to operate in an absence of information. Some exemplary “absence of information” scenarios will be discussed in more detail herein. These examples are not intended to be exhaustive but rather to illustrate examples of scenarios that present an “absence of information.”

Referring again to FIG. 6A, operation 602 may include operation 604 depicting configuring a device to acquire one or more subtasks configured to be carried out by at least two discrete interface devices, said one or more subtasks corresponding to portions of one or more tasks of acquiring data requested by a task requestor, the subtasks configured to be carried out with incomplete information regarding the task requestor and/or the task of acquiring data. For example, FIG. 2 shows acquiring one or more subtasks configured to be carried out with incomplete information and related to one or more tasks of acquiring data device configuring module 204 configuring a device (e.g., a Samsung Galaxy Tab) to acquire one or more subtasks (e.g., determine where it is currently raining within the city limits of Washington, D.C.) configured to be carried out by at least two discrete interface devices (e.g., Samsung Galaxy Tab and a Nokia Lumia), said one or more subtasks corresponding to portions of one or more tasks of acquiring data (e.g., determine rainfall movement patterns from east to west through Washington D.C. to more accurately predict when Washington Nationals games will rain out) requested by a task requestor (e.g., Major League Baseball), the subtasks configured to be carried out with incomplete information regarding the task requestor and/or the task of acquiring data (e.g., the Samsung Galaxy Tab that is carrying out the subtask would not have complete information about the task to be carried out (e.g., determining rainfall movement patterns), even though the device might have some information about the task of acquiring data (e.g., it can be inferred that the Samsung Galaxy Tab knows that the task of acquiring data is related to rainfall within its area), and in addition, the Samsung Galaxy Tab has no knowledge of the task requestor, e.g., Major League Baseball, or any of the people, hardware, or software that made or received the task of acquiring data).

Referring again to FIG. 6A, operation 602 may include operation 606 depicting configuring a device to acquire one or more subtasks configured to be carried out by at least two discrete interface devices, said one or more subtasks corresponding to portions of one or more tasks of acquiring data requested by a task requestor, the subtasks configured to be carried out with less information than would be present on a device carrying out the task of acquiring data. For example, FIG. 2 shows acquiring one or more subtasks configured to be carried out with less information and related to one or more tasks of acquiring data device configuring module 206 configuring a device (e.g., installing subtask acquisition software on a Kindle Fire smartphone) to acquire (e.g., receive from the carrier Verizon Wireless, which generates the subtasks from tasks received from other members of the network) one or more subtasks (e.g., “determine the amount of ambient light coming in from the window of the restaurant at which you are located”) configured to be carried out by at least two discrete interface devices (e.g., a Kindle Fire tablet and a Samsung Captivate smartphone), said one or more subtasks corresponding to portions of one or more tasks of acquiring data (e.g., “determine which restaurants have sufficient ambient light for reading at the table”) requested by a task requestor (e.g., a person who wants to go out to eat, but is alone, and wants to read comfortably at the table), the subtasks configured to be carried out with less information than would be present on a device carrying out the task of acquiring data (e.g., the Kindle Fire does not know that it is detecting for sufficient ambient light for reading, only that the Kindle Fire is detecting for sufficient ambient light). Moreover, because the Kindle Fire is only performing this action at its present location, and does not know whether to compare restaurants, places that serve coffee, businesses facing east, or the like, the Kindle Fire has less information than a device that is carrying out the entire task (e.g., by moving to different places) would have. It is noted that, in this context, “configuring a device” means installing, configuring, changing, updating, modifying, or otherwise performing some action on hardware or software of a device. The configuring of the device may be done by the manufacturer of the Kindle Fire (e.g., Amazon), or a seller of the device (e.g., Best Buy), or a third party (e.g., a technician at Radio Shack).

Referring again to FIG. 6A, operation 602 may include operation 608 depicting configuring a device to acquire one or more subtasks configured to be carried out by at least two discrete interface devices, said one or more subtasks corresponding to portions of one or more tasks of acquiring data requested by a task requestor, the subtasks configured to be carried out with insufficient information to carry out the task of acquiring data. For example, FIG. 2 shows acquiring one or more subtasks configured to be carried out with insufficient information and related to one or more tasks of acquiring data device configuring module 208 configuring a device (e.g., loading a hardware chip into a Motorola Droid Razr to allow subtask acquisition) to acquire (e.g., receive from a central task repository with minimal processing performed at the device) one or more subtasks (e.g., “take a picture of home plate from your position within Nationals Park”) configured to be carried out by at least two discrete interface devices (e.g., the Motorola Droid Razr and the HTC Droid Incredible), said one or more subtasks corresponding to portions of one or more tasks of acquiring data (e.g., “determine which seats at Nationals Park have views that are blocked by the foul poles or other obstructions”) requested by a task requestor (e.g., a person wanting to scalp tickets for tonight's game), the subtasks configured to be carried out with insufficient information to carry out the task of acquiring data (e.g., the Motorola Droid Razr does not have sufficient information to perform the task of “determine which seats at Nationals Park have views that are blocked by the foul poles or other obstructions” from only the subtask “take a picture of home plate from your position within Nationals Park”).

Referring again to FIG. 6A, operation 502 may include operation 610 depicting configuring a device to acquire one or more subtasks, each subtask related to a discrete task of acquiring data requested by a task requestor. For example, FIG. 2 shows acquiring one or more subtasks related to a discrete task of acquiring data device configuring module 210 configuring a device (e.g., iPhone 5) to acquire (e.g., receive from a subtask creator with substantial processing performed at the device) one or more subtasks (e.g., “rate the taste of a bagel at the nearest bagel shop at your location,” “determine how many people are in line for a cheeseburger at the McDonald's closest to your location,” and “determine the loudness of the construction noise on the corner of 14th St. and P. St NE”), each subtask related to a discrete task of acquiring data requested by a task requestor (e.g., “rate the taste of a bagel at the nearest bagel shop at your location” may correspond to “determine which shop in DuPont Circle has the freshest bagels”, which may be requested from a person living in DuPont Circle who wants to order a bagel; “determine how many people are in line for a cheeseburger at the McDonald's closest to your location,” may be related to “determine which McDonald's stores in Fresno, Calif. are the busiest,” which may be an automated entry requested by a computer programmed to make such requests at particular times; and “determine the loudness of the construction noise on the corner of 14th St. and P. St NE,” may be related to “determine which apartments on P St. have the quietest mornings,” which may be requested by a person working for a realty company).

Referring now to FIG. 6B, operation 502 may include operation 612 depicting configuring a device to acquire, at predetermined time intervals, one or more subtasks configured to be carried out by at least two discrete interface devices, said one or more subtasks corresponding to portions of one or more tasks of acquiring data requested by a task requestor. For example, FIG. 2 shows acquiring one or more subtasks related to one or more tasks of acquiring data at predetermined time intervals device configuring module 212 configuring a device (e.g., a Samsung Focus S) to acquire (e.g., receive from a subtask aggregator that also decides which devices receives particular subtasks), at predetermined time intervals (e.g., once a day), one or more subtasks (e.g., “take a picture of the Eiffel Tower”) configured to be carried out by at least two discrete interface devices (e.g., the Samsung Focus S and a Nokia E7), said one or more subtasks corresponding to portions of one or more tasks of acquiring data (e.g., “obtain a real-time 360 degree picture of the Eiffel Tower”) requested by a task requestor (e.g., a person living in Dubai and building a model of the Eiffel Tower).

Referring again to FIG. 6B, operation 502 may include operation 614 depicting configuring a device to acquire, in response to one or more predetermined conditions, one or more subtasks configured to be carried out by at least two discrete interface devices, said one or more subtasks corresponding to portions of one or more tasks of acquiring data requested by a task requestor. For example, FIG. 2 shows acquiring one or more subtasks related to one or more tasks of acquiring data in response to predetermined conditions device configuring module 214 configuring a device (e.g., a Nokia E5) to acquire (e.g., receive from a communication network provider that has a database of subtasks to be carried out that it generated from requesting tasks from other users of the communication network), in response to one or more predetermined conditions, one or more subtasks (e.g., “determine the number of people in the coffee shop at your current location”) configured to be carried out by at least two discrete interface devices (e.g., the Nokia E5 and the Dell Venue Pro), said one or more subtasks corresponding to portions of one or more tasks of acquiring data (e.g., “determine which coffee shops in Old Town Alexandria are the most crowded at 3 pm”) requested by a task requestor (e.g., a person in Old Town Alexandria who wants a cup of coffee and is using a device connected to the communication network provided by the provider).

It is noted that, in this case, the subtask “determine the number of people in the coffee shop at your current location” could be completed in a number of ways. For example, the person operating the Nokia E5 could merely input the number of people in the coffee shop. In another example, the person operating another device to carry out the subtask could use the video capturing feature and capture a video of the entire shop, which, in some embodiments, could be processed on the device, or, in other embodiments transmitted via the communication network for further analysis. In another example, the person operating the device to carry out the subtask could take a number of pictures of the coffee shop, which, in some embodiments, could be processed to estimate how many people are in the coffee shop, either locally at the device, or remotely after transmission of the information.

Referring again to FIG. 6B, operation 614 may include operation 616 depicting configuring a device to acquire, in response to detection of a particular connection speed, one or more subtasks configured to be carried out by at least two discrete interface devices, said one or more subtasks corresponding to portions of one or more tasks of acquiring data requested by a task requestor. For example, FIG. 2 shows acquiring one or more subtasks related to one or more tasks of acquiring data in response to detected particular connection speed device configuring module 216 configuring a device (e.g., Motorola Brute i686) to acquire (e.g., retrieve subtasks from a database in a known location), in response to detection of a particular communication speed (e.g., data connection speed over the communication network greater than 1 MB/s), one or more subtasks (e.g., “make a recording of the music played at Hye Bar at 2 pm”) configured to be carried out by at least two discrete interface devices (e.g., the Motorola Brute i686 and a Sony PVR recorder), said one or more subtasks corresponding to portions of one or more tasks of acquiring data (e.g., “determine how many times per hour Pearl Jam is played at Hye Bar”) requested by a task requestor (e.g., a fan of Pearl Jam debating whether to plan an event at the Hye Bar).

Referring again to FIG. 6B, operation 614 may include operation 618 depicting configuring a device to acquire, in response to detection of a particular number of subtasks available for acquisition, one or more subtasks configured to be carried out by at least two discrete interface devices, said one or more subtasks corresponding to portions of one or more tasks of acquiring data requested by a task requestor. For example, FIG. 2 shows acquiring one or more subtasks related to one or more tasks of acquiring data in response to detected particular number of available subtasks device configuring module 218 configuring a device (e.g., Apple iPhone 5) to acquire (e.g., retrieve subtasks from a data repository in a location specified at the time by a remote computer), in response to detection (e.g., receiving a signal, e.g., whether requested or not) of a particular number (e.g., 10) of subtasks available for acquisition (e.g., the device detects a particular number (e.g., 10) of subtasks are available at a data repository at the location), one or more subtasks (e.g., “measure the number of wireless networks available at the nearest sandwich shop”) configured to be carried out by at least two discrete interface devices (e.g., Apple iPhone 5 and Acer Iconia), said one or more subtasks corresponding to portions of one or more tasks of acquiring data (e.g., “determine which sandwich shops have the largest number of available wireless networks”) requested by a task requestor (e.g., a businessperson interested in having a lunch meeting where Internet connection may be required).

Referring again to FIG. 6B, operation 614 may include operation 620 depicting configuring a device to acquire, in response to detection of a particular type of subtasks available for acquisition, one or more subtasks configured to be carried out by at least two discrete interface devices, said one or more subtasks corresponding to portions of one or more tasks of acquiring data requested by a task requestor. For example, FIG. 2 shows acquiring one or more subtasks related to one or more tasks of acquiring data in response to detected particular type of available subtasks device configuring module 220 configuring a device (e.g., Palm Pre Plus) to acquire (e.g., retrieve subtasks from a data repository that the device may physically connect to via a cord), in response to detection of a particular type of subtasks available for acquisition (e.g., subtasks requiring a microphone), one or more subtasks (e.g., “record the peak loudness at the Pearl Jam concert at your location”) configured to be carried out by at least two discrete interface devices (e.g., Palm Pre Plus and the Zoom H4n Digital Recorder), said one or more subtasks corresponding to portions of one or more tasks of acquiring data (e.g., “determine how loud the Pearl Jam concert is so I can see if my kids can go to the next one”) requested by a task requestor (e.g., a person trying to determine whether her children can attend a Pearl Jam concert).

Referring again to FIG. 6B, operation 502 may include operation 622 depicting installing, on a device, software configured to allow the device to acquire one or more subtasks, said one or more subtasks corresponding to one or more portions of a task of acquiring data requested by a task requestor. For example, FIG. 2 shows acquiring one or more subtasks corresponding to portions of one or more tasks of acquiring data device software installing module 222 installing (e.g., to set up hardware or software for use or service, e.g., to copy software (e.g., application software, into memory, or modify existing software in memory)), on a device (e.g., Samsung Epic Touch), software configured to allow the device to acquire one or more subtasks (e.g., software that is configured to receive or retrieve one or more subtasks from a subtask repository, e.g., a subtask of “take a picture of the Sphinx in Egypt”) corresponding to one or more portions of a task of acquiring data (e.g., “obtain a 360 degree model of the Sphinx for use in a game program”) requested by a task requestor (e.g., a game development company).

Referring now to FIG. 6C, operation 502 may include operation 624 depicting configuring software on a device such that said software, when activated, is configured to acquire one or more subtasks configured to be carried out by at least two discrete interface devices and corresponding to one or more portions of a task of acquiring data requested by a task requestor. For example, FIG. 2 shows acquiring one or more subtasks corresponding to portions of one or more tasks of acquiring data device activated software configuring module 224 configuring software (e.g., changing settings on an application, e.g., loading locations into an application where subtasks may be received) such that said software (e.g., subtask retrieving software), when activated (e.g., when the device is powered on, or when the user chooses to execute the subtask retrieving software), is configured to acquire one or more subtasks (e.g., “measure the 3G signal strength at your current location”) configured to be carried out by at least two discrete interface devices (e.g., Motorola Droid X and Apple iPhone 4S) and corresponding to one or more portions of a task of acquiring data (e.g., “accurately measure real 3G signal strength over a particular area and across different devices”) requested by a task requestor (e.g., AT&T).

Referring again to FIG. 6C, operation 502 may include operation 626 depicting configuring a device operating system to allow the device to acquire one or more subtasks configured to be carried out by at least two discrete interface devices and corresponding to one or more portions of a task of acquiring data requested by a task requestor. For example, FIG. 2 shows one or more subtask acquisition allowance device operating system configuring module 226 configuring (e.g., adding, changing, or modifying settings of) a device (e.g., an ASUS EeePc or a HTC Droid Incredible) operating system (e.g., Windows or Google Android) to allow the device (e.g., the ASUS EeePc) to acquire (e.g., send a request for subtasks, and receive a location where subtasks can be retrieved, and retrieving one or more of the subtasks from the location) one or more subtasks (e.g., “determine how many WPA encrypted wireless networks are visible from your current location”) configured to be carried out by at least two discrete interface devices (e.g., the ASUS EeePC or the HTC Droid Incredible) and corresponding to one or more portions of a task of acquiring data (e.g., “create a map of all the WPA encrypted wireless networks in Seattle”) requested by a task requestor (e.g., the Association for Computing Machinery (“ACM”)).

Referring again to FIG. 6C, operation 502 may include operation 628 depicting configuring a device operating system to instruct the device to acquire one or more subtasks configured to be carried out by at least two discrete interface devices and corresponding to one or more portions of a task of acquiring data requested by a task requestor. For example, FIG. 2 shows instructing a device operating system to allow acquisition of one or more subtasks module 228 configuring (e.g., adding, changing, or modifying settings of) a device (e.g. Apple iPad) operating system (e.g., iOS) to instruct the device (e.g., cause the device) to acquire one or more subtasks (e.g., “measure the level of ambient noise when the device is moving greater than 50 miles per hour”) configured to be carried out by at least two discrete interface devices (e.g., an Apple iPad and an Apple iPhone) and corresponding to one or more portions of a task of acquiring data (e.g., “measure average road noise over 50 miles per hour”) requested by a task requestor (e.g., Consumer Reports).

Referring again to FIG. 6C, operation 502 may include operation 630 depicting adding, to a device, software configured to allow the device to acquire one or more subtasks configured to be carried out by at least two discrete interface devices and corresponding to one or more portions of a task of acquiring data requested by a task requestor. For example, FIG. 2 shows adding software to a device that is configured to allow acquisition of one or more subtasks module 230 adding (e.g., copying from one location to another), to a device (e.g., LG Optimus 7), software configured to allow the device (e.g., a subtask receiving software component) to acquire one or more subtasks (e.g., “measure the level of ambient noise when the device is moving fast enough to be in a car and is on Pennsylvania Avenue”) configured to be carried out by at least two discrete interface devices (e.g., LG Optimus 7 and the Pantech Pocket) and corresponding to one or more portions of a task of acquiring data (e.g., “measure the average road noise on Pennsylvania Avenue”) requested by a task requestor (e.g., Washington D.C. Public Works Department).

Referring again to FIG. 6C, operation 502 may include operation 632 depicting adding, to a device, hardware configured to allow the device to acquire one or more subtasks configured to be carried out by at least two discrete interface devices and corresponding to one or more portions of a task of acquiring data requested by a task requestor. For example, FIG. 2 shows adding hardware to a device that is configured to allow acquisition of one or more subtasks module 232 adding (e.g., activating, configuring hardware to act in a certain way, or physically installing), to a device (e.g., T-Mobile MyTouch 4G), hardware configured to allow the device to acquire one or more subtasks (e.g., “measure the temperature at a particular time”) configured to be carried out by at least two discrete interface devices (e.g., T-Mobile MyTouch 4G and Dell Inspiron outfitted with thermometers) and corresponding to one or more portions of a task of acquiring data (e.g., “determine temperature trends at 2 pm on Thursday”) requested by a task requestor (e.g., a weather hobbyist). It is noted that here, adding hardware may include hardware that allows the device to acquire subtasks, e.g., communication hardware, and logic modules encapsulated as hardware. In some embodiments, the hardware also include additional sensors that are needed to perform some subtasks, e.g., a thermometer, as in the previous examples. Other examples similar to this example are not listed but also are included in these definitions.

Referring again to FIG. 6C, operation 502 may include operation 634 depicting configuring a device to acquire a predetermined number of subtasks configured to be carried out by at least two discrete interface devices. For example, FIG. 2 shows acquiring a predetermined number of subtasks related to one or more tasks of acquiring data device configuring module 234 configuring (e.g., changing at least one setting, either in hardware or software) a device (e.g., an HP G7 laptop) to acquire a predetermined number (e.g., 5) of subtasks (e.g., “determine the ambient light at your location when the laptop is outside”) configured to be carried out by at least two discrete interface devices (e.g., the HP G7 laptop and the ASUS Transformer).

Referring now to FIG. 6D, operation 502 may include operation 636 depicting configuring a device to acquire one or more subtasks configured to be carried out by at least two discrete interface devices in order to complete a task of acquiring data requested by a task requestor. For example, FIG. 2 shows acquiring one or more subtasks configured to be carried out by at least two discrete interface devices in order to complete a task of acquiring data device configuring module 236 configuring (e.g., adding or changing at least one setting, either in hardware or software) a device (e.g., a BlackBerry Bold) to acquire one or more subtasks (e.g., “determine the ambient moonlight at 10 pm at your location”) configured to be carried out by at least two discrete interface devices (e.g., the BlackBerry Bold and the Nokia Lumia) in order to complete a task of acquiring data (e.g., “determine how much moonlight pierces a cloud cover at 10 pm at various locations”) requested by a task requestor (e.g., a moon-watching group of people).

Referring again to FIG. 6D, operation 502 may include operation 638 depicting configuring a device to acquire one or more subtasks configured to be carried out by at least two discrete interface devices to obtain data necessary to complete a task of acquiring data requested by a task requestor. For example, FIG. 2 shows acquiring one or more subtasks configured to be carried out by at least two discrete interface devices to obtain data necessary to complete a task of acquiring data device configuring module 238 configuring a device (e.g., an Apple iPhone 4) to acquire one or more subtasks (e.g., “count the obviously visible stars in the sky at the moment from your location”) configured to be carried out by at least two discrete interface devices (e.g., the Apple iPhone 4 and the Nokia Lumia) to obtain data necessary (e.g., the task cannot be completed without the data for completing the subtask) to complete a task of acquiring data (e.g., “determine which spots in Seattle are the best for stargazing”) requested by a task requestor (e.g., an astronomy Facebook group).

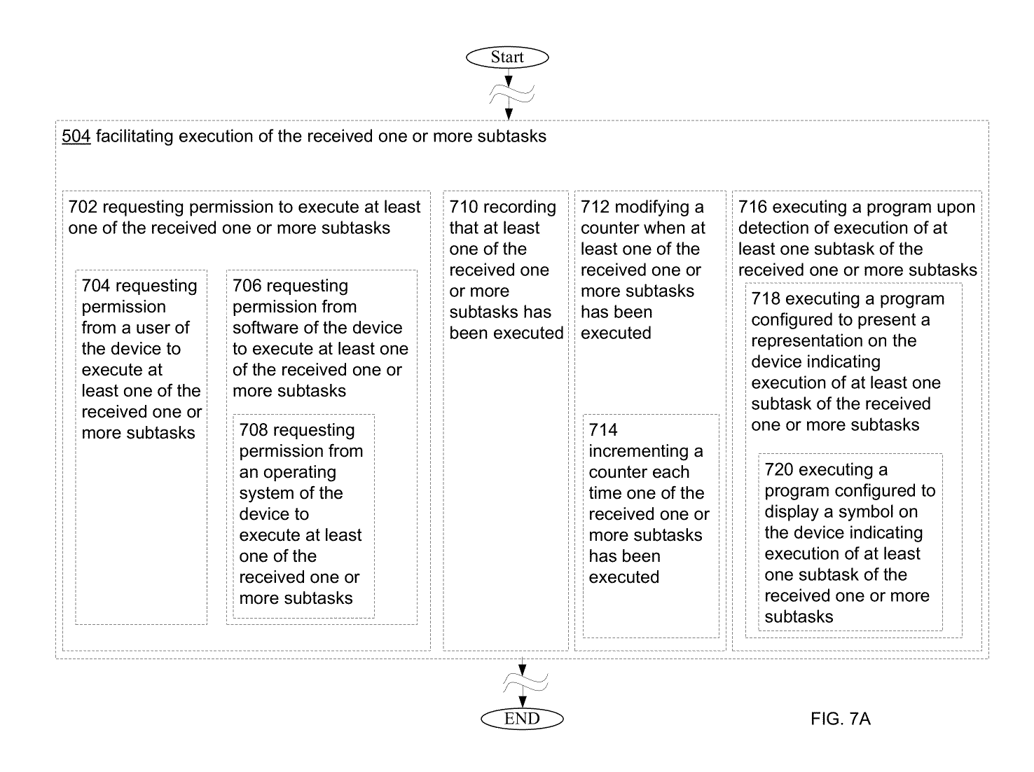

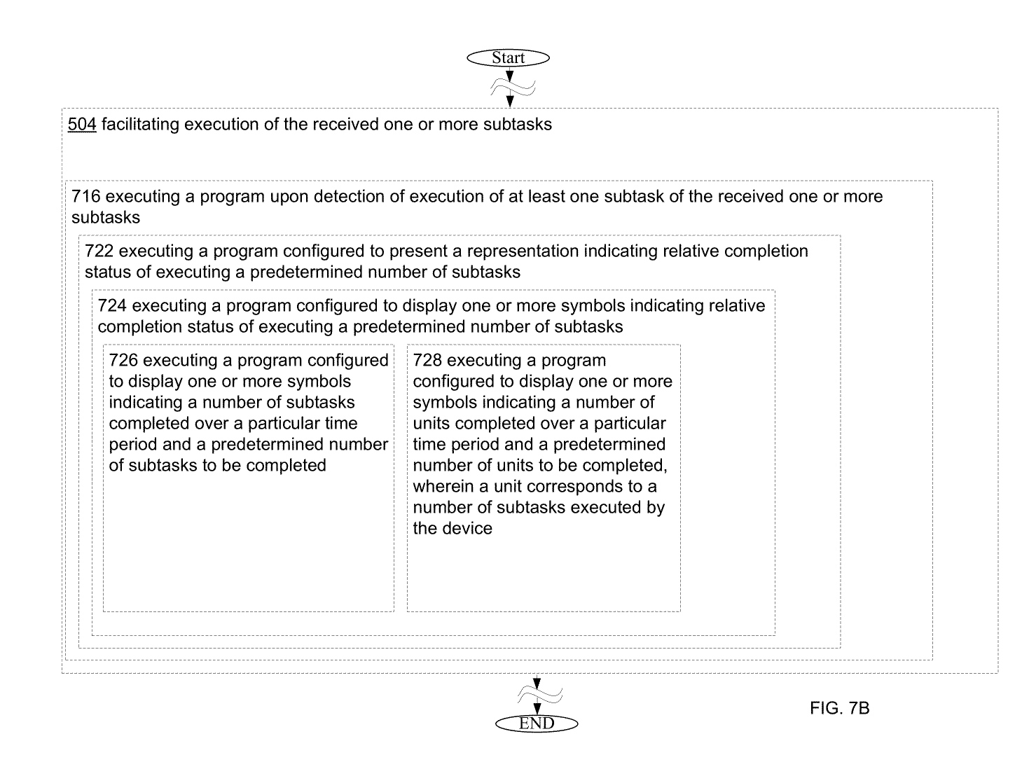

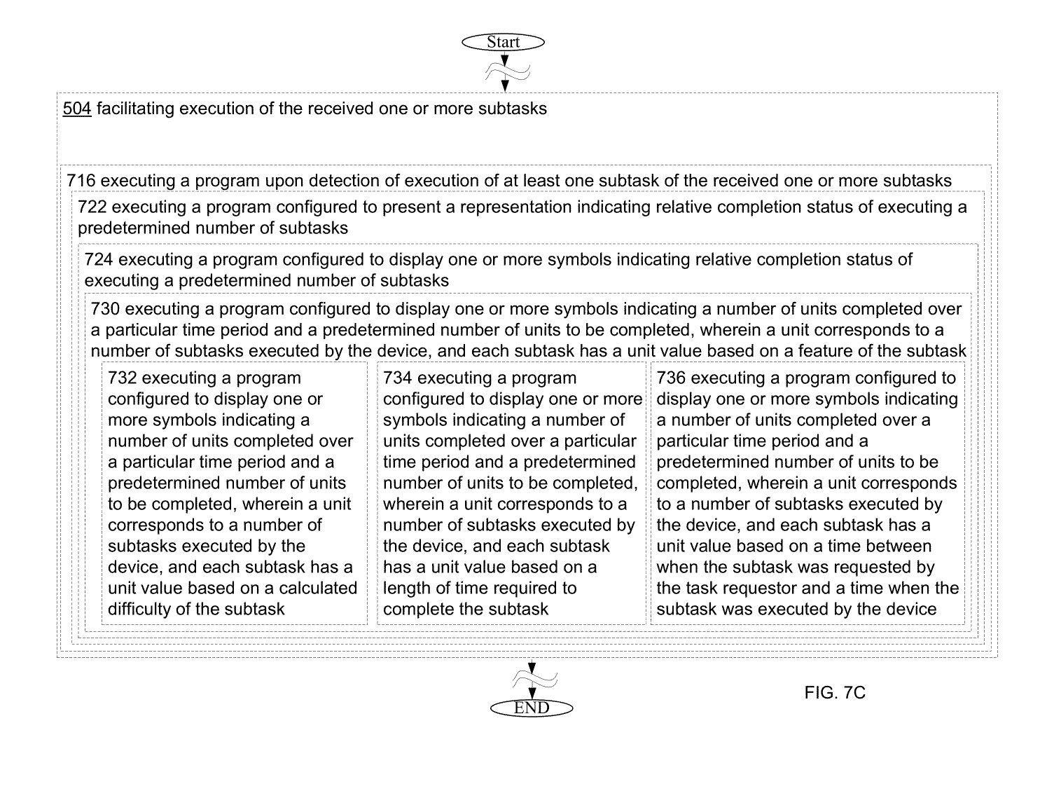

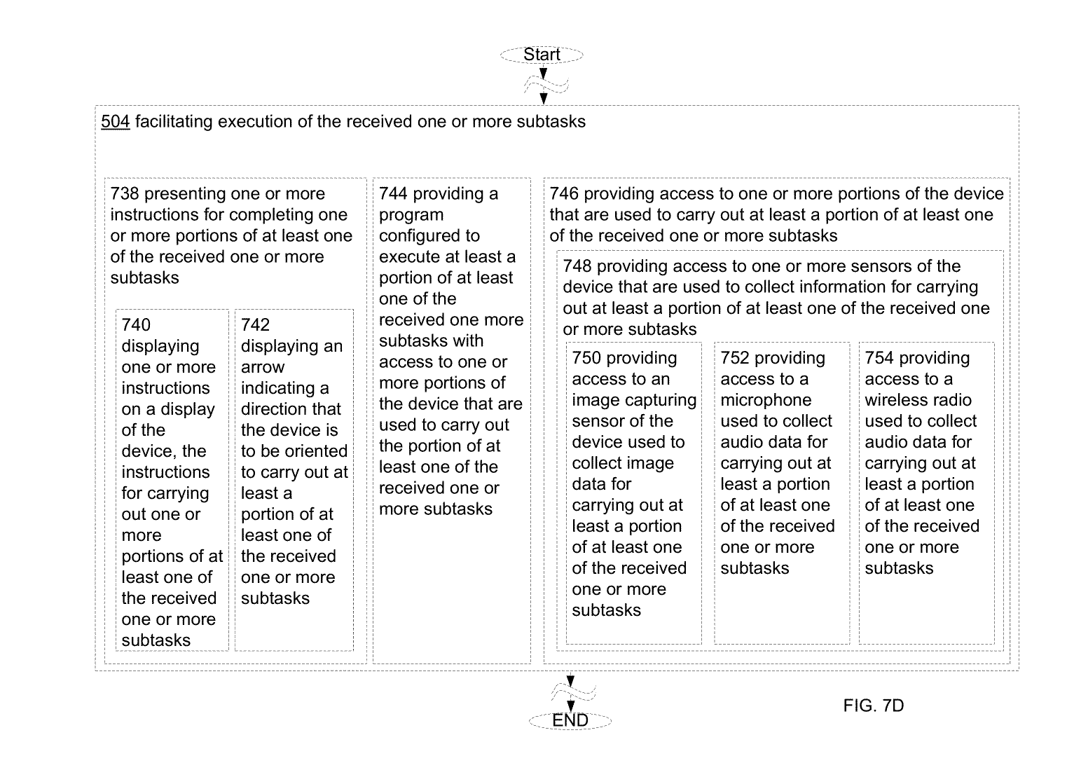

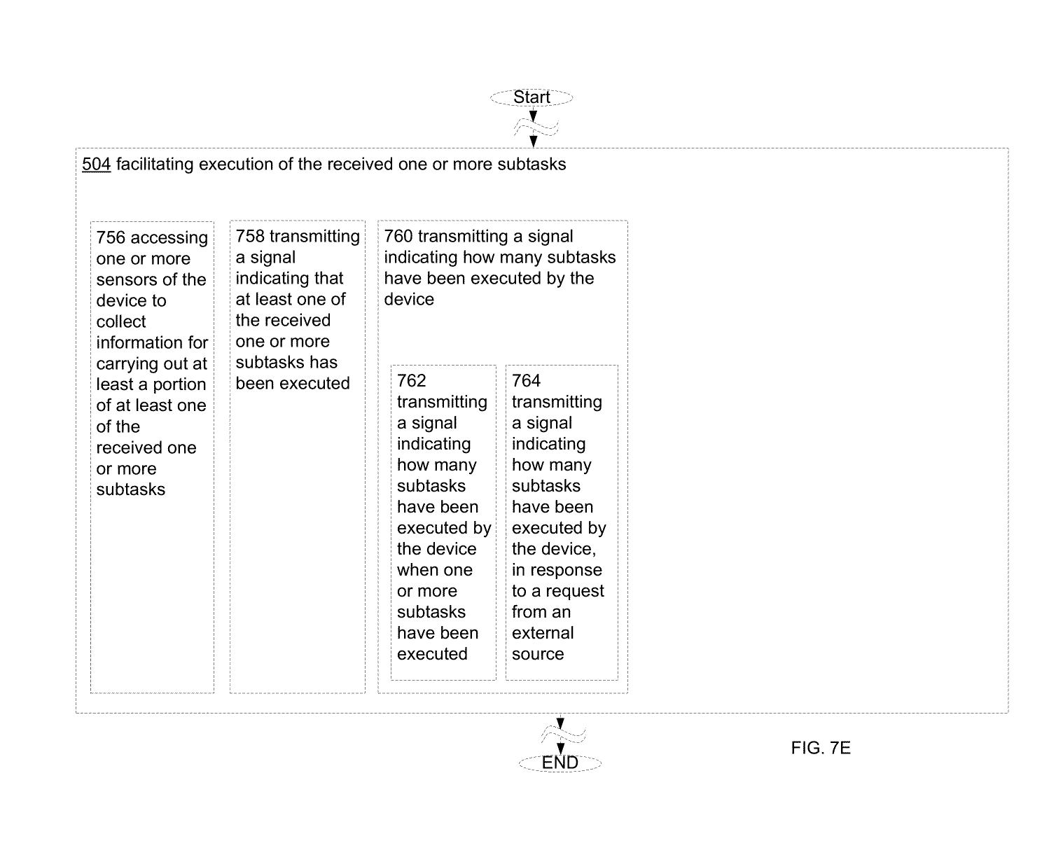

FIGS. 7A-7E depict various implementations of operation 504, according to embodiments. Referring now to FIG. 7A, operation 504 may include operation 702 depicting requesting permission to execute at least one of the received one or more subtasks. For example, FIG. 3 shows permission to execute at least one received subtask requesting module 302 requesting permission (e.g., permission from a user or permission from a program on the device, e.g., a device operating system) to execute (e.g., carry out or take steps to carry out, e.g., activating an image capturing sensor) at least one of the received one or more subtasks (e.g., “take a picture of the Space Needle”).

Referring again to FIG. 7A, operation 504 may include operation 704 depicting requesting permission from a user of the device to execute at least one of the received one or more subtasks. For example, FIG. 3 shows permission to execute at least one received subtask requesting from user of the device module 304 requesting permission (e.g., permission from the user of the device) from a user of the device to execute (e.g., carry out or take steps to carry out, e.g., activating memory to store the number of wireless networks detected, or activating the wireless radio to collect the needed information) at least one of the received one or more subtasks (e.g., “count the number of unencrypted wireless networks at each location you visit today”).

Referring again to FIG. 7A, operation 504 may include operation 706 depicting requesting permission from software of the device to execute at least one of the received one or more subtasks. For example, FIG. 3 shows permission to execute at least one received subtask requesting from device software module 306 requesting permission from software of the device (e.g., the device operating system, a different program running on the device, a memory management system, a resource management system, a device driver, and the like) to execute (e.g., carry out, or take steps to carry out) at least one of the received one or more subtasks (e.g., “rate the comfort of the airplane seat that you're sitting in when you board the plane based on your seatmates”).

Referring again to FIG. 7A, operation 504 may include operation 708 depicting requesting permission from an operating system of the device to execute at least one of the received one or more subtasks. For example, FIG. 3 shows permission to execute at least one received subtask requesting from device operating system module 308 requesting permission (e.g., sending a signal requesting access to particular resources, software, or other aspects of the device) from an operating system (e.g., Android 4.0) of the device (e.g., Motorola Droid Razr) to execute (e.g., take steps to carry out, e.g., activate a particular piece of software or hardware, e.g., activate an image capturing sensor at the proper time) at least one of the received one or more subtasks (e.g., “take a picture of the view from the Il Tratorria restaurant”).

Referring again to FIG. 7A, operation 504 may include operation 710 depicting recording that at least one of the received one or more subtasks has been executed. For example, FIG. 3 shows execution of one or more received subtasks recording module 310 recording (e.g., making a record, e.g., storing in memory an indication that a subtask has been executed) that at least one of the received one or more subtasks (e.g., “take a picture of the parking lot at Tristam Stadium”) has been executed (e.g., the data that is the result of executing the subtask has been obtained). In some embodiments, only a portion of the data may be obtained to consider that the subtask has been executed. In some embodiments, the data may require further processing, but the subtask may still be considered to have been executed.

Referring again to FIG. 7A, operation 504 may include operation 712 depicting modifying a counter when at least one of the received one or more subtasks has been executed. For example, FIG. 3 shows counter modifying in response to execution of one or more subtasks module 312 modifying (e.g., changing a value of) a counter (e.g., a numerical or other representation that can indicate quantity) when at least one of the received one or more subtasks (e.g., “determine the barometric pressure at 5 pm at your location”) has been executed.

Referring again to FIG. 7A, operation 712 may include operation 714 depicting incrementing a counter each time one of the received one or more subtasks has been executed. For example, FIG. 3 shows counter incrementing in response to execution of one or more subtasks module 314 incrementing a counter (e.g., increasing the value of a numerical or other representation that indicates quantity) each time one of the received one or more subtasks has been executed (e.g., when a subtask of “determine how many people are in line in front of you at Wendy's” is completed, adding one to a “total subtasks executed” counter stored on the device). It is noted that the counter does not need to be stored on the device, the counter may be stored remotely, and the counter may be incremented by sending a signal to a remote location, which may perform some processing, and increment the counter at a remote location.

Referring again to FIG. 7A, operation 504 may include operation 716 depicting executing a program upon detection of execution of at least one subtask of the received one or more subtasks. For example, FIG. 3 shows program execution upon detection of execution of at least one subtask module 316 executing a program (e.g., a program that tracks the number of subtask completed) upon detection of execution (e.g., upon determining that a subtask is being executed or has been executed) of at least one subtask (e.g., “determine the view of home plate from your position within Nationals Park”).

Referring again to FIG. 7A, operation 716 may include operation 718 depicting executing a program configured to present a representation on the device indicating execution of at least one subtask of the received one or more subtasks. For example, FIG. 3 shows upon detection of execution of at least one subtask, program configured to present a representation executing module 318 executing a program (e.g., a piece of software on the device that causes a particular symbol to be displayed on the device) configured to present a representation (e.g., to display a subtask icon) on the device (e.g., on the screen of an HTC Sensation 4G phone) indicating execution of at least one subtask (e.g., indicating that the subtask is executing or has executed) of the received one or more subtasks (e.g., “determine where it is currently raining near your location”).

Referring again to FIG. 7A, operation 718 may include operation 720 depicting executing a program configured to display a symbol on the device indicating execution of at least one subtask of the received one or more subtasks. For example, FIG. 3 shows upon detection of execution of at least one subtask, program configured to display a symbol executing module 320 executing a program (e.g., software loaded on the device, or part of a larger program loaded on the device) configured to display a symbol (e.g., to display text reading “SUBTASK EXECUTED”) on the device (e.g., the Palm Pre Plus) indicating execution of at least one subtask (e.g., indicating that the subtask of “count the number of Beanie Babies in stock at the Toys-R-Us nearest to your location” has been completed (e.g., the number was entered, or the picture was taken from which the number can be inferred).

Referring now to FIG. 7B, operation 716 also may include operation 722 depicting executing a program configured to present a representation indicating relative completion status of executing a predetermined number of subtasks. For example, FIG. 3 shows program execution to present representation indicating relative completion status, upon detection of execution of at least one subtask module 322 executing a program (e.g., a subtask monitoring program) configured to present a representation (e.g., to display a pie chart) indicating relative completion status of executing a predetermined number of subtasks (e.g., showing a pie chart with 25% one color and 75% another color, indicating that of the predetermined number (e.g., four (4)) of subtasks, one (1) has been completed).

Referring again to FIG. 7B, operation 722 may include operation 724 depicting executing a program configured to display one or more symbols indicating relative completion status of executing a predetermined number of subtasks. For example, FIG. 3 shows program execution to display one or more symbols indicating relative completion status of a predetermined number of subtasks, upon detection of execution of at least one subtask module 324 executing a program configured to display one or more symbols (e.g., a status bar at the top of the screen) indicating relative completion status of executing a predetermined number of subtasks (e.g., each time a subtask is completed, the status bar fills in more, until the predetermined number of subtasks has been completed, at which time the status bar is full).

Referring again to FIG. 7B, operation 724 may include operation 726 depicting executing a program configured to display one or more symbols indicating a number of subtasks completed over a particular time period and a predetermined number of subtasks to be completed. For example, FIG. 3 shows program execution to display one or more symbols indicating a number of subtasks completed over a particular time period, upon detection of execution of at least one subtask module 326 executing a program configured to display one or more symbols (e.g., a bar chart) indicating a number of subtasks completed over a particular time period (e.g., the X-axis of the bar chart indicates the day, and the Y-axis of the chart indicates the number of subtasks completed on that day and a predetermined number of subtasks to be completed (e.g., the chart also shows the total number of subtasks to be completed)).

Referring again to FIG. 7B, operation 724 may include operation 728 depicting executing a program configured to display one or more symbols indicating a number of units achieved over a particular time period and a predetermined number of units to be achieved, wherein a unit corresponds to a number of subtasks executed by the device. For example, FIG. 3 shows program execution to display one or more symbols indicating a number of units achieved over a particular time period, upon detection of execution of at least one subtask module 328 executing a program configured to display one or more symbols (e.g., seven icons of a baseball) indicating a number of units (e.g., seven units have been achieved) achieved over a particular time period (e.g., one month) and a predetermined number of units to be achieved (e.g., showing three icons of a hollow baseball for ten total icons, indicating 70% of the predetermined units have been achieved), wherein a unit corresponds to a number of subtasks (e.g., five subtasks) executed by the device (e.g., the Dell XPS 15).

Referring now to FIG. 7C, operation 724 may further include operation 730 depicting executing a program configured to display one or more symbols indicating a number of units completed over a particular time period and a predetermined number of units to be completed, wherein a unit corresponds to a number of subtasks executed by the device, and each subtask has a unit value based on a feature of the subtask. For example, FIG. 3 shows program execution to display one or more symbols indicating a number of units achieved over a particular time period upon detection of execution of at least one subtask that has a feature-based unit value module 330 executing a program (e.g., displaying a menu, displaying a screen) configured to display one or more symbols (e.g., portions of a complete picture) indicating a number of units completed over a particular time period (e.g., each time a unit is completed, more of the picture is uncovered), wherein a unit corresponds to a number of subtasks (e.g., the number varies based on the properties of the subtask) executed by the device (e.g., an Asus NX90 laptop), and each subtask has a unit value (e.g., “0.2 units”) based on a feature of the subtask (e.g., a less difficult or time-consuming subtask may be 0.2 units, and a more difficult subtask may be 1.0 units).

Referring again to FIG. 7C, operation 730 may include operation 732 depicting executing a program configured to display one or more symbols indicating a number of units completed over a particular time period and a predetermined number of units to be completed, wherein a unit corresponds to a number of subtasks executed by the device, and each subtask has a unit value based on a calculated difficulty of the subtask. For example, FIG. 3 shows upon subtask detection, displaying one or more symbols indicating a number of units based on subtask difficulty achieved over predetermined time period module 332 executing a program configured to display one or more symbols (e.g., text symbols, e.g., the number “7”) indicating a number of units (e.g., seven units) completed over a particular time period (e.g., one hour) and a predetermined number of units to be completed (e.g., displaying the number “100” for one hundred units to be completed), wherein a unit corresponds to a number of subtasks executed by the device (e.g., the digital camera with WiFi), and each subtask has a unit value (e.g. seven (7)) based on a calculated difficulty of the subtask (e.g., a computer or human operator determines how many resources are used to complete the subtask, where a resource can be time, processor power, sensors used, or other measurable quantity).

Referring again to FIG. 7C, operation 730 may include operation 734 depicting executing a program configured to display one or more symbols indicating a number of units completed over a particular time period and a predetermined number of units to be completed, wherein a unit corresponds to a number of subtasks executed by the device, and each subtask has a unit value based on a length of time required to complete the subtask. For example, FIG. 3 shows upon subtask detection, displaying one or more symbols indicating a number of units based on subtask completion time achieved over predetermined time period module 334 executing a program configured to display one or more symbols (e.g., a rabbit symbol with a particular position on the screen, e.g., at the far left of the screen at the beginning, and at the far right of the screen when the number of units reaches the predetermined number of units to be completed) indicating a number of units (e.g., four (4) units) completed over a particular time period (e.g., two days) and a predetermined number of units to be completed (e.g., two hundred (200) units), wherein a unit corresponds to a number of subtasks executed by the device (e.g., the laptop computer), and each subtask has a unit value based on a length of time required to complete the subtask (e.g., a subtask that requires the use of a sensor for five seconds may be worth one unit, and a subtask that requires the use of a sensor for fifteen seconds may be worth three units).

It is noted that “a length of time required to complete the subtask” may include an amount of time that resources are used, or an amount of time that the subtask actually takes to complete. For example, if a user of a device must move to a position or orient the device in a particular manner, in some embodiments, that time may be included in “a length of time required to complete the subtask.” In other embodiments, the length of time may refer only to the length of time that a particular resource is in use, or a length of time that a particular resource is in exclusive use for the purpose of carrying out the subtask.

Referring again to FIG. 7C, operation 730 may include operation 736 depicting executing a program configured to display one or more symbols indicating a number of units completed over a particular time period and a predetermined number of units to be completed, wherein a unit corresponds to a number of subtasks executed by the device, and each subtask has a unit value based on a time between when the subtask was requested by the task requestor and a time when the subtask was executed by the device. For example, FIG. 3 shows upon subtask detection, displaying one or more symbols indicating a number of units based on elapsed time achieved over predetermined time period module 336 executing a program (e.g., the hardware upon which the instructions are programmed or hard-wired) configured to display one or more symbols (e.g. a status indicator) indicating a number of units completed over a particular time period (e.g., 600 over six months), wherein a unit corresponds to a number of subtasks (e.g., the value depends on the time as described herein) executed by the device (e.g., the mobile device), and each subtask has a unit value based on a time between when the subtask was requested by the task requestor and a time when the subtask was executed by the device (e.g., the longer the time between the request of the task that led to the subtask generation, and the execution of the generated subtask, the more units the subtask is worth, e.g., subtasks that have been available to be completed for a long time are worth more, e.g., there is a priority on older subtasks so that tasks may be completed in a timely manner).

Referring now to FIG. 7D, operation 504 may include operation 738 depicting presenting one or more instructions for completing one or more portions of at least one of the received one or more subtasks. For example, FIG. 3 shows one or more instructions for completing one or more portions of one or more subtasks presenting module 338 presenting one or more instructions (e.g., using the speaker to play audible instructions, e.g., “walk to the nearest McDonald's” and “hold the image capturing sensor up to the counter”) for completing one or more portions (e.g., the “walk to the nearest McDonald's” is a portion of the subtask “take a picture of the line at the McDonald's closest to your location”) of at least one of the received one or more subtasks (e.g., “take a picture of the line at the McDonald's closest to your location”).

Referring again to FIG. 7D, operation 738 may include operation 740 depicting displaying one or more instructions on a display of the device, the instructions for carrying out one or more portions of at least one of the received one or more subtasks. For example, FIG. 3 shows one or more instructions for carrying out one or more portions of one or more subtasks displaying module 340 displaying one or more instructions (e.g., “activate the microphone when the display flashes red”) on a display of the device (e.g., on a screen of the Motorola Droid X), the instructions for carrying out one or more portions of at least one of the received one or more subtasks (e.g., “record the peak noise level at the Pearl Jam concert”).

Referring again to FIG. 7D, operation 738 may include operation 742 depicting displaying an arrow indicating a direction that the device is to be oriented to carry out at least a portion of at least one of the received one or more subtasks. For example, FIG. 3 shows arrow indicating device orientation direction to carry out at least a portion of at least one subtask displaying module 342 displaying an arrow indicating a direction that the device (e.g., the Apple iPhone 4) is to be oriented (e.g., “towards Times Square”) to carry out at least a portion of at least one of the received one or more subtasks (e.g., “take a picture of the main ad display at Times Square at 8:52 am”).

Referring again to FIG. 7D, operation 504 may include operation 744 depicting providing a program configured to execute at least a portion of at least one of the received one more subtasks with access to one or more portions of the device that are used to carry out the portion of at least one of the received one or more subtasks. For example, FIG. 3 shows program for executing portion of subtask device access to portion of relevant device providing module 344 providing a program configured to execute at least a portion (e.g., a program that controls the microphone and memory to store sound data) of at least one of the received one or more subtasks (e.g., “determine the loudness of the crowd at a Washington Capitals game”) with access to one or more portions of the device (e.g., the microphone, and the memory, e.g., internal or on a card) that are used to carry out the portion of at least one of the received one or more subtasks.

Referring again to FIG. 7D, operation 504 may include operation 746 depicting providing access to one or more portions of the device that are used to carry out at least a portion of at least one of the received one or more subtasks. For example, FIG. 3 shows access to one or more portions of a device used to carry out at least a portion of at least one subtask providing module 346 providing access (e.g., granting access to the software for carrying out the subtask, or granting access for the user to control portions of the device) to one or more portions of the device (e.g., hardware or software, e.g., the image capturing sensor) that are used to carry out oat least a portion (e.g., “take a picture”) of at least one of the received one or more subtasks (e.g., “take a picture of the view of Puget Sound from the Space Needle”).

Referring again to FIG. 7D, operation 746 may include operation 748 depicting providing access to one or more sensors of the device that are used to collect information for carrying out at least a portion of at least one of the received one or more subtasks. For example, FIG. 3 shows access to one or more sensors of a device used to carry out at least a portion of at least one subtask providing module 348 providing access to one or more sensors of the device (e.g., the wireless radio) used to carry out at least a portion (e.g., “measure the number of wireless networks having an upload speed of greater than 2 MB/s”) of at least one subtask (e.g., “determine the wireless coverage in a particular area of Seattle, Wash.”) of the received one or more subtasks.

Referring again to FIG. 7D, operation 748 may include operation 750 depicting providing access to an image capturing sensor of the device used to collect image data for carrying out at least a portion of at least one of the received one or more subtasks. For example, FIG. 3 shows access to image capturing sensor of a device used to carry out at least a portion of at least one subtask providing module 350 providing access to an image capturing sensor (e.g., still camera or video camera) of the device (e.g., Acer Iconia) used to collect image data (e.g., a picture of Times Square) for carrying out at least a portion (e.g., “take a picture of Times Square”) of at least one of the received one or more subtasks (e.g., “estimate the number of people at Times Square on midnight at New Years' Eve”).

Referring again to FIG. 7D, operation 748 may include operation 752 depicting providing access to a microphone used to collect audio data for carrying out at least a portion of at least one of the received one or more subtasks. For example, FIG. 3 shows access to a microphone of a device used to carry out at least a portion of at least one subtask providing module 352 providing access to a microphone (e.g., a microphone of a Sony PVR recorder) used to collect audio data for carrying out at least a portion (e.g., “determine a recording of the song currently playing at the Billy Joel concert”) of at least one of the received one or more subtasks (e.g., many subtasks of “determine which songs are playing at the Billy Joel concert”).

Referring again to FIG. 7D, operation 748 may include operation 754 depicting providing access to a wireless radio used to collect data for carrying out at least a portion of at least one of the received one or more subtasks. For example, FIG. 3 shows access to a wireless radio of a device used to carry out at least a portion of at least one subtask providing module 354 providing access to a wireless radio used to collect data (e.g., a number of unencrypted wireless networks) for carrying out at least a portion of at least one of the received one or more subtasks (e.g., “determine how many unencrypted wireless networks are available at the nearest Starbucks”).

Referring now to FIG. 7E, operation 504 may include operation 756 depicting accessing one or more sensors of the device to collect information for carrying out at least a portion of at least one of the received one or more subtasks. For example, FIG. 3 shows information collecting sensor of device accessing module 356 accessing one or more sensors of the device (e.g., the image capturing sensor) to collect information (e.g., image data) for carrying out at least a portion of at least one of the received one or more subtasks (e.g., “take a picture of the pastries at Melon's Pastry shop in Old Town, Alexandria”).

Referring again to FIG. 7E, operation 504 may include operation 758 depicting transmitting a signal indicating that at least one of the received one or more subtasks has been executed. For example, FIG. 3 shows at least one received subtask is executed signal transmitting module 358 transmitting a signal (e.g., sending data to a location) indicating that at least one of the received one or more subtasks (e.g., “measure the 4G strength at Mama's Old Style Pizzaria”) has been executed (e.g., the data has been collected).

Referring again to FIG. 7E, operation 504 may include operation 760 depicting transmitting a signal indicating how many subtasks have been executed by the device. For example, FIG. 3 shows signal indicating how many subtasks have been executed transmitting module 360 transmitting a signal (e.g., sending data) indicating how many subtasks have been executed (e.g., “twenty (20) subtasks have been executed by this Nokia E5 phone”) by the device (e.g., the Nokia E5).

Referring again to FIG. 7E, operation 760 may include operation 762 depicting transmitting a signal indicating how many subtasks have been executed by the device when one or more subtasks have been executed. For example, FIG. 3 shows signal indicating how many subtasks have been executed transmitting in response to execution of a subtask module 362 transmitting a signal indicating how many subtasks have been executed by the device (e.g., the Samsung Nexus) when one or more subtasks have been executed (e.g., each time a subtask, e.g., “measure the barometric pressure in the Lower Queen Anne neighborhood in Seattle” is completed, transmit the signal indicating how many subtasks have been executed, e.g., transmit the total number, or transmit a number indicating that the total number, which may be stored elsewhere, should be incremented by one).

Referring again to FIG. 7E, operation 760 may include operation 764 depicting transmitting a signal indicating how many subtasks have been executed by the device, in response to a request from an external source. For example, FIG. 3 shows signal indicating how many subtasks have been executed in response to external source request transmitting module 364 transmitting a signal (e.g., data) indicating how many subtasks (e.g., twenty-five (25)) have been executed by the device (e.g., the Asus Transformer Prime tablet), in response to a request (e.g., a received signal requesting to know how many subtasks have been completed) from an external source (e.g., a server run by a communication network provider, e.g., Verizon).

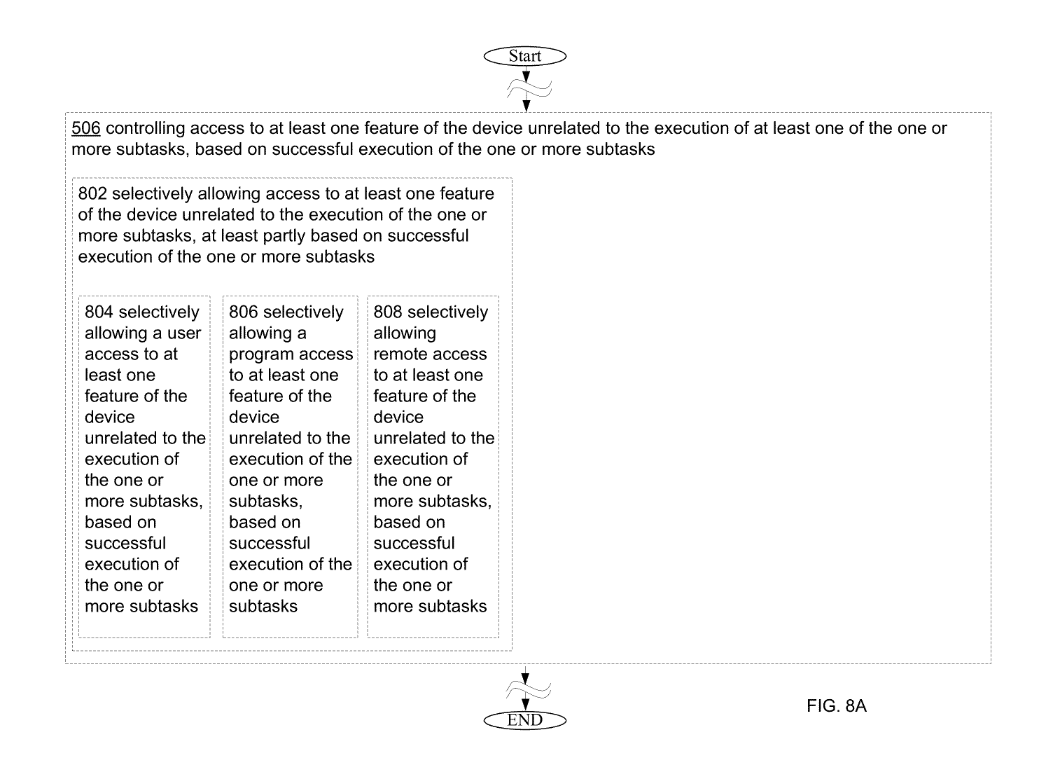

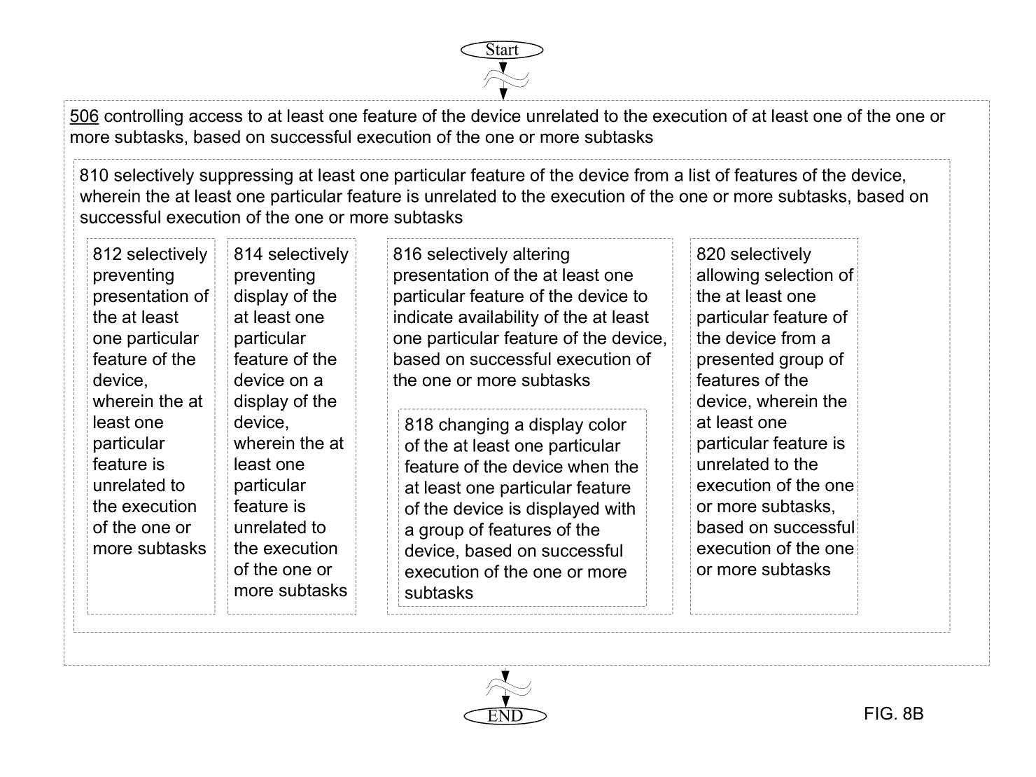

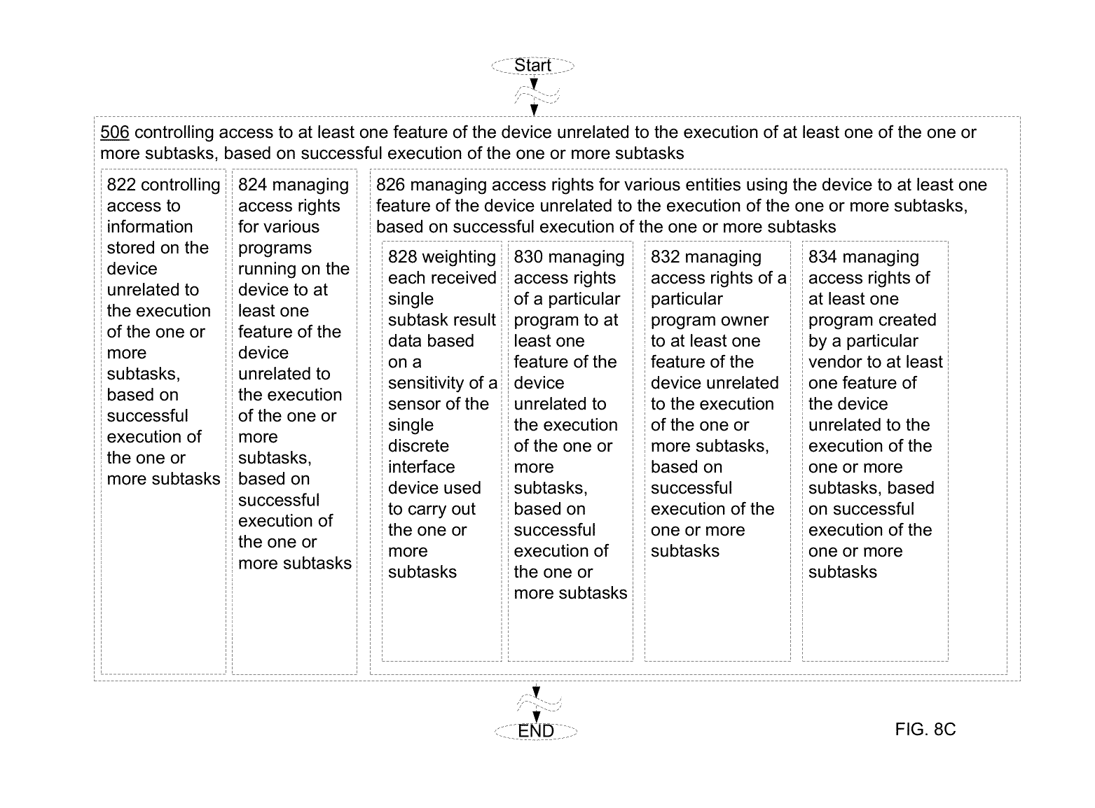

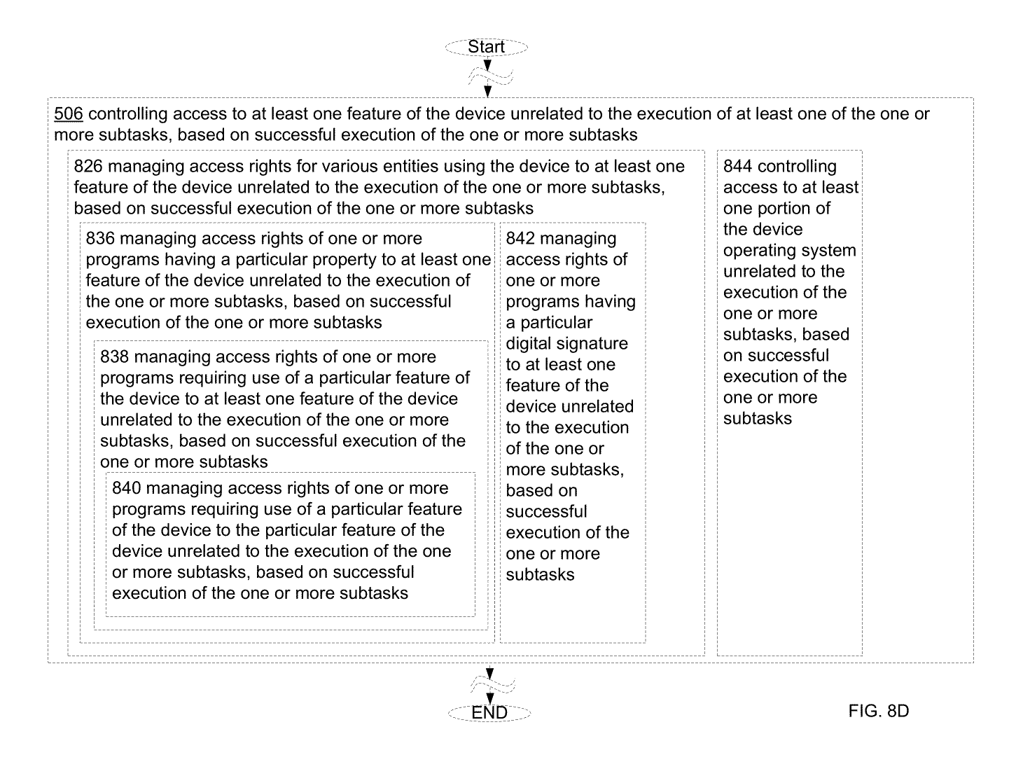

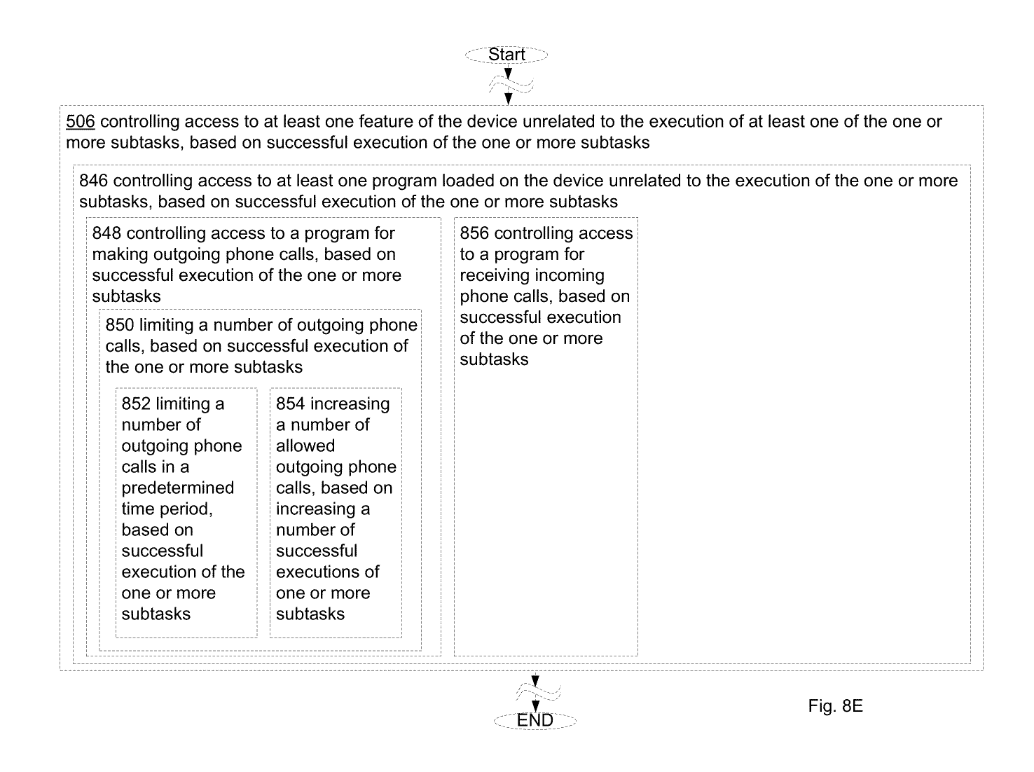

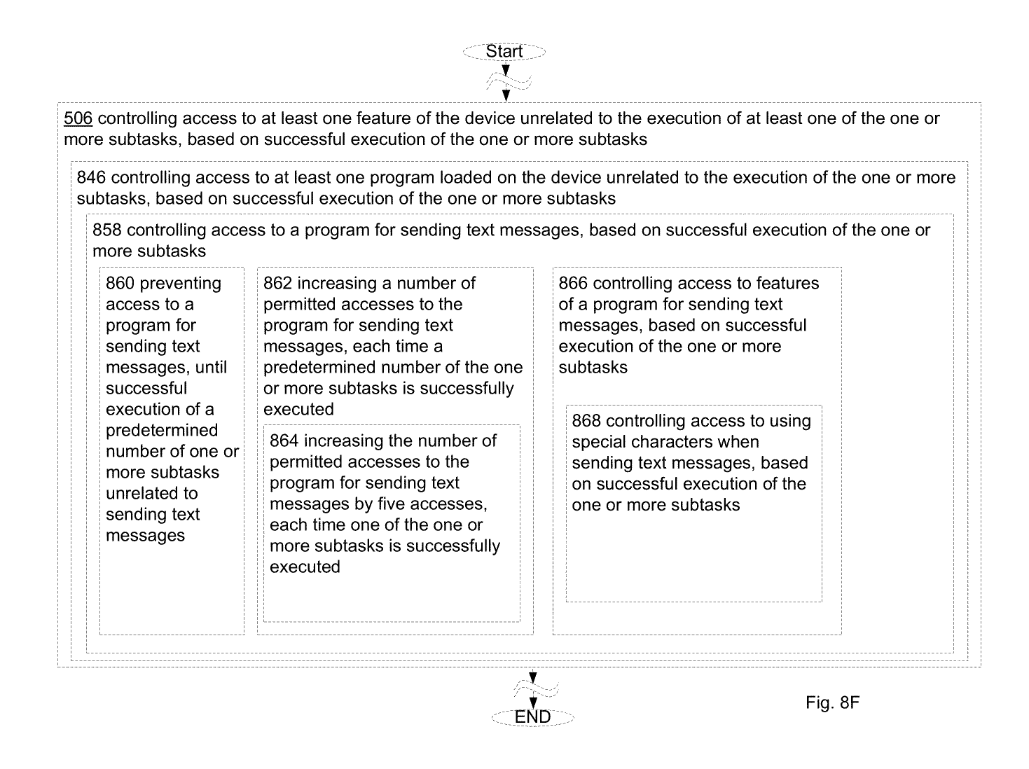

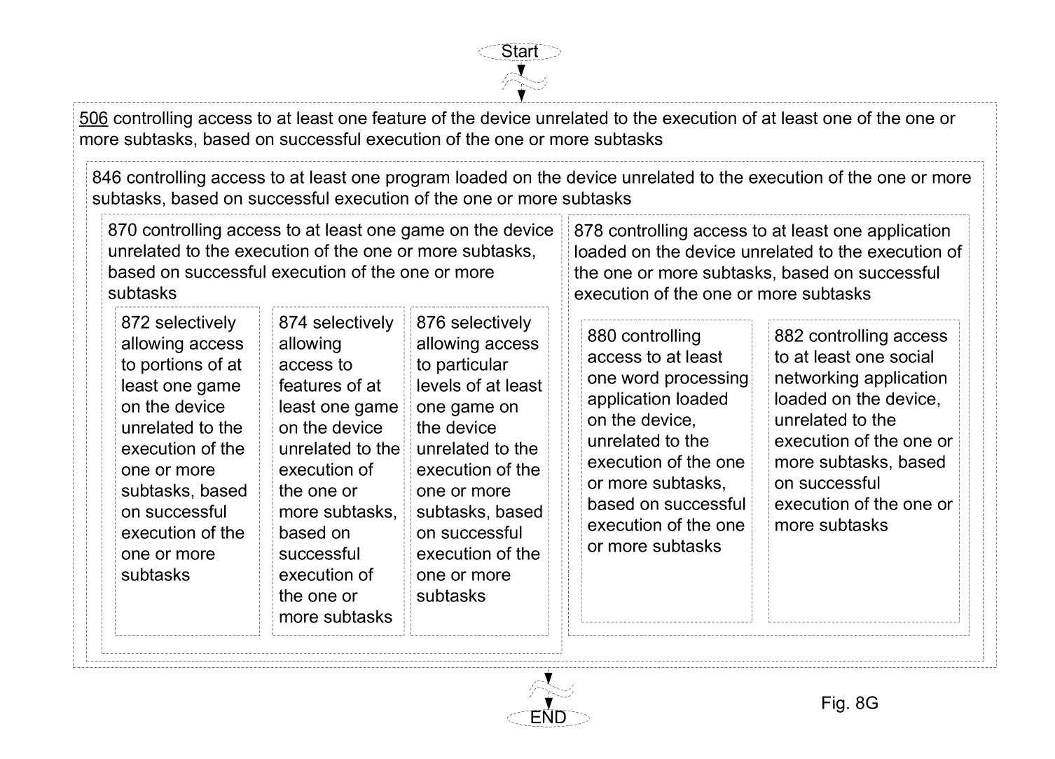

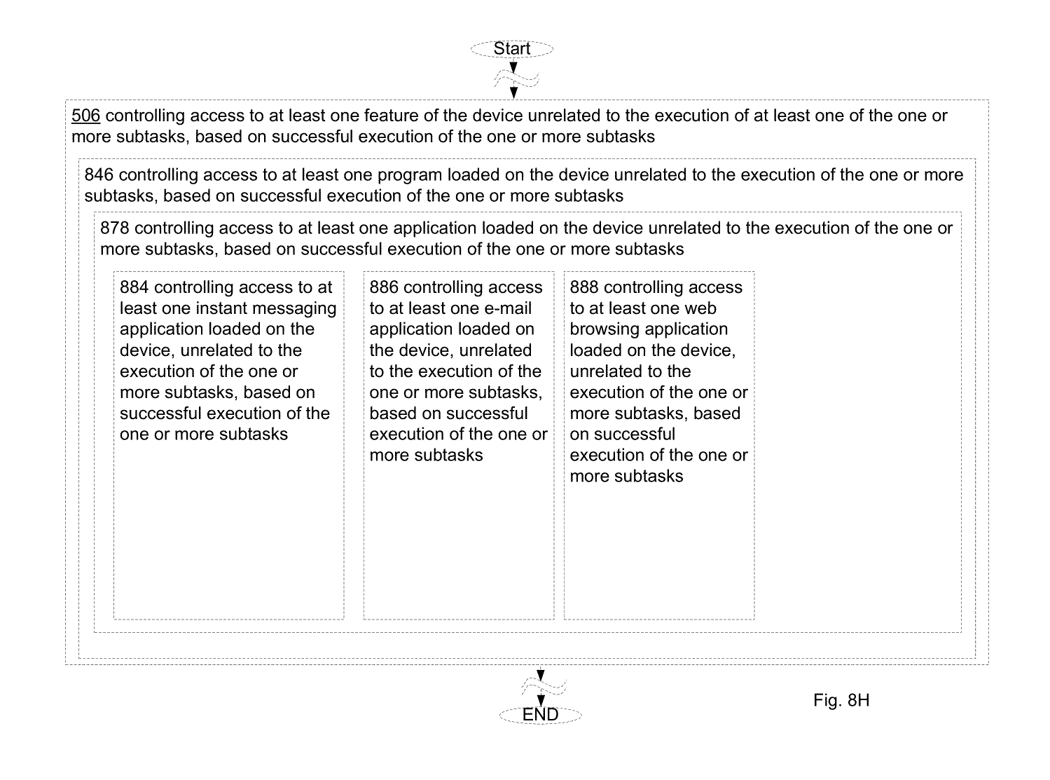

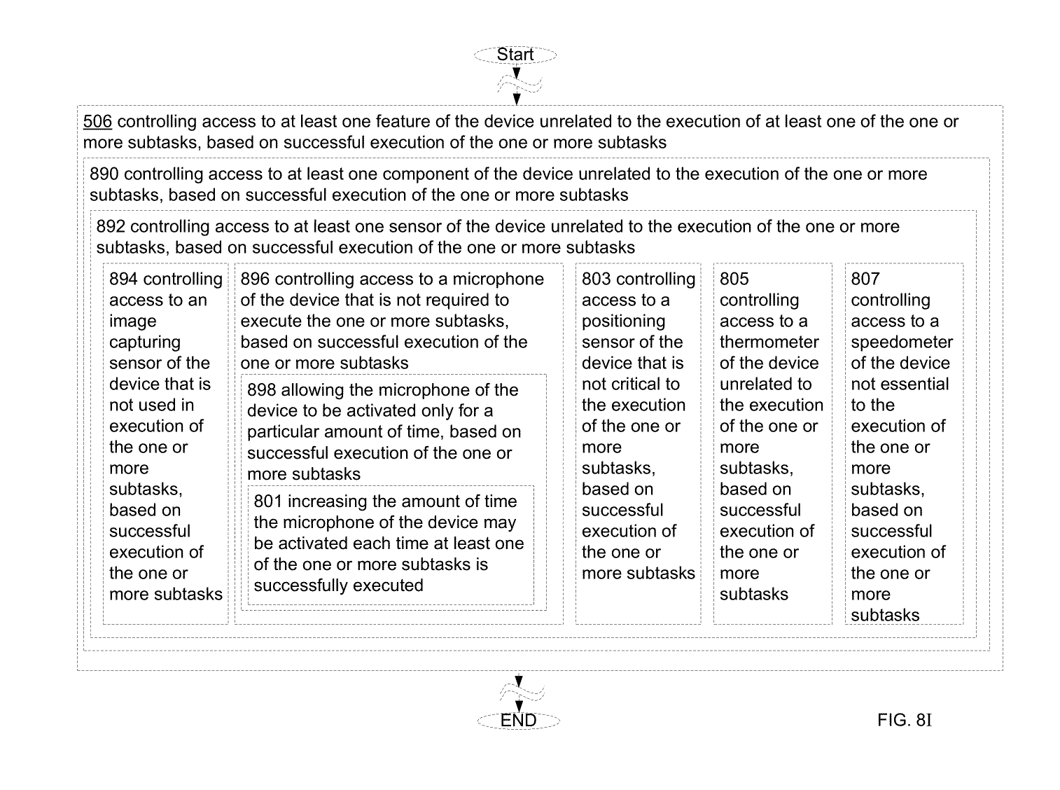

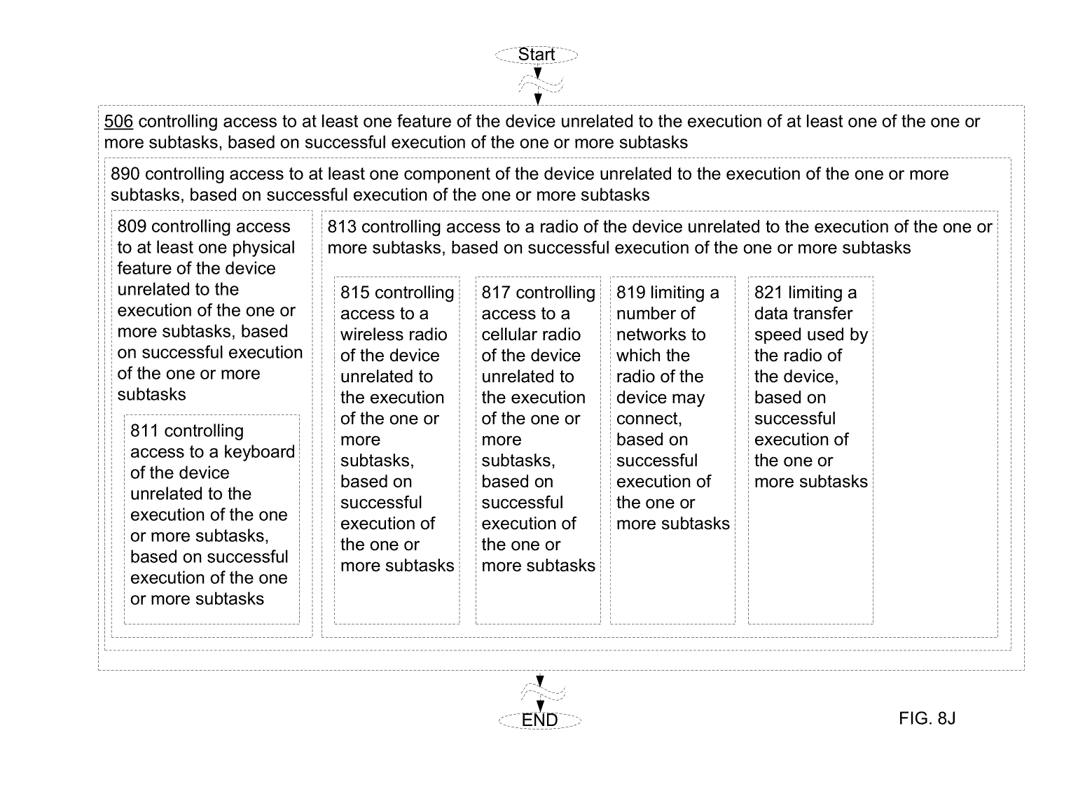

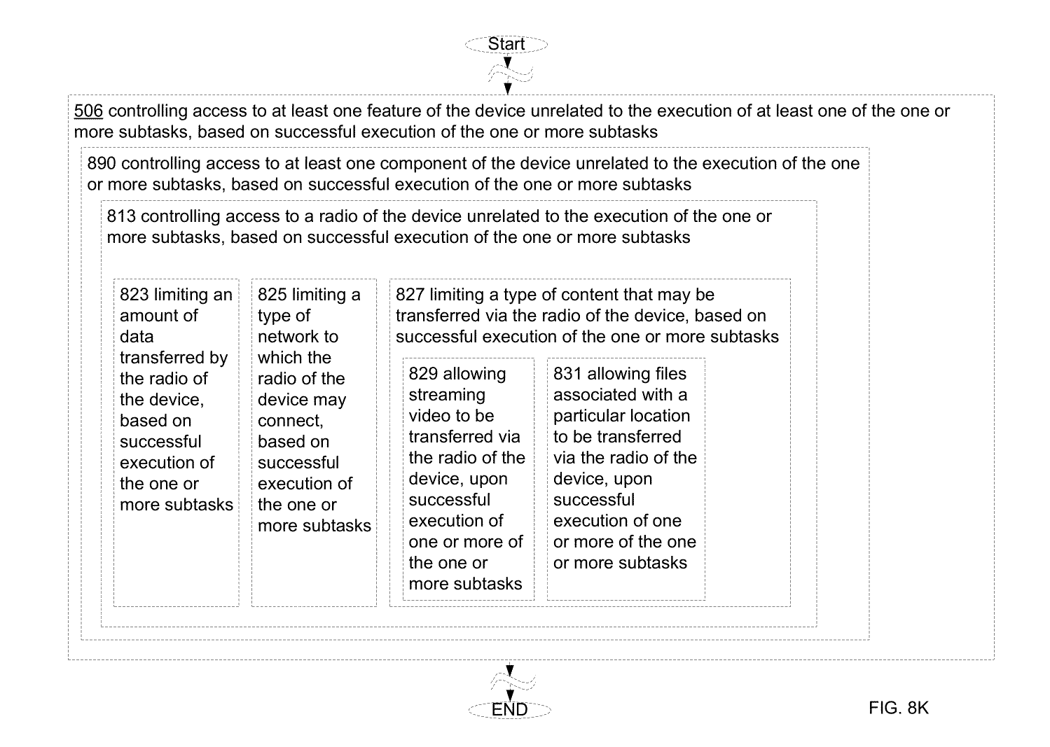

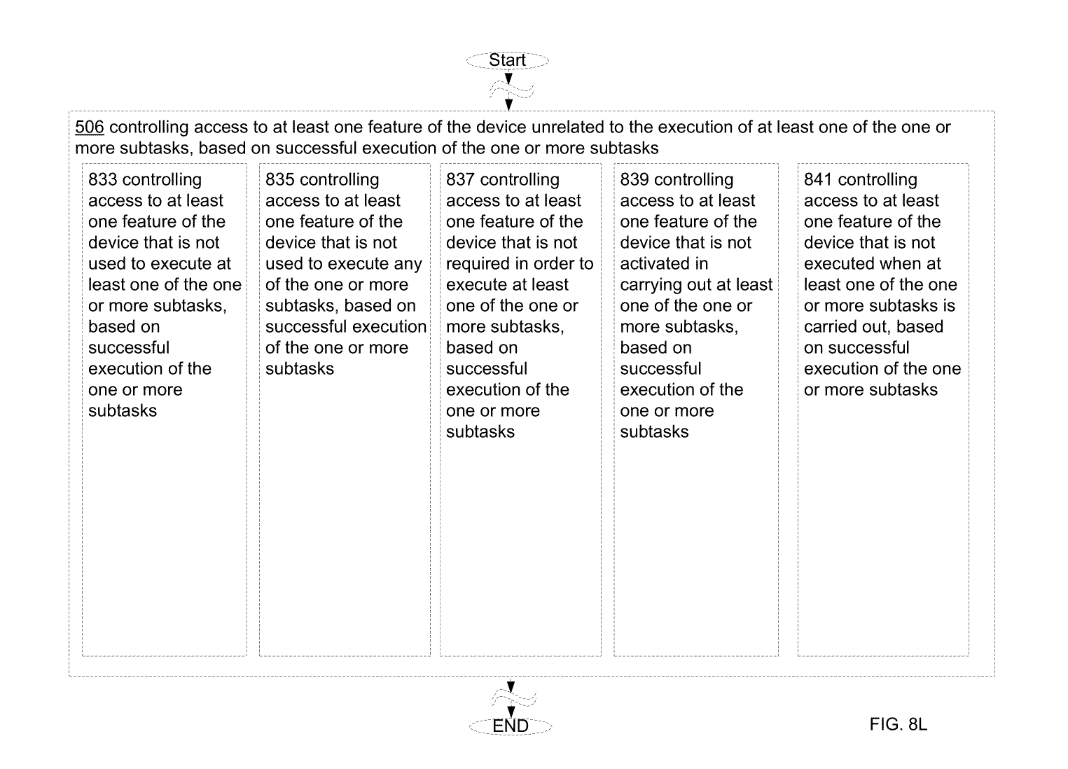

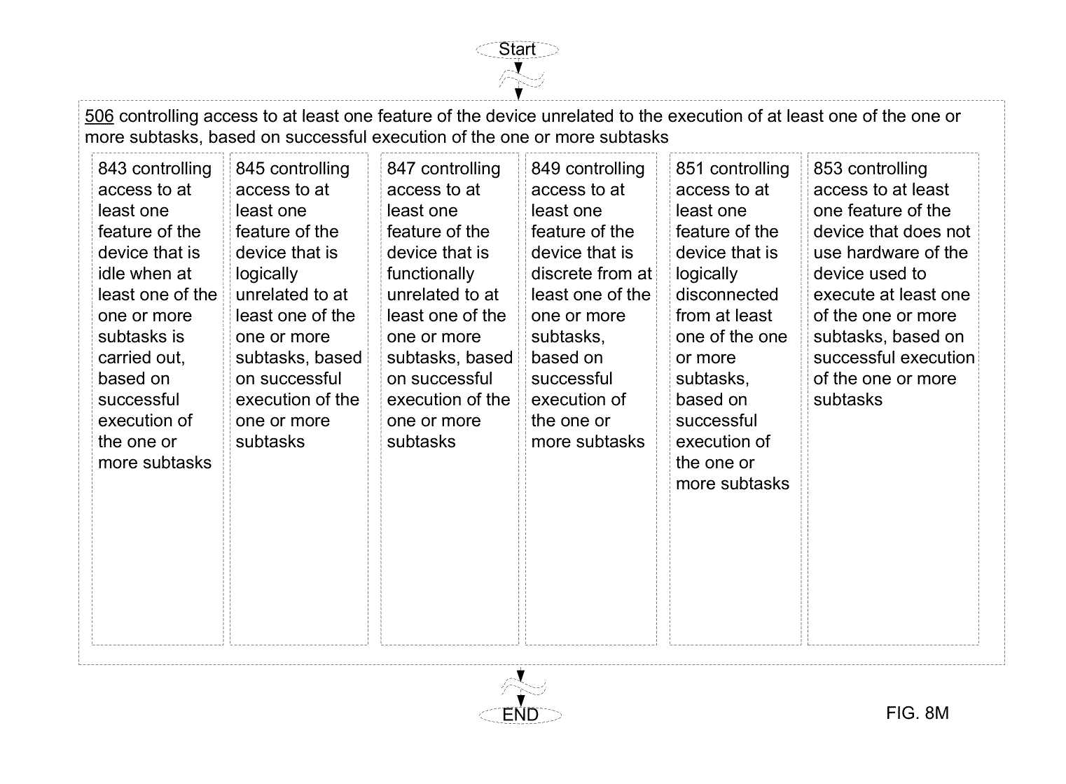

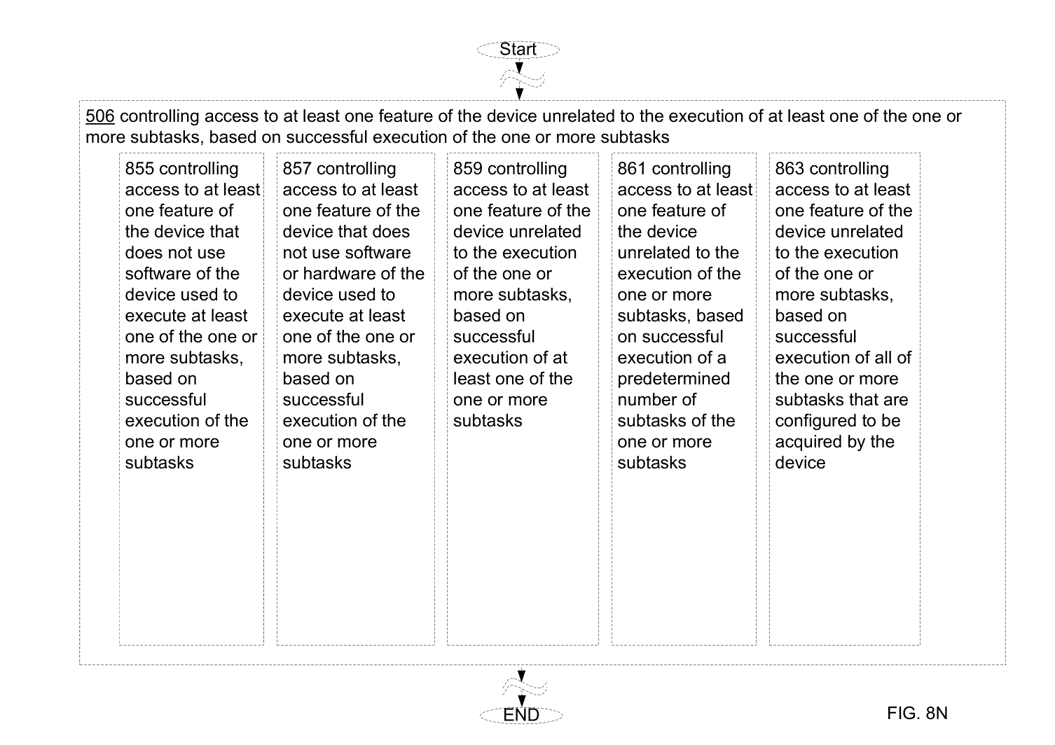

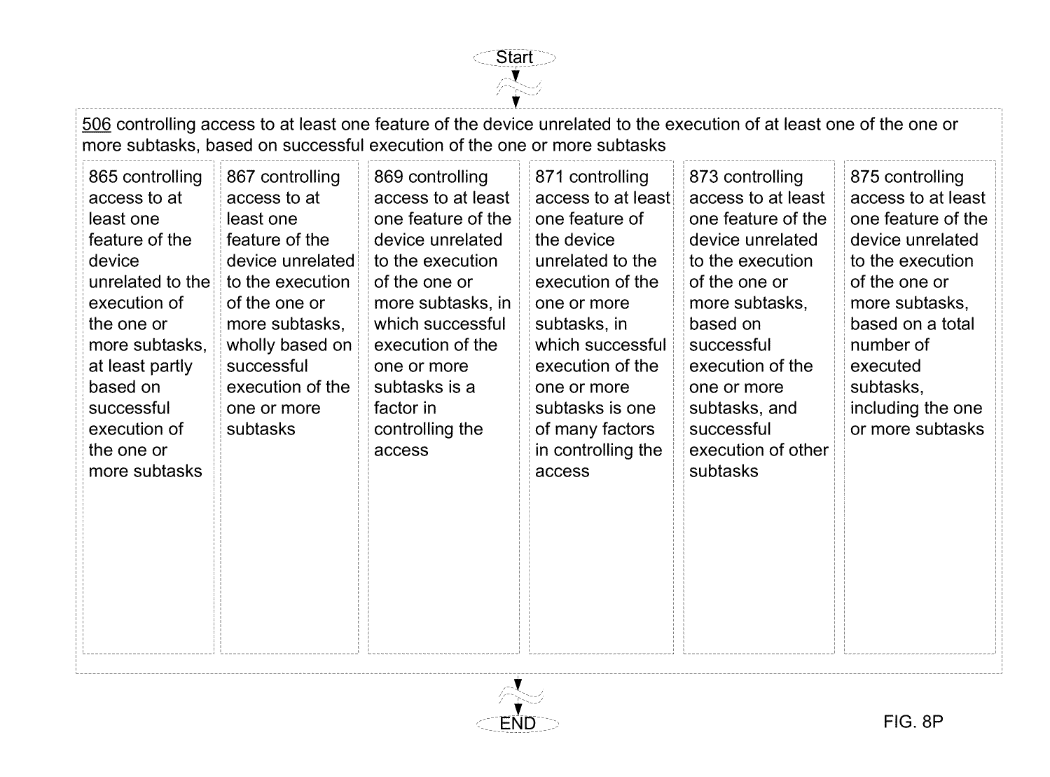

FIGS. 8A-8K depict various implementations of operation 506, according to embodiments. Referring now to FIG. 8A, operation 506 may include operation 802 depicting selectively allowing access to at least one feature of the device unrelated to the execution of the one or more subtasks, based on successful execution of the one or more subtasks. For example, FIG. 3 shows selectively allowing access to a device feature based on subtask execution module 402 selectively allowing access to at least one feature of the device (e.g., the SMS texting software of a mobile device) unrelated to the execution of the one or more subtasks (e.g., “take a picture of Times Square”), based on successful execution of the one or more subtasks (e.g., for every subtask that is completed, one access to SMS texting software is allowed).

Referring again to FIG. 8A, operation 802 may include operation 804 depicting selectively allowing a user access to at least one feature of the device unrelated to the execution of the one or more subtasks, based on successful execution of the one or more subtasks. For example, FIG. 4 shows selectively allowing a user access to a device feature based on subtask execution module 404 selectively allowing a user (e.g., the person in ownership of the device) access to at least one feature (e.g., outgoing SMS texting software) of the device (e.g., the mobile device) unrelated to the execution of the one or more subtasks (e.g., “take a picture of Times Square,” which is not needed for carrying out outgoing SMS text messages), based on successful execution of the one or more subtasks (e.g., for every successful subtask execution, the user may send ten (10) outgoing SMS texts).

Referring again to FIG. 8A, operation 802 may include operation 806 depicting selectively allowing a program access to at least one feature of the device unrelated to the execution of the one or more subtasks, based on successful execution of the one or more subtasks. For example, FIG. 4 shows selectively allowing a program access to a device feature based on subtask execution module 406 selectively allowing a program (e.g., a user has installed a game program) access to at least one feature of the device (e.g., the wireless or cellular radio, e.g., so the user can play online or submit high scores) unrelated to the execution of the one or more subtasks (e.g., the game program is unrelated to carrying out the one or more subtasks, even though the wireless radio may be used), based on successful execution of the one or more subtasks (e.g., “determine the number of people in line at the nearest Arby's restaurant”).

Referring again to FIG. 8A, operation 802 may include operation 808 depicting selectively allowing remote access to at least one feature of the device unrelated to the execution of the one or more subtasks, based on successful execution of the one or more subtasks. For example, FIG. 4 shows selectively allowing remote access to a device feature based on subtask execution module 408 selectively allowing remote access (e.g. access from somewhere other than at the device) to at least one feature of the device (e.g., accessing content stored on the device, e.g., a video clip from FX's television show “Archer”) unrelated to the execution of the one or more subtasks (e.g., the subtask of “determine the ambient temperature at your location” from a device that measures temperature and stores content), based on successful execution of the one or more subtasks (e.g., once a predetermined number, e.g., 5, subtasks have been completed, the media content stored on the device is available to be remotely accessed).

Referring now to FIG. 8B, operation 506 may include operation 810 depicting selectively suppressing at least one particular feature of the device from a list of features of the device, wherein the at least one particular feature is unrelated to the execution of the one or more subtasks, based on successful execution of the one or more subtasks. For example, FIG. 4 shows selectively suppressing a particular feature of the device that is unrelated to the execution of the one or more subtasks from a list of features of the device based on successful execution of the one or more subtasks module 410 selectively suppressing (e.g., controlling when something can be displayed, shown, accessed, read, or otherwise engaged) at least one particular feature of the device from a list of features of the device (e.g., preventing the feature from showing up in a search, or not displaying the icon from a menu of possible actions), wherein the at least one particular feature (e.g., “use the camera”) is unrelated to the execution of the one or more subtasks (e.g., “measure the temperature at your location”), based on successful execution of the one or more subtasks.

Referring again to FIG. 8B, operation 810 may include operation 812 depicting selectively preventing presentation of the at least one particular feature of the device, wherein the at least one particular feature is unrelated to the execution of the one or more subtasks. For example, FIG. 4 shows selectively preventing presentation of a particular feature unrelated to subtask execution module 412 selectively preventing presentation (e.g., controlling when presentation is made) of the at least one particular feature (e.g., “send a text message”) of the device, wherein the at least one particular feature (e.g., “send a text message”) is unrelated to the execution of the one or more subtasks (e.g., “measure the loudness at the Miley Cyrus concert”).

Referring again to FIG. 8B, operation 810 may include operation 814 depicting selectively preventing display of the at least one particular feature of the device on a display of the device, wherein the at least one particular feature is unrelated to the execution of the one or more subtasks. For example, FIG. 4 shows selectively preventing display of a particular feature on a device display unrelated to subtask execution module 414 selectively preventing display of the at least one particular feature of the device (e.g., preventing an option to “call this number” from appearing when a number is shown on screen, e.g., to disable outgoing calling), wherein the at least one particular feature (e.g., dialing outgoing numbers) is unrelated to the execution of the one or more subtasks (e.g., “determine speed across the George Washington Bridge”).

Referring again to FIG. 8B, operation 810 may include operation 816 depicting selectively altering presentation of the at least one particular feature of the device to indicate availability of the at least one particular feature of the device, based on successful execution of the one or more subtasks. For example, FIG. 4 shows selectively altering presentation of a particular feature to indicate availability on a device display unrelated to subtask execution module 416 selectively altering presentation (e.g., changing a color, or appearance, or adding an asterisk) of the at least one particular feature (e.g., “dial an outgoing number”) of the device (e.g., a mobile device, e.g., the iPhone 4), based on successful execution of the one or more subtasks (e.g., “determine the amount of ambient light at night at the corner of 2nd and Pike”).

Referring again to FIG. 8B, operation 816 may include operation 818 depicting changing a display color of the at least one particular feature of the device when the at least one particular feature of the device is displayed with a group of features of the device, based on successful execution of the one or more subtasks. For example, FIG. 4 shows selectively changing display color of a particular feature when displayed in a group module 418 changing a display color (e.g., from black to grey) of the at least one particular feature (e.g., “make an outgoing call”) of the device (e.g., the mobile smartphone) when the at least one particular feature of the device (e.g., “make an outgoing call”) is displayed with a group of features of the device (e.g., “save in contacts,” “send text message,” “send multimedia message,” “send e-mail,” “invite to Facebook”), based on successful execution (e.g., when enough subtasks have been completed, the feature display color is no longer changed) of the one or more subtasks (e.g., “determine the view of the end zone from your seat at RFK Stadium in Washington D.C.”).

Referring again to FIG. 8B, operation 810 may include operation 820 depicting selectively allowing selection of the at least one particular feature of the device from a presented group of features of the device, wherein the at least one particular feature is unrelated to the execution of the one or more subtasks, based on successful execution of the one or more subtasks. For example, FIG. 4 shows selectively allowing selection of a particular feature unrelated to subtask execution from a list of features on a module 420 selectively allowing selection (e.g., controlling when an option is capable of selection, e.g., with a mouse) of the at least one particular feature of the device (e.g., “play a game”) from a presented group of features of the device (e.g., “play a game,” “make a phone call,” “send a text message,” “log on to the internet”), wherein the at least one particular feature (e.g., “play a game”) is unrelated to the execution of the one or more subtasks (e.g., “rate the freshness of the cookies at the local Potbelly's restaurant”).

Referring now to FIG. 8C, operation 506 may include operation 822 depicting controlling access to information stored on the device unrelated to the execution of the one or more subtasks, based on successful execution of the one or more subtasks. For example, FIG. 4 shows device-stored information unrelated to subtask execution access controlling module 422 controlling access (e.g., permitting read, write, or both) to information stored on the device (e.g., an MPEG-2 Layer III audio file (“MP3”) catalog) unrelated to the execution of the one or more subtasks (e.g., “take a picture of the Grand Canyon from your location”), based on successful execution of the one or more subtasks (e.g., each successful execution of a subtask allows access to the MP3 catalog for one hour).

Referring again to FIG. 8C, operation 506 may include operation 824 depicting managing access rights for various programs running on the device to at least one feature of the device unrelated to the execution of the one or more subtasks, based on successful execution of the one or more subtasks. For example, FIG. 4 shows device programs unrelated to subtask execution access rights managing module 424 managing access rights (e.g., which programs have access to which other programs and hardware components) for various programs (e.g., a game program, which may want to access, e.g., the vibration function of the device) running on the device (e.g., the Samsung Galaxy Tab) to at least one feature of the device (e.g., the vibration function) unrelated to the execution of the one or more subtasks (e.g., “take a picture of Lake Washington”).

Referring again to FIG. 8C, operation 506 may include operation 826 depicting managing access rights for various entities using the device to at least one feature of the device unrelated to the execution of the one or more subtasks, based on successful execution of the one or more subtasks. For example, FIG. 4 shows entities using features of device unrelated to subtask execution access rights managing module 426 managing access rights (e.g., determining which programs a user can access) for various entities using the device (e.g., various people logged into the computing device) unrelated to the execution of the one or more subtasks (e.g., a person who has executed 25 subtasks while logged in may have access to different or more programs or content than a person who has executed 250 subtasks), based on successful execution of the one or more subtasks.

Referring again to FIG. 8C, operation 826 may include operation 828 depicting managing access rights of a particular user of the device to at least one feature of the device unrelated to the execution of the one or more subtasks, based on successful execution of the one or more subtasks. For example, FIG. 4 shows particular user using features of device unrelated to subtask execution access rights managing module 428 managing access rights of a particular user of the device (e.g., a user who is logged in, to a phone, a computer, a GPS navigator, or other device) to at least one feature of the device (e.g., streaming video) unrelated to the execution of the one or more subtasks (e.g., streaming video is not used for execution of the one or more subtasks), based on successful execution of the one or more subtasks (e.g., after twenty-five (25) subtasks have been completed, streaming video can be watched for that particular user).

Referring again to FIG. 8C, operation 826 may include operation 830 depicting managing access rights of a particular program to at least one feature of the device unrelated to the execution of the one or more subtasks, based on successful execution of the one or more subtasks. For example, FIG. 4 shows particular program accessing feature of device unrelated to subtask execution access rights managing module 430 managing access rights of a particular program (e.g., giving a word processing program access to the network communication interface to mail a document) to at least one feature of the device (e.g., the network communication interface) unrelated to the execution of the one or more subtasks (e.g., the network communication interface, although transmitting data, is unrelated to the subtask, “determine the amount of ambient light at your location”), based on successful execution of the one or more subtasks (e.g., after a predetermined number of subtasks have been completed, the word processing program gains access to the network communication interface).

Referring again to FIG. 8C, operation 826 may include operation 832 depicting managing access rights of a particular program owner to at least one feature of the device unrelated to the execution of the one or more subtasks, based on successful execution of the one or more subtasks. For example, FIG. 4 shows particular program owner accessing features of device unrelated to subtask execution access rights managing module 432 managing access rights of a particular program owner (e.g., Google, which owns the “google apps” programs, and all Google programs have their access rights managed) to at least one feature of the device (e.g., the keyboard input of a mobile device) unrelated to the execution of the one or more subtasks (e.g., keyboard input is unrelated to the subtask of “determine the 4G network strength at your present location”), based on successful execution of the one or more subtasks.

Referring again to FIG. 8C, operation 826 may include operation 834 depicting managing access rights of at least one program created by a particular vendor to at least one feature of the device unrelated to the execution of the one or more subtasks, based on successful execution of the one or more subtasks. For example, FIG. 4 shows particular vendor that created program accessing feature of device unrelated to subtask execution access rights managing module 434 managing access rights of at least one program (e.g., an email program, e.g. Hotmail) created by a particular vendor (e.g., Microsoft) to at least one feature of the device (e.g., outgoing data) unrelated to the execution of the one or more subtasks (e.g., “take a picture of the Eiffel Tower”), based on successful execution of the one or more subtasks (e.g., outgoing mail may be performed, but queued and not sent until one or more subtasks are executed).

Referring now to FIG. 8D, operation 826 may include operation 836 depicting managing access rights of one or more programs having a particular property to at least one feature of the device unrelated to the execution of the one or more subtasks, based on successful execution of the one or more subtasks. For example, FIG. 4 shows program having particular property accessing feature of device unrelated to subtask execution access rights managing module 436 managing access rights of one or more programs (e.g., web browsers) having a particular property (e.g., reading and parsing HTML) to at least one feature of the device (e.g., the network adapter, e.g., which may render them useless) unrelated to the execution of the one or more subtasks (e.g., “take a picture of the Eiffel Tower”), based on successful execution of the one or more subtasks (e.g., each time a subtask is completed, the “web browsers” class of programs will gain access to the network adapter for a particular amount of time).

Referring again to FIG. 8D, operation 836 may include operation 838 depicting managing access rights of one or more programs requiring use of a particular feature of the device to at least one feature of the device unrelated to the execution of the one or more subtasks, based on successful execution of the one or more subtasks. For example, FIG. 4 shows program requiring particular feature accessing feature of device unrelated to subtask execution access rights managing module 438 managing access rights of one or more programs (e.g., game programs and video display) requiring use of a particular feature of the device (e.g., a video processing chip or card) to at least one feature of the device (e.g., not necessarily the same feature, but to the feature of the wireless radio, e.g., preventing online play) unrelated to the execution of the one or more subtasks (e.g., “take a picture of the stage from the hill picnic seating at Merriweather Post Pavilion”), based on successful execution of the one or more subtasks.

Referring again to FIG. 8D, operation 838 may include operation 840 depicting managing access rights of one or more programs requiring use of a particular feature of the device to the particular feature of the device unrelated to the execution of the one or more subtasks, based on successful execution of the one or more subtasks. For example, FIG. 4 shows program requiring particular feature accessing particular feature of device unrelated to subtask execution access rights managing module 440 managing access rights of one or more programs (e.g., a game program) requiring use of a particular feature of the device (e.g., the video processor, e.g., the Graphics Processing Unit (“GPU”), which may be part of the larger chip structure or incorporated into software) to the particular feature of the device (e.g., the GPU) unrelated to the execution of the one or more subtasks (e.g., “measure the time taken to walk from 8th street to 2nd street”), based on successful execution of the one or more subtasks.

Referring again to FIG. 8D, operation 826 may include operation 842 depicting managing access rights of one or more programs having a particular digital signature to at least one feature of the device unrelated to the execution of the one or more subtasks, based on successful execution of the one or more subtasks. For example, FIG. 4 shows program having particular digital signature accessing feature of device unrelated to subtask execution access rights managing module 442 managing access rights of one or more programs (e.g., an e-mail client) having a particular digital signature to at least one feature of the device (e.g., smart word completion) unrelated to the execution of the one or more subtasks (e.g., “rate the freshness of the doughnuts at Top Pot Bakery”), based on successful execution of the one or more subtasks.

Referring again to FIG. 8D, operation 506 may include operation 844 depicting controlling access to at least one portion of the device operating system unrelated to the execution of the one or more subtasks, based on successful execution of the one or more subtasks. For example, FIG. 4 shows device operating system portion unrelated to subtask execution access rights managing module 444 controlling access to at least one portion of the device operating system (e.g., the portion that controls installing new software) unrelated to the execution of the one or more subtasks (e.g., “measure the pollen count at your location”), based on successful execution of the one or more subtasks (e.g., once a device has been used for executing subtasks, that portion of the device operating system may be accessed, and new programs may be installed).

Referring now to FIG. 8E, operation 506 may include operation 846 depicting controlling access to at least one program loaded on the device unrelated to the execution of the one or more subtasks, based on successful execution of the one or more subtasks. For example, FIG. 4 shows device-loaded program unrelated to execution of one or more subtasks access controlling module 446 controlling access to at least one program (e.g., Twitter) loaded on the device (e.g., the Acer Iconia) unrelated to the execution of the one or more subtasks (e.g., “determine the relative humidity at your location”), based on successful execution of the one or more subtasks.

Referring again to FIG. 8E, operation 846 may include operation 848 depicting controlling access to a program for making outgoing phone calls, based on successful execution of the one or more subtasks. For example, FIG. 4 shows subtask execution-based outgoing call-making program access controlling module 448 controlling access to a program for making outgoing phone calls (e.g., a phone dialer), based on successful execution of the one or more subtasks (e.g., if there is a subtask loaded on the device and ready to be completed, the device may prevent outgoing phone calls until the subtask is completed).

Referring again to FIG. 8E, operation 848 may include operation 850 depicting limiting a number of outgoing phone calls, based on successful execution of the one or more subtasks. For example, FIG. 4 shows subtask execution-based outgoing call-making program number limiting module 450 limiting a number of outgoing phone calls, based on successful execution of the one or more subtasks (e.g., for each subtask that is completed, the device may permit three (3) outgoing phone calls). In other embodiments, the number of outgoing phone calls allowed for each completed subtask may vary based on one or more properties of the subtask, similarly to the subtask unit value described above.

Referring again to FIG. 8E, operation 850 may include operation 852 depicting limiting a number of outgoing phone calls in a predetermined time period, based on successful execution of the one or more subtasks. For example, FIG. 4 shows subtask execution-based outgoing call-making program number in predetermined time period limiting module 452 limiting a number of outgoing phone calls in a predetermined time period (e.g., only permitting 5 outgoing phone calls per week per subtask completed), based on successful execution of the one or more subtasks (e.g., each successful subtask execution increases the number of outgoing phone calls per predetermined time period that are allowed, for example, if three subtasks are completed, then five outgoing calls per week are allowed, but if four subtasks are completed, then ten outgoing calls per week are allowed).

Referring again to FIG. 8E, operation 850 may include operation 854 depicting increasing a number of allowed outgoing phone calls, based on increasing a number of successful executions of one or more subtasks. For example, FIG. 4 shows subtask execution-based outgoing call-making program total number limiting module 454 increasing a number of allowed outgoing phone calls, based on increasing a number of successful executions of one or more subtasks (e.g., each successfully completed subtask increases the total number of outgoing phone calls that are allowed to be made).

Referring again to FIG. 8E, operation 846 may include operation 856 depicting controlling access to a program for receiving incoming phone calls, based on successful execution of the one or more subtasks. For example, FIG. 4 shows subtask execution-based incoming call-making program access controlling module 456 controlling access to a program for receiving incoming phone calls (e.g., a program on a mobile device that handles incoming phone calls), based on successful execution of the one or more subtasks (e.g., until a predetermined number of subtasks have been completed, the device cannot access the program that handles incoming phone calls, thus preventing the incoming phone calls from being completed).

Referring now to FIG. 8F, operation 846 may include operation 858 depicting controlling access to a program for sending text messages, based on successful execution of the one or more subtasks. For example, FIG. 4 shows subtask execution-based text messaging program access controlling module 458 controlling access to a program for sending text messages (e.g., the program for sending text messages may be accessed only at particular time periods during the day, e.g., from 5-7 pm), based on successful execution of the one or more subtasks (e.g., each subtask completed may increase the time period for which the text message program may be accessed, e.g., with four subtasks completed, the program for sending text messages may be accessed from 3-7 pm, but with ten subtasks completed, the program for sending text messages may be accessed from 1-11 pm. In the context of this application, “text messages” can refer to Short Message Service (“SMS”) messages, Multimedia Message Service (“MMS”) messages, Enhanced Messaging Service (“EMS”), instant messages, Premium-Rated Short Message Service (“PSMS”), SkyMail, Short Mail, Wireless Application Protocol (“WAP”) messages, and the like. It is noted that “text messages” do not necessarily contain only text, despite their name, but the name “text messages” merely refers to how a large group of types of messages are colloquially categorized.

Referring again to FIG. 8F, operation 858 may include operation 860 depicting preventing access to a program for sending text messages, until successful execution of a predetermined number of one or more subtasks unrelated to sending text messages. For example, FIG. 4 shows prevention of text messaging program access until successful subtask execution access preventing module 460 preventing access to a program for sending text messages (e.g., disallowing a user to send text messages), until successful execution of a predetermined number of one or more subtasks (e.g., “take a picture of the Taj Mahal”) unrelated to sending text messages (e.g., text messages are not needed to take a picture of the Taj Mahal).

Referring again to FIG. 8F, operation 858 may include operation 862 depicting increasing a number of permitted accesses to the program for sending text messages, each time a predetermined number of the one or more subtasks is successfully executed. For example, FIG. 4 shows number of permitted accesses to program for sending text messages increasing by predetermined number relative to subtask execution increasing module 462 increasing a number of permitted accesses (e.g., increasing the number of times a user of the device is allowed to run the text messaging service program) to the program for sending text messages (e.g., the text messaging service software on the device), each time a predetermined number (e.g., one) of the one or more subtasks is successfully executed (e.g., each time a “take a picture” subtask or other subtask is completed).

Referring again to FIG. 8F, operation 862 may include operation 864 depicting increasing the number of permitted accesses to the program for sending text messages by five accesses, each time one of the one or more subtasks is successfully executed. For example, FIG. 4 shows number of permitted accesses to program for sending text messages increasing by predetermined number relative to subtask execution increasing by five module 464 increasing the number of permitted accesses to the program for sending text messages (e.g., Nokia's text messaging software loaded on a Nokia E7) by five accesses, each time one of the one or more subtasks (e.g., “determine the 3G signal strength for AT&T′s network at your location”) is successfully executed.

Referring again to FIG. 8F, operation 458 may include operation 866 depicting controlling access to features of a program for sending text messages, based on successful execution of the one or more subtasks. For example, FIG. 4 shows subtask execution-based text messaging program feature access controlling module 866 controlling access to features of a program for sending text messages (e.g., a text message spell-checking program), based on successful execution of the one or more subtasks (e.g., completing a number of subtasks will allow a user of the device to access the spell-checking features of the program on the device that sends and receives text messages.

Referring again to FIG. 8F, operation 866 may include operation 868 depicting controlling access to using special characters when sending text messages, based on successful execution of the one or more subtasks. For example, FIG. 4 shows subtask execution-based text messaging program special character feature access controlling module 868 controlling access to using special characters (e.g., emoticons, e.g., smiley faces) when sending text messages, based on successful execution of the one or more subtasks (e.g., completing the subtask “determine how many people are in line for a cheeseburger at the McDonald's closest to your location” will provide access to using a predetermined number of frowny-face emoticons.)

Referring now to FIG. 8G, operation 846 may include operation 870 depicting controlling access to at least one game on the device unrelated to the execution of the one or more subtasks, based on successful execution of the one or more subtasks. For example, FIG. 4 shows subtask execution-based game program access controlling module 456 controlling access to at least one game (e.g., “Angry Birds”) on the device (e.g., Apple iPad) unrelated to the execution of the one or more subtasks (e.g., the game Angry Birds is not needed to carry out subtasks), based on successful execution of the one or more subtasks (e.g., the Angry Birds game cannot be launched until five subtasks have been completed).

Referring again to FIG. 8G, operation 870 may include operation 872 depicting selectively allowing access to portions of at least one game on the device unrelated to the execution of the one or more subtasks, based on successful execution of the one or more subtasks. For example, FIG. 4 shows subtask execution-based portions of game program access selective allowing module 472 selectively allowing access to portions (e.g., additional locations) of at least one game (e.g., World of Warcraft) on the device (e.g., Dell XPS 15) unrelated to the execution of the one or more subtasks (e.g., World of Warcraft is unrelated to carrying out subtasks), based on successful execution of the one or more subtasks (e.g., each successfully completed subtask may result in allowed access to an additional location for World of Warcraft).

Referring again to FIG. 8G, operation 870 may include operation 874 depicting selectively allowing access to features of at least one game on the device unrelated to the execution of the one or more subtasks, based on successful execution of the one or more subtasks. For example, FIG. 4 shows subtask execution-based features of game program access selective allowing module 474 selectively allowing access to features (e.g., character appearance upgrades, e.g., different shirts, hats, or outfits) of at least one game (e.g., Grand Theft Auto) on the device (e.g., Samsung Focus S) unrelated to the execution of the one or more subtasks, based on successful execution of the one or more subtasks (e.g., every ten successfully completed subtasks may unlock a new hat for the main character to wear in-game, in a third-person shooter game).

Referring again to FIG. 8G, operation 870 may include operation 876 depicting selectively allowing access to particular levels of at least one game on the device unrelated to the execution of the one or more subtasks, based on successful execution of the one or more subtasks. For example, FIG. 4 shows subtask execution-based levels of game program access selective allowing module 476 selectively allowing access to particular levels (e.g., “stages”) of at least one game (e.g., “Angry Birds in Space”) on the device (e.g., HTC HD2 mobile device) unrelated to the execution of the one or more subtasks, based on successful execution of the one or more subtasks (e.g., each successful execution of twenty subtasks unlocks a new level for Angry Birds in Space).

Referring again to FIG. 8G, operation 846 may include operation 878 depicting controlling access to at least one application loaded on the device unrelated to the execution of the one or more subtasks, based on successful execution of the one or more subtasks. For example, FIG. 4 shows subtask execution-based application access controlling module 478 controlling access (e.g., crippling certain functions) to at least one application (e.g., Microsoft Excel) loaded on the device (e.g., HP Folio) unrelated to the execution of the one or more subtasks (e.g., the Microsoft Excel program is not used to execute the subtask of “determine the loudness of the construction noise outside your office”), based on successful execution of the one or more subtasks (e.g., access to Microsoft Excel is prevented or limited (e.g., no cell formulas are allowed until a predetermined number of subtasks have been completed).

Referring again to FIG. 8G, operation 878 may include operation 880 depicting controlling access to at least one word processing application loaded on the device, unrelated to the execution of the one or more subtasks, based on successful execution of the one or more subtasks. For example, FIG. 4 shows subtask execution-based word processing application access controlling module 480 controlling access (e.g., preventing too many uses of a certain function, e.g., the “save” function) to at least one word processing application (e.g., OpenOffice) loaded on the device (e.g., Dell Inspiron), unrelated to the execution of the one or more subtasks (e.g., “measure the temperature at a particular time”), based on successful execution of the one or more subtasks (e.g., for each subtask that is successfully completed, fifty more uses of the “save” feature are activated).

Referring again to FIG. 8G, operation 878 may include operation 882 depicting controlling access to at least one social networking application loaded on the device, unrelated to the execution of the one or more subtasks, based on successful execution of the one or more subtasks. For example, FIG. 4 shows subtask execution-based social networking application access controlling module 482 controlling access to at least one social networking application (e.g., “Facebook”) loaded on the device (e.g., the Samsung Captivate), unrelated to the execution of the one or more subtasks (e.g., “determine how many WPA encrypted wireless networks are visible from your current location”), based on successful execution of the one or more subtasks (e.g., access to logging on to Facebook is limited or prevented until a predetermined number of subtasks have been completed).

Referring now to FIG. 8H, operation 878 may include operation 884 depicting controlling access to at least one instant messaging application loaded on the device, unrelated to the execution of the one or more subtasks, based on successful execution of the one or more subtasks. For example, FIG. 4 shows subtask execution-based instant messaging application access controlling module 484 controlling access to at least one instant messaging application (e.g., AOL Instant Messenger) loaded on the device (e.g., the Motorola Brute i686), unrelated to the execution of the one or more subtask (e.g., “take a picture of Mt. Rushmore”), based on successful execution of the one or more subtasks (e.g., the AOL Instant Messenger application cannot be executed until twenty-five subtasks have been completed by the Motorola Brute).

Referring again to FIG. 8H, operation 878 may include operation 886 depicting controlling access to at least one e-mail application loaded on the device, unrelated to the execution of the one or more subtasks, based on successful execution of the one or more subtasks. For example, FIG. 4 shows subtask execution-based e-mail application access controlling module 486 controlling access to at least one e-mail application (e.g., Google GMail) loaded on the device (e.g., HTC Droid Incredible), unrelated to the execution of the one or more subtasks (e.g., the e-mail application is not related to the execution of at least one or more subtasks), based on successful execution of the one or more subtasks (e.g., sending mail is delayed for a predetermined number of minutes based on the number of subtasks that have been completed in the previous week).

Referring again to FIG. 8H, operation 878 may include operation 888 depicting controlling access to at least one web browsing application loaded on the device, unrelated to the execution of the one or more subtasks, based on successful execution of the one or more subtasks. For example, FIG. 4 shows subtask execution-based web browsing application access controlling module 488 controlling access to at least one web browsing application (e.g., Opera Browser) loaded on the device (e.g., BlackBerry Bold), unrelated to the execution of the one or more subtasks (e.g., the web browser is not needed to complete the one or more subtasks), based on successful execution of the one or more subtasks (e.g., the Opera Browser automatically terminates after a predetermined number of minutes running, based on the number of subtasks that have been completed over the lifetime of the BlackBerry Bold).

Referring now to FIG. 8I, operation 506 may include operation 890 depicting controlling access to at least one component of the device unrelated to the execution of the one or more subtasks, based on successful execution of the one or more subtasks. For example, FIG. 4 shows subtask execution-based component access controlling module 490 controlling access to at least one component (e.g., the front-facing camera of the device) of the device (e.g., the Motorola Droid Razr) unrelated to the execution of the one or more subtasks (e.g., the subtasks of “determine the temperature at your location”).

Referring again to FIG. 8I, operation 890 may include operation 892 depicting controlling access to at least one sensor of the device unrelated to the execution of the one or more subtasks, based on successful execution of the one or more subtasks. For example, FIG. 4 shows subtask execution-based sensor unrelated to subtask execution access controlling module 492 controlling access to at least one sensor (e.g., the microphone) of the device (e.g., the Palm Pre Plus) unrelated to the execution of the one or more subtasks (e.g., “take a picture of the Space Needle”), based on successful execution of the one or more subtasks.

Referring again to FIG. 8I, operation 892 may include operation 894 depicting controlling access to an image capturing sensor of the device that is not used in execution of the one or more subtasks, based on successful execution of the one or more subtasks. For example, FIG. 4 shows subtask execution-based image capturing sensor not used in subtask execution access controlling module 494 controlling access to an image capturing sensor (e.g., a camera) of the device (e.g., the Apple iPhone 4S) that is not used in execution of the one or more subtasks (e.g., “measure the signal strength in the Starbucks closest to your location”), based on successful execution of the one or more subtasks.

Referring again to FIG. 8I, operation 892 may include operation 896 depicting controlling access to a microphone of the device that is not required to execute the one or more subtasks, based on successful execution of the one or more subtasks. For example, FIG. 4 shows subtask execution-based microphone not required to execute subtasks access controlling module 496 controlling access to a microphone of the device (e.g., a Dell XPS laptop computer) that is not required to execute the one or more subtasks (e.g., “take a picture of the counter of the coffee shop at your location”), based on successful execution of the one or more subtasks.

Referring again to FIG. 8I, operation 896 may include operation 898 depicting allowing the microphone of the device to be activated only for a particular amount of time, based on successful execution of the one or more subtasks. For example, FIG. 4 shows subtask execution-based microphone particular activation time allowing module 498 allowing the microphone of the device (e.g., the Samsung Galaxy Tab) to be activated only for a particular amount of time (e.g., less than sixty total minutes), based on successful execution of the one or more subtasks (e.g., the more subtasks are completed, the longer the total amount of time the microphone is allowed to be activated).

Referring again to FIG. 8I, operation 898 may include operation 801 depicting increasing the amount of time the microphone of the device may be activated each time at least one of the one or more subtasks is successfully executed. For example, FIG. 4 shows microphone activation time allowing increasing on each successful subtask execution module 401 increasing the amount of time increasing the amount of time the microphone of the device (e.g., the Droid Razr) may be activated (e.g., one minute per subtask) each time at least one of the one or more subtasks is successfully executed (e.g., when zero subtasks have been completed, the microphone may only be activated for one minute at a time. Thereafter, for each subtask that is completed, the microphone may be activated for an additional one minute at a time. For example, if the user of the device has completed ten subtasks, then the microphone may be activated for eleven minutes at a time).

Referring again to FIG. 8I, operation 892 may include operation 803 depicting controlling access to a positioning sensor of the device that is not critical to the execution of the one or more subtasks, based on successful execution of the one or more subtasks. For example, FIG. 4 shows subtask execution-based positioning sensor not critical to subtask execution access controlling module 403 controlling access to a positioning sensor (e.g., a GPS sensor) of the device that is not critical to the execution of the one or more subtasks (e.g., the sensor may provide useful information, but the subtask can be completed without the use of the sensor), based on successful execution of the one or more subtasks.

Referring again to FIG. 8I, operation 892 may include operation 805 depicting controlling access to a thermometer of the device unrelated to the execution of the one or more subtasks, based on successful execution of the one or more subtasks. For example, FIG. 4 shows subtask execution-based thermometer unrelated to subtask execution access controlling module 405 controlling access to a thermometer of the device (e.g., a thermometer built into a smartphone) unrelated to the execution of the one or more subtasks (e.g., “measure the 4G signal strength on Mercer Island'), based on successful execution of the one or more subtasks (e.g., in this example, the thermometer is not limited, but the output is not made available to the device until a particular number of subtasks have been completed).

Referring again to FIG. 8I, operation 892 may include operation 807 depicting controlling access to a speedometer of the device not essential to the execution of the one or more subtasks, based on successful execution of the one or more subtasks. For example, FIG. 4 shows subtask execution-based speedometer not essential to subtask execution access controlling module 407 controlling access to a speedometer of the device (e.g., a tablet with a speedometer/GPS calculator) not essential (e.g., not required, but possibly useful) to the execution of the one or more subtasks, based on successful execution of the one or more subtasks.

Referring now to FIG. 8J, operation 890 may include operation 809 depicting controlling access to at least one physical feature of the device unrelated to the execution of the one or more subtasks, based on successful execution of the one or more subtasks. For example, FIG. 4 shows subtask execution-based physical feature access controlling module 409 controlling access to at least one physical feature (e.g., the trackball) of the device (e.g., the Blackberry Torch) unrelated to the execution of the one or more subtasks (e.g., the trackball is not required to carry out the subtasks, but merely provides added convenience for the user), based on successful execution of the one or more subtasks (e.g., “measure the ambient noise on 32nd street”).

Referring again to FIG. 8J, operation 809 may include operation 811 depicting controlling access to a keyboard of the device unrelated to the execution of the one or more subtasks, based on successful execution of the one or more subtasks. For example, FIG. 4 shows subtask execution-based keyboard access controlling module 411 controlling access to a keyboard of the device (e.g., the Motorola Droid, which has a touch screen for use and an optional keyboard) unrelated to the execution of the one or more subtasks (e.g., the keyboard is not required to carry out subtasks), based on successful execution of the one or more subtasks (e.g., “determine how many WPA-encrypted wireless networks are visible from your location”).

Referring again to FIG. 8J, operation 490 may include operation 813 depicting controlling access to a radio of the device unrelated to the execution of the one or more subtasks, based on successful execution of the one or more subtasks. For example, FIG. 4 shows subtask execution-based radio access controlling module 413 controlling access to a radio (e.g., a wireless radio) of the device (e.g., an Apple iPad 3G) unrelated to the execution of the one or more subtasks (e.g., “take a picture of Times Square at 9 pm at night”), based on successful execution of the one or more subtasks.

Referring again to FIG. 8J, operation 813 may include operation 815 depicting controlling access to a wireless radio of the device unrelated to the execution of the one or more subtasks, based on successful execution of the one or more subtasks. For example, FIG. 4 shows subtask execution-based wireless radio access controlling module 415 controlling access to a wireless radio of the device (e.g., the Apple iPad 3G) unrelated to the execution of the one or more subtasks (e.g., the wireless radio may be used to transmit the information after the subtask is completed, but may be unused in executing a subtask, e.g., “take a picture of the cakes at Carvel's”), based on successful execution of the one or more subtasks.

Referring again to FIG. 8J, operation 813 may include operation 817 depicting controlling access to a cellular radio of the device unrelated to the execution of the one or more subtasks, based on successful execution of the one or more subtasks. For example, FIG. 4 shows subtask execution-based cellular radio access controlling module 417 controlling access to a cellular radio of the device (e.g., the Amazon Kindle 3G) unrelated to the execution of the one or more subtasks (e.g., the cellular radio access may be controlled while the wireless access may be left unfettered), based on successful execution of the one or more subtasks.

Referring again to FIG. 8J, operation 813 may include operation 819 depicting limiting a number of networks to which the radio of the device may connect, based on successful execution of the one or more subtasks. For example, FIG. 4 shows subtask execution-based radio number of connectable networks limiting module 419 limiting a number of networks (e.g., to two networks, e.g., a home network and one public network, e.g., “Starbucks network”) to which the radio (e.g., the wireless radio) of the device (e.g., the Asus Transformer) may connect (e.g., after two different networks have connected to the device, the device may only connect to those two networks until a certain number of subtasks are completed), based on successful execution of the one or more subtasks (e.g., although, more connections to networks may be permitted to transmit subtask data).

Referring again to FIG. 8J, operation 813 may include operation 821 depicting limiting a data transfer speed used by the radio of the device, based on successful execution of the one or more subtasks. For example, FIG. 4 shows subtask execution-based radio data transfer speed limiting module 421 limiting (e.g., capping, throttling, or otherwise controlling) a data transfer speed used by the radio of the device (e.g., the Nook Color), based on successful execution of the one or more subtasks (e.g., the more subtasks that are completed, the less the data transfer speed is limited).

Referring now to FIG. 8K, operation 813 may include operation 823 depicting limiting an amount of data transferred by the radio of the device, based on successful execution of the one or more subtasks. For example, FIG. 4 shows subtask execution-based radio data transfer amount limiting module 423 limiting an amount of data (e.g., limiting to 1 GB per 100 subtasks) transferred by the radio of the device (e.g., the wireless radio of an Acer Iconia), based on successful execution of the one or more subtasks (e.g., when more subtasks are completed, more data is permitted to be transferred).

Referring again to FIG. 8K, operation 813 may include operation 825 depicting limiting a type of network to which the radio of the device may connect, based on successful execution of the one or more subtasks. For example, FIG. 4 shows subtask execution-based radio type of permitted network to which to connect limiting module 425 limiting a type of network (e.g., 3G vs. 4G, or in another embodiment, wireless-G vs. wireless-N) to which the radio (e.g., wireless radio, or cellular radio) of the device (e.g., the HP Touchpad) may connect, based on successful execution of the one or more subtasks (e.g., completing a particular number of subtasks allows access to more types of networks, which may have more features, faster connection speeds, or more coverage).

Referring again to FIG. 8K, operation 813 may include operation 827 depicting limiting a type of content that may be transferred via the radio of the device, based on successful execution of the one or more subtasks. For example, FIG. 4 shows subtask execution-based radio data content type limiting module 427 limiting a type of content (e.g., limiting streaming audio to 100 MB per week) that may be transferred via the radio of the device (e.g., the Asus EeePc), based on successful execution of the one or more subtasks (e.g., each subtask completed may increase the limit on the amount of data that can be used on a type of content). In some embodiments, multiple types of content may be capped, e.g., streaming audio, streaming video, and FTP download, and a user may choose a limit to which he or she wishes to apply a completed subtask, e.g., a completed subtask may be applied to FTP download, raising the limit from 100MB per week to 200 MB per week).

Referring again to FIG. 8K, operation 827 may include operation 829 depicting allowing streaming video to be transferred via the radio of the device, upon successful execution of one or more of the one or more subtasks. For example, FIG. 4 shows subtask execution-based streaming video content type allowing module 429 allowing streaming video to be transferred via the radio of the device (e.g., the BlackBerry Playbook), upon successful execution of the one or more subtasks (e.g., streaming video is prevented from being transferred until a certain number of subtasks have been completed).

Referring again to FIG. 8K, operation 827 may include operation 831 depicting allowing files associated with a particular location to be transferred via the radio of the device, upon successful execution of one or more of the one or more subtasks. For example, FIG. 4 shows subtask execution-based particular location associated file type allowing module allowing files associated with a particular location (e.g., YouTube) to be transferred via the radio of the device (e.g., the Dell XPS laptop), upon successful execution of one or more of the one or more subtasks (e.g., video files from YouTube cannot be downloaded until a particular number of subtasks is completed).

Referring now to FIG. 8L, operation 506 may include operation 833 depicting controlling access to at least one feature of the device that is not used to execute at least one of the one or more subtasks, based on successful execution of the one or more subtasks. For example, FIG. 4 shows device feature not used for at least one subtask execution-based access controlling module 433 controlling access to at least one feature (e.g., the front facing camera) of the device (e.g., the Asus Transformer Prime tablet) that is not used to execute at least one of the one or more subtasks (e.g., the front facing camera is not used to execute the subtask “determine the wireless network coverage over the block bounded by 2nd street and the lake”), based on successful execution of the one or more subtasks (e.g., the camera is disabled until a certain number of subtasks are completed).

Referring again to FIG. 8L, operation 506 may include operation 835 depicting controlling access to at least one feature of the device that is not used to execute any of the one or more subtasks, based on successful execution of the one or more subtasks. For example, FIG. 4 shows device feature not used for any subtask execution-based access controlling module 435 controlling access to at least one feature of the device (e.g., playing games) that is not used to execute any of the one or more subtasks (e.g., taking a picture, measuring a wireless signal, detecting temperature, detecting speed, detecting ambient light, and the like), based on successful execution of the one or more subtasks. It is noted that this limitation does not mean that games cannot be subtasks, it just means that, as an example of one embodiment, none of the received one or more subtasks related to gaming.

Referring again to FIG. 8L, operation 506 may include operation 837 depicting controlling access to at least one feature of the device that is not required in order to execute at least one of the one or more subtasks, based on successful execution of the one or more subtasks. For example, FIG. 4 shows device feature not required to execute at least one subtask execution-based access controlling module 437 controlling access to at least one feature (e.g., the GPS sensor) of the device (e.g., the Apple iPad 2) that is not required in order to execute at least one of the one or more subtasks (e.g., “take a picture of the Eiffel Tower”), based on successful execution of the one or more subtasks (e.g., programs on the device may have limited access to the GPS sensor until a certain number of subtasks are completed).

Referring again to FIG. 8L, operation 506 may include operation 839 depicting controlling access to at least one feature of the device that is not activated in carrying out at least one of the one or more subtasks, based on successful execution of the one or more subtasks. For example, FIG. 4 shows device feature not activated in carrying out at least one subtask execution-based access controlling module 439 controlling access to at least one feature (e.g., the camera) of the device (e.g., the Motorola Droid Razr) that is not activated (e.g., remains off) in carrying out at least one of the one or more subtasks (e.g., “determine the ambient temperature at your location”), based on successful execution of the one or more subtasks (e.g., for each subtask that is successfully executed, a user may use the camera to take a certain number of pictures, or a certain amount of video).

Referring again to FIG. 8L, operation 506 may include operation 841 depicting controlling access to at least one feature of the device that is not executed when at least one of the one or more subtasks is carried out, based on successful execution of the one or more subtasks. For example, FIG. 4 shows device feature not executed in carrying out at least one subtask execution-based access controlling module 441 controlling access to at least one feature (e.g., Microsoft Office) of the device (e.g., the HP Folio laptop) that is not executed when at least one of the one or more subtasks (e.g., “take a picture of home plate from inside Camden Yards”) is carried out, based on successful execution of the one or more subtasks.

Referring now to FIG. 8M, operation 506 may include operation 843 depicting controlling access to at least one feature of the device that is idle when at least one of the one or more subtasks is carried out, based on successful execution of the one or more subtasks. For example, FIG. 4 shows device feature idle when carrying out at least one subtask execution-based access controlling module 443 controlling access to at least one feature (e.g., the microphone) of the device (e.g., the Samsung Focus S phone) that is idle (e.g., not drawing power, or not involved in processing) when at least one of the one or more subtasks is carried out (e.g., “take a picture of the front table at the restaurant at which you are located”), based on successful execution of the one or more subtasks.

Referring again to FIG. 8M, operation 506 may include operation 845 depicting controlling access to at least one feature of the device that is logically unrelated to at least one of the one or more subtasks, based on successful execution of the one or more subtasks. For example, FIG. 4 shows logically unrelated device feature subtask execution-based access controlling module 445 controlling access to at least one feature of the device (e.g., the voice recorder) that is logically unrelated (e.g., does not share device logic) to at least one of the one or more subtasks (e.g., “take a picture of Winchester Square”), based on successful execution of the one or more subtasks.

Referring again to FIG. 8M, operation 506 may include operation 847 depicting controlling access to at least one feature of the device that is functionally unrelated to at least one of the one or more subtasks, based on successful execution of the one or more subtasks. For example, FIG. 4 shows functionally unrelated device feature subtask execution-based access controlling module 447 controlling access to at least one feature (e.g., the voice-recognition system of a windshield-mounted GPS system) of the device (e.g., the GPS navigation system) that is functionally unrelated to at least one of the one or more subtasks (e.g., “determine how fast you are moving across the I-90 bridge,” e.g., the voice recognition system has no function related to making that determination), based on successful execution of the one or more subtasks (e.g., if a certain number of subtasks are not completed per month, the voice recognition system will be disabled).

Referring again to FIG. 8M, operation 506 may include operation 849 depicting controlling access to at least one feature of the device that is discrete from at least one of the one or more subtasks, based on successful execution of the one or more subtasks. For example, FIG. 4 shows discrete device feature subtask execution-based access controlling module 449 controlling access to at least one feature (e.g., the front-facing camera) of the device (e.g., HTC Surround) that is discrete (e.g., separated from the parts of the device that are executing the subtask) from at least one of the one or more subtasks (e.g., “transmit the location where the street noise on 2nd street is the loudest”), based on successful execution of the one or more subtasks.

Referring again to FIG. 8M, operation 506 may include operation 851 depicting controlling access to at least one feature of the device that is logically disconnected from at least one of the one or more subtasks, based on successful execution of the one or more subtasks. For example, FIG. 4 shows logically disconnected device feature subtask execution-based access controlling module 451 controlling access to at least one feature of the device (e.g., the outgoing call feature) that is logically disconnected (e.g., does not share any of the same device logic, e.g., programming) from at least one of the one or more subtasks (e.g., “take a picture of Puget Sound from the top of the Space Needle in Seattle”), based on successful execution of the one or more subtasks.

Referring again to FIG. 8M, operation 506 may include operation 853 depicting controlling access to at least one feature of the device that does not use hardware of the device used to execute at least one of the one or more subtasks, based on successful execution of the one or more subtasks. For example, FIG. 4 shows device feature that does not use device hardware used to execute subtask access controlling based on one or more subtask executions module 453 controlling access to at least one feature of the device (e.g., outgoing text messaging) that does not use hardware of the device (e.g., the camera) used to execute at least one of the one or more subtasks (e.g., “take a picture of the view of Lake Bellevue from the Happy Sushi restaurant”), based on successful execution of the one or more subtasks.

Referring now to FIG. 8N, operation 506 may include operation 855 depicting controlling access to at least one feature of the device that does not use software of the device used to execute at least one of the one or more subtasks, based on successful execution of the one or more subtasks. For example, FIG. 4 shows device feature that does not use device software used to execute subtask access controlling based on one or more subtask executions module 455 controlling access to at least one feature of the device (e.g., online gaming) that does not use software of the device (e.g., the recording software) used to execute at least one of the one or more subtasks (e.g., record the loudest decibel level reached while flying in your seat in a Boeing 747″), based on successful execution of the one or more subtasks.

Referring again to FIG. 8N, operation 506 may include operation 857 depicting controlling access to at least one feature of the device that does not use software or hardware of the device used to execute at least one of the one or more subtasks, based on successful execution of the one or more subtasks. For example, FIG. 4 shows device feature that does not use device software or hardware used to execute subtask access controlling based on one or more subtask executions module 457 controlling access to at least one feature of the device (e.g., the incoming call feature) that does not use software (e.g., image capturing software) or hardware (e.g., the camera) of the device used to execute at least one of the one or more subtasks (e.g., “take a picture of the line to get the new Apple laptop at the Apple store closest to your location”), based on successful execution of the one or more subtasks.

Referring again to FIG. 8N, operation 506 may include operation 859 depicting controlling access to at least one feature of the device unrelated to the execution of the one or more subtasks, based on successful execution of at least one of the one or more subtasks. For example, FIG. 4 shows unrelated device feature at least one of one or more subtasks execution-based access controlling module 459 controlling access to at least one feature (e.g., multimedia message sending) of the device unrelated to the execution of the one or more subtasks (e.g., “measure how many wireless networks are available at the Starbucks closest to your location”), based on successful execution of at least one of the one or more subtasks.

Referring again to FIG. 8N, operation 506 may include operation 861 depicting controlling access to at least one feature of the device unrelated to the execution of the one or more subtasks, based on successful execution of a predetermined number of subtasks of the one or more subtasks. For example, FIG. 4 shows unrelated device feature predetermined number of one or more subtasks execution-based access controlling module 461 controlling access to at least one feature of the device (e.g., the Twitter software) unrelated to the execution of the one or more subtasks (e.g., “detect the amount of ambient light at night at your location”), based on successful execution of a predetermined number of subtasks of the one or more subtasks (e.g., twenty subtasks may be received, and access to the Twitter software may occur at completion of ten of the twenty subtasks).

Referring again to FIG. 8N, operation 506 may include operation 863 depicting controlling access to at least one feature of the device unrelated to the execution of the one or more subtasks, based on successful execution of all of the one or more subtasks that are configured to be acquired by the device. For example, FIG. 4 shows unrelated device feature all of one or more subtasks execution-based access controlling module 463 controlling access to at least one feature (e.g., the picture editing feature) of the device (e.g., the Apple iPhone 4) unrelated to the execution of the one or more subtasks (e.g., “determine how many people are currently in the coffee shop at your location”), based on successful execution of all of the one or more subtasks that are configured to be acquired by the device (e.g., if there are ten subtasks to be acquired by the device, the picture editing feature cannot be accessed until all ten subtasks are successfully executed).

Referring now to FIG. 8P (there is no FIG. 80 to avoid confusion with the number “eighty”), operation 506 may include operation 865 depicting controlling access to at least one feature of the device unrelated to the execution of the one or more subtasks, at least partly based on successful execution of the one or more subtasks. For example, FIG. 4 shows unrelated device feature subtask at least partly execution-based access controlling module 465 controlling access to at least one feature (e.g., voice dialing) of the device (e.g., the BlackBerry 8800) unrelated to the execution of the one or more subtasks (e.g., “take a picture of the London Bridge”), at least partly based on successful execution of the one or more subtasks (e.g., access to voice dialing is partially based on the subtask execution status, and partly based on other factors).

Referring again to FIG. 8P, operation 506 may include operation 867 depicting controlling access to at least one feature of the device unrelated to the execution of the one or more subtasks, wholly based on successful execution of the one or more subtasks. For example, FIG. 4 shows unrelated device feature subtask wholly execution-based access controlling module 467 controlling access to at least one feature (e.g., call forwarding) of the device (e.g., the Palm Pre Plus) unrelated to the execution of the one or more subtasks (e.g., “determine the amount of background noise at the new Central restaurant for dinner”), wholly based on successful execution of the one or more subtasks (e.g., the only factor that determines whether the user has access to the call forwarding feature is the number of subtasks that have been successfully executed).

Referring again to FIG. 8P, operation 506 may include operation 869 depicting controlling access to at least one feature of the device unrelated to the execution of the one or more subtasks, in which successful execution of the one or more subtasks is a factor in controlling the access. For example, FIG. 4 shows unrelated device feature access controlling using successful execution of one or more subtasks as a factor module 469 controlling access to at least one feature (e.g., caller ID) of the device (e.g., the Nokia E7) unrelated to the execution of the one or more subtasks (e.g., “determine the maximum decibels from your seat in Merriweather Post Pavilion for the Pearl Jam concert”), in which successful execution of the one or more subtasks is a factor in controlling the access (e.g., the access to the caller ID feature, e.g., which may be disabled until a certain number of the one or more subtasks is completed).

Referring again to FIG. 8P, operation 506 may include operation 871 depicting controlling access to at least one feature of the device unrelated to the execution of the one or more subtasks, in which successful execution of the one or more subtasks is one of many factors in controlling the access. For example, FIG. 4 shows unrelated device feature access controlling using successful execution of one or more subtasks as one factor of many factors module 471 controlling access to at least one feature of the device (e.g., predictive text typing) unrelated to the execution of the one or more subtasks (e.g., take a picture of the field at FedEx field as a touchdown is scored), in which successful execution of the one or more subtasks is one of many (e.g., at least two) factors in controlling the access.

Referring again to FIG. 8P, operation 506 may include operation 873 depicting controlling access to at least one feature of the device unrelated to the execution of the one or more subtasks, based on successful execution of the one or more subtasks, and successful execution of other subtasks. For example, FIG. 4 shows unrelated device feature one or more subtask execution-based and other subtask-execution based access controlling module 473 controlling access to at least one feature of the device (e.g., the Windows Live Hotmail e-mail client) unrelated to the execution of the one or more subtasks (e.g., “determine the amount of street noise at 7 am in the apartment where you are located”), and successful execution of other subtasks (e.g., subtasks that were executed previously factor into the calculation of how much to control the Windows Live Hotmail e-mail client).

Referring again to FIG. 8P, operation 506 may include operation 875 depicting controlling access to at least one feature of the device unrelated to the execution of the one or more subtasks, based on a total number of executed subtasks, including the one or more subtasks. For example, FIG. 4 shows unrelated device feature total number of subtask execution, including the one or more subtasks access controlling module 475 controlling access to at least one feature (e.g., the web browser) of the device (e.g., the Motorola Droid X) unrelated to the execution of the one or more subtasks (e.g., “rate the freshness of the bagels at the Dunkin' Donuts closest to your location”), based on a total number of executed subtasks (e.g., based on the total number of subtasks executed in the entire history of the device, e.g., the feature will be unlocked once one thousand subtasks total are completed), including the one or more subtasks.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuitry (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuitry, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled//implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

What is claimed is:

1-280. (canceled)

281. A system, comprising:
an acquiring one or more subtasks that are portions of one or more tasks of acquiring data and configured to execute on two or more discrete interface devices device configuring module, configured to configure a device to acquire one or more subtasks configured to be carried out by at least two discrete interface devices, said one or more subtasks corresponding to portions of one or more tasks of acquiring data requested by a task requestor;
a received one or more subtasks requested by a task requestor execution facilitating module; and
an unrelated device feature subtask execution-based access controlling module configured to control access to at least one feature of the device unrelated to the execution of the one or more subtasks, based on successful execution of the one or more subtasks.

282. The system of claim 281, wherein said acquiring one or more subtasks that are portions of one or more tasks of acquiring data and configured to execute on two or more discrete interface devices device configuring module comprises:
an acquiring one or more subtasks configured to be carried out in an absence of information and related to one or more tasks of acquiring data device configuring module configured to configure a device to acquire one or more subtasks configured to be carried out by at least two discrete interface devices, said one or more subtasks corresponding to portions of one or more tasks of acquiring data requested by a task requestor, the subtasks configured to be carried out in an absence of information regarding the task and/or the task requestor.

283. (canceled)

284. (canceled)

285. (canceled)

286. The system of claim 281, wherein said acquiring one or more subtasks that are portions of one or more tasks of acquiring data and configured to execute on two or more discrete interface devices device configuring module comprises:
an acquiring one or more subtasks related to a discrete task of acquiring data device configuring module.

287. (canceled)

288. (canceled)

289. (canceled)

290. (canceled)

291. (canceled)

292. (canceled)

293. (canceled)

294. The system of claim 281, wherein said acquiring one or more subtasks that are portions of one or more tasks of acquiring data and configured to execute on two or more discrete interface devices device configuring module comprises:
a one or more subtask acquisition allowance device operating system configuring module configured to configure a device operating system to allow the device to acquire one or more subtasks configured to be carried out by at least two discrete interface devices and corresponding to one or more portions of a task of acquiring data requested by a task requestor.

295. (canceled)

296. The system of claim 281, wherein said acquiring one or more subtasks that are portions of one or more tasks of acquiring data and configured to execute on two or more discrete interface devices device configuring module comprises:
an adding software to a device that is configured to allow acquisition of one or more subtasks module configured to add, to a device, software configured to allow the device to acquire one or more subtasks configured to be carried out by at least two discrete interface devices and corresponding to one or more portions of a task of acquiring data requested by a task requestor.

297. (canceled)

298. (canceled)

299. (canceled)

300. (canceled)

301. (canceled)

302. (canceled)

303. (canceled)

304. (canceled)

305. (canceled)

306. The system of claim 281, wherein said received one or more subtasks requested by a task requestor execution facilitating module comprises:
a counter modifying in response to execution of one or more subtasks module configured to modify a counter when at least one of the received one or more subtasks has been executed.

307. (canceled)

308. The system of claim 281, wherein said received one or more subtasks requested by a task requestor execution facilitating module comprises:
a program execution upon detection of execution of at least one subtask module configured to execute a program upon detection of execution of at least one subtask of the received one or more subtasks.

309. The system of claim 308, wherein said program execution upon detection of execution of at least one subtask module comprises:
an upon detection of execution of at least one subtask, program configured to present a representation executing module configured to execute a program configured to present a representation on the device indicating execution of at least one subtask of the received one or more subtasks.

310. The system of claim 309, wherein said upon detection of execution of at least one subtask, program configured to present a representation executing module comprises:
an upon detection of execution of at least one subtask, program configured to display a symbol executing module configured to execute a program configured to display a symbol on the device indicating execution of at least one subtask of the received one or more subtasks.

311. The system of claim 308, wherein said program execution upon detection of execution of at least one subtask module comprises:
a program execution to present representation indicating relative completion status, upon detection of execution of at least one subtask module configured to execute a program configured to present a representation indicating relative completion status of executing a predetermined number of subtasks.

312. The system of claim 311, wherein said program execution to present representation indicating relative completion status, upon detection of execution of at least one subtask module comprises:
a program execution to display one or more symbols indicating relative completion status of a predetermined number of subtasks, upon detection of execution of at least one subtask module configured to execute a program configured to display one or more symbols indicating relative completion status of executing a predetermined number of subtasks.

313. (canceled)

314. (canceled)

315. The system of claim 312, wherein said program execution to display one or more symbols indicating relative completion status of a predetermined number of subtasks, upon detection of execution of at least one subtask module comprises:
a program execution to display one or more symbols indicating a number of units achieved over a particular time period upon detection of execution of at least one subtask that has a feature-based unit value module configured to execute a program configured to display one or more symbols indicating a number of units completed over a particular time period and a predetermined number of units to be completed, wherein a unit corresponds to a number of subtasks executed by the device, and each subtask has a unit value based on a feature of the subtask.

316. (canceled)

317. The system of claim 315, wherein said program execution to display one or more symbols indicating a number of units achieved over a particular time period upon detection of execution of at least one subtask that has a feature-based unit value module comprises:
an upon subtask detection, displaying one or more symbols indicating a number of units based on subtask completion time achieved over predetermined time period module.

318. (canceled)

319. (canceled)

320. (canceled)

321. (canceled)

322. (canceled)

323. The system of claim 281, wherein said received one or more subtasks requested by a task requestor execution facilitating module comprises:
an access to one or more portions of a device used to carry out at least a portion of at least one subtask providing module configured to provide access to one or more portions of the device that are used to carry out at least a portion of at least one of the received one or more subtasks.

324. (canceled)

325. (canceled)

326. (canceled)

327. (canceled)

328. The system of claim 281, wherein said received one or more subtasks requested by a task requestor execution facilitating module comprises:
an information collecting sensor of device accessing module configured to access one or more sensors of the device to collect information for carrying out at least a portion of at least one of the received one or more subtasks.

329. The system of claim 281, wherein said received one or more subtasks requested by a task requestor execution facilitating module comprises:
an at least one received subtask is executed signal transmitting module configured to transmit a signal indicating that at least one of the received one or more subtasks has been executed.

330. The system of claim 281, wherein said received one or more subtasks requested by a task requestor execution facilitating module comprises:
a signal indicating how many subtasks have been executed transmitting module configured to transmit a signal indicating how many subtasks have been executed by the device.

331. (canceled)

332. The system of claim 330, wherein said signal indicating how many subtasks have been executed transmitting module comprises:
a signal indicating how many subtasks have been executed in response to external source request transmitting module.

333. The system of claim 281, wherein said unrelated device feature subtask execution-based access controlling module comprises:
a selectively allowing access to a device feature based on subtask execution module configured to selectively allow access to at least one feature of the device unrelated to the execution of the one or more subtasks, based on successful execution of the one or more subtasks.

334. The system of claim 333, wherein said selectively allowing access to a device feature based on subtask execution module comprises:
a selectively allowing a user access to a device feature based on subtask execution module.

335. The system of claim 333, wherein said selectively allowing access to a device feature based on subtask execution module comprises:
a selectively allowing a program access to a device feature based on subtask execution module.

336. (canceled)

337. The system of claim 281, wherein said unrelated device feature subtask execution-based access controlling module comprises:
a selectively suppressing a particular feature of the device that is unrelated to the execution of the one or more subtasks from a list of features of the device based on successful execution of the one or more subtasks module.

338. (canceled)

339. The system of claim 337, wherein said selectively suppressing a particular feature of the device that is unrelated to the execution of the one or more subtasks from a list of features of the device based on successful execution of the one or more subtasks module comprises:
a selectively preventing display of a particular feature on a device display unrelated to subtask execution module.

340. (canceled)

341. (canceled)

342. The system of claim 337, wherein said selectively suppressing a particular feature of the device that is unrelated to the execution of the one or more subtasks from a list of features of the device based on successful execution of the one or more subtasks module comprises:
a selectively allowing selection of a particular feature unrelated to subtask execution from a list of features on a module.

343. (canceled)

344. (canceled)

345. The system of claim 281, wherein said unrelated device feature subtask execution-based access controlling module comprises:
an entities using features of device unrelated to subtask execution access rights managing module configured to manage access rights for various entities using the device to at least one feature of the device unrelated to the execution of the one or more subtasks, based on successful execution of the one or more subtasks.

346. (canceled)

347. The system of claim 345, wherein said entities using features of device unrelated to subtask execution access rights managing module comprises:
a particular program accessing features of device unrelated to subtask execution access rights managing module.

348. The system of claim 345, wherein said entities using features of device unrelated to subtask execution access rights managing module comprises:
a particular program owner accessing features of device unrelated to subtask execution access rights managing module.

349. The system of claim 345, wherein said entities using features of device unrelated to subtask execution access rights managing module comprises:
a particular vendor that created program accessing features of device unrelated to subtask execution access rights managing module.

350. (canceled)

351. (canceled)

352. (canceled)

353. The system of claim 345, wherein said entities using features of device unrelated to subtask execution access rights managing module comprises:
a program having particular digital signature accessing feature of device unrelated to subtask execution access rights managing module.

354. The system of claim 281, wherein said unrelated device feature subtask execution-based access controlling module comprises:
a device operating system portion unrelated to subtask execution access rights managing module configured to control access to at least one portion of the device operating system unrelated to the execution of the one or more subtasks, based on successful execution of the one or more subtasks.

355. The system of claim 281, wherein said unrelated device feature subtask execution-based access controlling module comprises:
a device-loaded program unrelated to execution of one or more subtasks access controlling module configured to control access to at least one program loaded on the device unrelated to the execution of the one or more subtasks, based on successful execution of the one or more subtasks.

356. The system of claim 355, wherein said device-loaded program unrelated to execution of one or more subtasks access controlling module comprises:
a subtask execution-based outgoing call-making program access controlling module.

357. (canceled)

358. (canceled)

359. (canceled)

360. The system of claim 355, wherein said device-loaded program unrelated to execution of one or more subtasks access controlling module comprises:
a subtask execution-based incoming call-making program access controlling module.

361. (canceled)

362. (canceled)

363. (canceled)

364. (canceled)

365. (canceled)

366. (canceled)

367. The system of claim 355, wherein said device-loaded program unrelated to execution of one or more subtasks access controlling module comprises:
a subtask execution-based game program access controlling module configured to control access to at least one game on the device unrelated to the execution of the one or more subtasks, based on successful execution of the one or more subtasks.

368. (canceled)

369. The system of claim 367, wherein said subtask execution-based game program access controlling module comprises:
a subtask execution-based features of game program access selective allowing module.

370. The system of claim 367, wherein said subtask execution-based game program access controlling module comprises:
a subtask execution-based levels of game program access selective allowing module.

371. The system of claim 355, wherein said device-loaded program unrelated to execution of one or more subtasks access controlling module comprises:
a subtask execution-based application access controlling module configured to control access to at least one application loaded on the device unrelated to the execution of the one or more subtasks, based on successful execution of the one or more subtasks.

372. (canceled)

373. (canceled)

374. (canceled)

375. (canceled)

376. The system of claim 371, wherein said subtask execution-based application access controlling module comprises:
a subtask execution-based web browsing application access controlling module.

377. The system of claim 281, wherein said unrelated device feature subtask execution-based access controlling module comprises:
a subtask execution-based component access controlling module configured to control access to at least one component of the device unrelated to the execution of the one or more subtasks, based on successful execution of the one or more subtasks.

378. (canceled)

379. (canceled)

380. (canceled)

381. (canceled)

382. (canceled)

383. (canceled)

384. (canceled)

385. (canceled)

386. (canceled)

387. (canceled)

388. The system of claim 377, wherein said subtask execution-based component access controlling module comprises:
a subtask execution-based radio access controlling module configured to control access to a radio of the device unrelated to the execution of the one or more subtasks, based on successful execution of the one or more subtasks.

389. (canceled)

390. (canceled)

391. (canceled)

392. (canceled)

393. (canceled)

394. (canceled)

395. The system of claim 388, wherein said subtask execution-based radio access controlling module comprises:
a subtask execution-based radio data content type limiting module configured to limit a type of content that may be transferred via the radio of the device, based on successful execution of the one or more subtasks.

396. (canceled)

397. (canceled)

398. (canceled)

399. (canceled)

400. (canceled)

401. (canceled)

402. (canceled)

403. (canceled)

404. (canceled)

405. (canceled)

406. (canceled)

407. (canceled)

408. (canceled)

409. The system of claim 281, wherein said unrelated device feature subtask execution-based access controlling module comprises:
a device feature that does not use device software used to execute subtask access controlling based on one or more subtask executions module.

410. (canceled)

411. (canceled)

412. (canceled)

413. The system of claim 281, wherein said unrelated device feature subtask execution-based access controlling module comprises:
an unrelated device feature all of one or more subtasks execution-based access controlling module.

414. The system of claim 281, wherein said unrelated device feature subtask execution-based access controlling module comprises:
an unrelated device feature subtask at least partly execution-based access controlling module configured to control access to at least one feature of the device unrelated to the execution of the one or more subtasks, at least partly based on successful execution of the one or more subtasks.

415. The system of claim 281, wherein said unrelated device feature subtask execution-based access controlling module comprises:
an unrelated device feature subtask wholly execution-based access controlling module configured to control access to at least one feature of the device unrelated to the execution of the one or more subtasks, wholly based on successful execution of the one or more subtasks.

416. The system of claim 281, wherein said unrelated device feature subtask execution-based access controlling module comprises:
an unrelated device feature access controlling using successful execution of one or more subtasks as one factor module.

417. (canceled)

418. (canceled)

419. (canceled)
